(19) United States
(12) Patent Application Publication
(10) Pub. No.: US 2024/0201996 A1
(43) Pub. Date: Jun. 20, 2024

(54) IMPROVEMENTS IN AND RELATING TO ENCODING AND COMPUTATION ON DISTRIBUTIONS OF DATA

(71) Applicant: CAMBRIDGE ENTERPRISE LIMITED, Cambridge (GB)

(72) Inventors: Phillip STANLEY-MARBELL, Cambridge Cambridgeshire (GB); Vasileios TSOUTSOURAS, Cambridge Cambridgeshire (GB); Bilgesu BILGIN, Cambridge Cambridgeshire (GB)

(73) Assignee: CAMBRIDGE ENTERPRISE LIMITED, Cambridge (GB)

(21) Appl. No.: 18/562,398

(22) PCT Filed: May 27, 2022
(86) PCT No.: PCT/EP2022/064492

§ 371 Date: Nov. 20, 2023

(30) Foreign Application Priority Data
May 27, 2021 (GB) 2107604.7
May 27, 2021 (GB) 2107606.2

(51) Int. Cl. G06F 9/30

(52) U.S. Cl. CPC G06F 9/3013; G06F 9/3001

(57) ABSTRACT

A method for computation on distributions of data, the method comprising providing a microarchitecture comprising: a first register containing data items; a second register containing distribution data representing distributions that are uncertainty representations associated with respective said data items; a first arithmetic logic unit for executing arithmetic on data items selected from the first register; a second arithmetic logic unit for executing arithmetic on distribution data selected from the second register; the method comprising the following steps implemented by the microarchitecture: executing, by the first arithmetic logic unit, an arithmetic operation on data items selected from the first register, and outputting the result; executing, by the second arithmetic logic unit, an arithmetic operation on distribution data representing distributions selected from the second register that are associated with the data items selected from the first register, and outputting the result; wherein the arithmetic operation executed on the distribution data selected from the second register is the same as the arithmetic operation executed on the data items selected from the first register thereby to generate further distribution data representing uncertainty associated with result of the arithmetic operation executed on the data items selected from the first register.

This application claims priority from GB2107604.7 filed 27 May 2021 and from GB2107606.2 filed 27 May 2021, the contents and elements of which are herein incorporated by reference for all purposes.

### FIELD OF THE INVENTION

The present invention relates to encoding, computation, storage and communication of distributions of data. The data may be distributions of data samples. The distributions of data may represent measurement uncertainty in measurement devices (e.g. sensors) and particularly, although not exclusively, may represent probability distributions.

### BACKGROUND

Measurement apparatuses (e.g. sensors) pervade almost all aspects of modern life. From the monitoring of the operation of vehicles (e.g. engines and performance), to manufacturing apparatus and operations, power distribution networks, traffic control and telecommunications networks. The technical data produced by this monitoring is essential to helping manage these complex machines, structures and arrangements in a way that allows better efficiency and safety. The emergence of ‘Big Data’ analytics has grown hand-in-hand with the exponential growth in this technical data.

However, the ability to benefit from the analysis of such technical data sets is predicated on the accuracy and reliability of the data itself. If the data being analysed is of poor quality, then so too are the decisions that are made based on the results of that analysis. To quote and old adage: ‘Garbage in; Garbage out’.

In all measurement apparatuses, no matter how sophisticated, the ‘measurement’ will never be identical to the ‘measurand’. Following standard terminology from metrology, the true value of the input signal being measured by a measurement apparatus is known as the ‘measurand’. Similarly, the estimate of the measurand obtained as the result of a measurement process, by a measurement apparatus, is known as the ‘measurement’.

This difference, between the value of the ‘measurand’ and the value of the ‘measurement’, is either due to disturbances in the measurement instrument/sensor (e.g., circuit noise such as Johnson-Nyquist noise, or random telegraph noise, or transducer drift) or it is due to properties of the environment in which the measurement or sensing occurs (e.g. in LIDAR, so-called ‘multipath’ leading to anomalous readings).

The noise in the measurement instrument/sensor and the errors in measurements due to the environment or other non-instrument factors, can collectively be referred to as ‘measurement uncertainty’.

Knowledge of measurement uncertainty associated with a technical data set permits the user to be informed about the uncertainty, and therefore the reliability, of the results of the analysis and decisions made on the basis of that data. Ignorance of this measurement uncertainty may lead to poor decisions. This can be safety-critical and is of paramount importance when the decision in question is being made by a machine (e.g. driverless car, an automated aircraft piloting system, an automated traffic light system etc.) unable to make acceptable risk-assessment judgements.

The present invention has been devised in light of the above considerations.

### SUMMARY OF THE INVENTION

Uncertain data are ubiquitous. A common example is sensor measurements where the very nature of physical measurements means there is always some degree of uncertainty between the recorded value (the measurement) and the quantity being measured (the measurand). This form of measurement uncertainty is often quantified by performing repeated measurements with the measurand nominally fixed and observing the variation across measurements using statistical analysis. Such uncertainty in values, resulting from incomplete information on the values they should take, is of increasing relevance in modern computing systems. Modern computer architectures neither have support for efficiently representing uncertainty, let alone arithmetic and control-flow on such values. Computer architectures today represent uncertain values with single point values or “particle” values (i.e., data with no associated uncertainty distribution), usually by taking the mean value as the representation for use in computation. Hereafter, for conciseness, we refer to single point values (i.e., data with no associated distribution) as “particle” values.

The invention provides an encoding method for encoding information within a data structure for data relating to uncertainty real-world data (e.g., functional data associated with measurement values from a sensor, or values associated with the state of a physical system) for efficiently storing (e.g., physically in a register file, in a buffer memory or other memory storage) the information and/or efficiently propagating the stored information through subsequent computations.

The present invention may encode, represent and propagate distributional information/data (e.g., probability distributions, frequency distributions etc.) representing uncertainty in measurement data made by a measurement apparatus (e.g., sensor) or in values associated with the state of a physical system.

The technical considerations underlying the encoding method and the data structure it generates, relate to the intended use of the encoded data: namely, in computations performed on distributions representing uncertainty in data values. These considerations allow a computing architecture to work efficiently using parameters within the data structure that encode a probability distribution describing uncertainty in real-world data. The result is to provide an efficient method for generating new parameters which are consistent/comply with a common data structure format and requirements, and which encode a probability distribution representing the result of applying an arithmetic operation on two (or more) other probability distributions. This allows further such computations to be applied to the new parameters in a consistent manner when calculating uncertainty in quantities calculated by applying further arithmetic operations. As a result, computations performed upon two or more “particle” values to obtain a new “particle” value may also be concurrently performed on the corresponding uncertainty distributions of the two or more “particle” values so as to obtain a new uncertainty distribution associated with the new “particle” value efficiently and in a consistent manner.

In a first aspect, the invention may provide a method computer-implemented method for the encoding of, and computation on, distributions of data, the method comprising:
obtaining a first set of data items;
obtaining a second set of data items;
generating a first tuple containing parameters encoding a probability distribution characterising the distribution of the data items of the first set;
generating a second tuple containing parameters encoding a probability distribution characterising the distribution of the data items of the second set in which the parameters used to encode the distribution of the data items of the second set are the same as the parameters used to encode the distribution of the data items of the first set;
generating a third tuple using parameters contained within the first tuple and using parameters contained within the second tuple, the third tuple containing parameters encoding a probability distribution representing the result of applying an arithmetic operation on the first probability distribution and the second probability distribution;
outputting the third tuple.

In this way, each tuple provides a data structure within which distributional information is encoded that represents a probability distribution (e.g., uncertainty in an associated “particle” value). A reference herein to a “tuple” may be considered to include a reference to a data structure consisting of multiple parts defining an ordered set of data constituting a record, as is commonly understood in the art. In mathematics, a tuple is a finite ordered list (sequence) of elements such as a sequence (or ordered list) of n elements, where n is a non-negative integer. The parameters contained within the first, second and third tuples according to preferred examples of the invention are, therefore, ordered according to a common parameter ordering or sequence which controls/instructs a computing system implementing the method on how to calculate a new distributional data (i.e., a new tuple, consistently encoded) to be associated with a new “particle” data item generated by doing arithmetic operations on two or more other “particle” data items each having their own respective associated distributional data (i.e., a respective tuple, consistently encoded). These encoded data structures (tuples) are distinct from the data (distributions) itself. The data structure may be automatically recognised by the computing system implementing the method, such that it may operate accordingly. In this way, a causal link exists between the encoding underlying the data structure, the interpretation of the data structure by a computing system for performing calculations using the data within the data structure, and the technical/operational efficiencies gained by the computing system when calculating new distributional information for a calculated new “particle” data item.

A “variable” may be considered to be a symbol which works as a placeholder for expression of quantities that may vary or change. For example, a “variable” may be used to represent the argument of a function or an arbitrary element of a set. A parameter, in mathematics, may be considered to be a variable for which the range of possible values identifies a collection of distinct cases in a problem. For example, any equation expressed in terms of parameters is a parametric equation. For example, the general equation of a straight line in gradient-intercept form, y=mx+c, in which m and c are parameters, is an example of a parametric equation. Different instances of this equation may be said to use “the same” parameters (i.e. a gradient parameter, m, and an intercept parameter, c) whether or not the actual values of those parameters are the same: first instance, y=m₁x+c₁; second instance, y=m₂x+c₂ use the same parameters (gradient-intercept) whether or not the actual values of m₁ and m₂ are equal (i.e. m₁=m₂) and whether or not the actual values of c₁ and c₂ are equal (i.e. c₁=c₂). In this sense, any two tuples containing parameters encoding a respective probability distribution may be said to use “the same” parameters (e.g. have the same use of parameters). As a non-limiting example, discussed in more detail below, the parameters used to encode a distribution of data items may be the parameters of “position”, x₁, of Dirac-δ functions and “probability”, pᵢ. Different distributions, for different data sets, may use these two parameters and therefore use “the same” parameters as each other. Of course, the actual values assigned to these parameters (position, probability) for the data in each set, as defined in this shared parametric form, are generally not the same. The use of the same parameters permits the method to achieve the same format of representation using the tuples to encode the distribution of the data items, and from that format, the same format of representation of the distributions themselves may be reproduced.

Preferably, the outputting of the third tuple comprises one or more of: storing the third tuple in a memory (e.g., in a register file, in a buffer memory or other memory storage); transmitting a signal conveying the third tuple (e.g., via an electrical signal or via an electromagnetic signal/carrier-wave). Accordingly, the encoding method improves the efficiency of storage and/or transmission of the probability distribution information encoded by the data structure of the third tuple.

According to the method, the arithmetic operation may comprise one or more of: addition; subtraction; multiplication; division, or more complex arithmetic operations e.g., fused multiplication and addition or square root, or any bivariate operation, e.g., exponentiation, by expressing them in terms of the aforementioned basic arithmetic operations, as would be readily apparent to the skilled person. Thus, just as new “particle” data item may be generated by doing any such arithmetic operations on two or more other “particle” data items each having their own respective associated distributional data, similarly, new distributional information (e.g., the third tuple) may be calculated for the new “particle” data item by applying the same arithmetic operations on the distributional data associated with the two or more other “particle” data items (e.g., the first and second tuples).

The third tuple may contain parameters encoding a probability distribution characterising the distribution of the data items of a third set of data items in which the parameters used to encode the distribution of the data items of the third set are the same as the parameters used to encode the distribution of the data items of the first set. Accordingly, third tuple may be a data structure containing parameters ordered according to a parameter ordering or sequence which is in common with the parameter ordering or sequence employed in the first tuple. This has the advantage of providing a common data structure in the first, second and third tuples when anyone or more of these tuples is subsequently used for controlling/instructing a computing system to calculate a further new distributional data (i.e., a new tuple, consistently encoded) to be associated with a further new “particle” data item generated by doing arithmetic operations on two or more “particle” data items each having their own respective associated distributional data (i.e., a respective tuple, consistently encoded).

Preferably, the first set of data comprises samples of a first random variable, and the second set of data comprises samples of a second random variable.

Preferably, the method comprises outputting the first tuple by one or more of: storing the first tuple in a memory (e.g., in a register file, in a buffer memory or other memory storage); transmitting a signal conveying the first tuple (e.g., via an electrical signal or via an electromagnetic signal/carrier-wave). Preferably, the method comprises outputting the second tuple by one of more of: storing the second tuple in a memory (e.g., in a register file, in a buffer memory or other memory storage); transmitting a signal conveying the second tuple (e.g., via an electrical signal or via an electromagnetic signal/carrier-wave).

The method may comprise obtaining the output first tuple by one or more of: retrieving the output first tuple from a memory; receiving a signal conveying the output first tuple. The method may comprise obtaining of the output second tuple by one or more of: retrieving the output second tuple from a memory; receiving a signal conveying the output second tuple. The method may comprise generating the third tuple using parameters contained within the obtained first tuple and within the obtained second tuple.

Desirably, the first tuple contains parameters encoding the position of data items within the probability distribution characterising the distribution of the data items of the first set. For example, the position of data items may be positions of Dirac delta functions. Preferably, the second tuple contains parameters encoding the position of data items within the probability distribution characterising the distribution of the data items of the second set. For example, the position of data items may be positions of Dirac delta functions. Desirably, the third tuple contains parameters encoding the position of data items within a probability distribution characterising the distribution of the data items of a third set of data items. For example, the position of data items may be positions of Dirac delta functions.

Desirably, the first tuple contains parameters encoding the position and/or width of data intervals within the probability distribution characterising the distribution of the data items of the first set. Preferably, the second tuple contains parameters encoding the position and/or width of data intervals within the probability distribution characterising the distribution of the data items of the second set. Desirably, the third tuple contains parameters encoding the position and/or width of data intervals within a probability distribution characterising the distribution of the data items of a third set of data items.

Desirably, the first tuple contains parameters encoding the probability of data items within the probability distribution characterising the distribution of the data items of the first set. For example, the probability of a data item encoded within the first tuple may be an amplitude or a weighting of a Dirac delta function, which may be positioned according to one or more parameters encoding the position of data item. Preferably, the second tuple contains parameters encoding the probability of data items within the probability distribution characterising the distribution of the data items of the second set. For example, the probability of a data item encoded within the second tuple may be an amplitude or a weighting of a Dirac delta function, which may be positioned according to one or more parameters encoding the position of data item. Desirably, the third tuple contains parameters encoding the probability of data items within a probability distribution characterising the distribution of the data items of a third set of data items. For example, the probability of a data item encoded within the third tuple may be an amplitude or a weighting of a Dirac delta function, which may be positioned according to one or more parameters encoding the position of data item.

Desirably, the first tuple contains parameters encoding the value of one or more statistical moments of the probability distribution characterising the distribution of the data items of the first set. Preferably, the second tuple contains parameters encoding the value of one or more statistical moments of the probability distribution characterising the distribution of the data items of the second set. Desirably, the third tuple contains parameters encoding the value of one or more statistical moments of a probability distribution characterising the distribution of the data items of a third set of data items.

Desirably, the probability distribution characterising the distribution of the data items of the first set comprises a distribution of Dirac delta functions. Preferably, the probability distribution characterising the distribution of the data items of the second set comprises a distribution of Dirac delta functions. Desirably, the probability distribution characterising the distribution of the data items of the third set comprises a distribution of Dirac delta functions.

Desirably, the first tuple is an N-tuple in which N>1 is an integer. Preferably the second tuple is an N-tuple in which N>1 is an integer. Desirably, the third tuple is an M-tuple for which N²/2<M<2N² in which N>1 is an integer. For example, for SoDD-based representations discussed in more detail below (i.e., all except CMR), if N is the memory usage of a given representation method with N_{dd} Dirac deltas, the initial M-tuple calculated as arithmetic propagation of the input N-tuples will encode N_{dd}² Dirac deltas using 2Nₐₐ² numbers (except for PQHR for which Nₐₐ² numbers suffice). In other words, (except for PQHR) M=2N_{dd}². Table 1, below gives the relationship between N and N_{dd} for a given method. For TTR and MQHR N=2N_{dd}, which implies M=N_{dd}²/2.

The method may comprise reducing the size of the third tuple (M-tuple representation) to be the same size (N-tuple) as the first tuple and the second tuple, to provide a reduced third tuple which is an N-tuple. This has the advantage of enabling a fixed size for the tuples that one calculates with (i.e. all being N-tuples), to enable further calculations with the derived tuples (i.e. the results of the arithmetic on distributions). This may be achieved by considering the data represented by the third tuple as being a new “obtained” data set (i.e. an obtained third set of data items, obtained as the result of the arithmetic operation) and therefrom generating a “compacted” third tuple containing parameters encoding a probability distribution characterising the distribution of the data items of the third set. The parameters used in the compacted third tuple to encode the distribution of the data items of the third set, may not only be the same as the parameters used to encode the distribution of the data items of the first set, but also the compacted third tuple may be constructed to be the same size (i.e. an N-tuple; the size is reduced from M to N) as both the first and second tuples. In this way, any of the methods and apparatus disclosed herein for use in generating a tuple from an obtained set of data items, may equally be applied to the output result of applying the arithmetic operation on distributions to allow that output to be represented as a tuple of the same size as the tuples representing the data set to which the arithmetic was applied. References herein to the “third tuple” may be considered to include a reference to a “compacted third tuple”, as appropriate.

In another aspect, the invention may provide a computer program product comprising a computer program which, when executed on a computer, implements the method according to the invention described above, in its first aspect.

In a second aspect, the invention may provide an apparatus for implementing the encoding of, and computation on, distributions of data, the apparatus comprising:
a memory for storing a first set of data items and a second set of data items;
a processor configured to perform the following processing steps:
   generate a first tuple containing parameters encoding a probability distribution characterising the distribution of the data items of the first set;
   generate a second tuple containing parameters encoding a probability distribution characterising the distribution of the data items of the second set in which the parameters used to encode the distribution of the data items of the second set are the same as the parameters used to encode the distribution of the data items of the first set;
   generate a third tuple using parameters contained within the first tuple and using parameters contained within the second tuple, the third tuple containing parameters encoding a probability distribution representing the result of applying an arithmetic operation on the first probability distribution and the second probability distribution; and,
   output the third tuple.

Preferably, the processor may be implemented as a microprocessor, or a dedicated digital logic circuit, or an analogue circuit configured to perform the processing steps. Preferably, the apparatus is configured to output the third tuple by one or more of: storing the third tuple in a memory; transmitting a signal conveying the third tuple.

Preferably, the apparatus is configured to output the first tuple by one or more of: storing the first tuple in a memory; transmitting a signal conveying the first tuple. Preferably, the apparatus is configured to output the second tuple by one or more of: storing the second tuple in a memory; transmitting a signal conveying the second tuple.

The apparatus is configured to obtain the output first tuple by one or more of: retrieving the output first tuple from a memory; receiving a signal conveying the output first tuple. The apparatus is configured to obtain the output second tuple by one or more of: retrieving the output second tuple from a memory; receiving a signal conveying the output second tuple. The apparatus is configured to generate the third tuple using parameters contained within the obtained first tuple and within the obtained second tuple.

The apparatus may be configured to perform the step of outputting of the first tuple by one or more of: storing the first tuple in a memory; transmitting a signal conveying the first tuple. The apparatus may be configured to perform the step of outputting the second tuple by one or more of: storing the second tuple in a memory; transmitting a signal conveying the second tuple. The apparatus may be configured to perform the step of outputting the third tuple by one or more of: storing the third tuple in a memory; transmitting a signal conveying the third tuple.

The apparatus may be configured to perform the step of obtaining of the output first tuple by one or more of: retrieving the output first tuple from a memory; receiving a signal conveying the output first tuple. The apparatus may be configured to perform the step of obtaining of the output second tuple by one or more of: retrieving the output second tuple from a memory; receiving a signal conveying the output second tuple.

The apparatus may be configured to perform the arithmetic operation comprising one or more of: addition; subtraction; multiplication; division.

The apparatus may be configured such that the third tuple contains parameters encoding a probability distribution characterising the distribution of the data items of a third set of data items in which the parameters used to encode the distribution of the data items of the third set are the same as the parameters used to encode the distribution of the data items of the first set.

The apparatus may be configured such that the first tuple contains parameters encoding the position of data items within the probability distribution characterising the distribution of the data items of the first set. The apparatus may be configured such that the second tuple contains parameters encoding the position of data items within the probability distribution characterising the distribution of the data items of the second set. The apparatus may be configured such that the third tuple contains parameters encoding the position of data items within a probability distribution characterising the distribution of the data items of a third set of data items.

The apparatus may be configured such that the first tuple contains parameters encoding the position and/or width of data intervals within the probability distribution characterising the distribution of the data items of the first set. The apparatus may be configured such that the second tuple contains parameters encoding the position and/or width of data intervals within the probability distribution characterising the distribution of the data items of the second set. The apparatus may be configured such that the third tuple contains parameters encoding the position and/or width of data intervals within a probability distribution characterising the distribution of the data items of a third set of data items.

The apparatus may be configured such that the first tuple contains parameters encoding the probability of data items within the probability distribution characterising the distribution of the data items of the first set. The apparatus may be configured such that the second tuple contains parameters encoding the probability of data items within the probability distribution characterising the distribution of the data items of the second set. The apparatus may be configured such that the third tuple contains parameters encoding the probability of data items within a probability distribution characterising the distribution of the data items of a third set of data items.

The apparatus may be configured such that the first tuple contains parameters encoding the value of one or more statistical moments of the probability distribution characterising the distribution of the data items of the first set. The apparatus may be configured such that the second tuple contains parameters encoding the value of one or more statistical moments of the probability distribution characterising the distribution of the data items of the second set. The apparatus may be configured such that the third tuple contains parameters encoding the value of one or more statistical moments of a probability distribution characterising the distribution of the data items of a third set of data items.

The apparatus may be configured such that the probability distribution characterising the distribution of the data items of the first set comprises a distribution of Dirac delta functions. The apparatus may be configured such that the probability distribution characterising the distribution of the data items of the second set comprises a distribution of Dirac delta functions. The apparatus may be configured such that the probability distribution characterising the distribution of the data items of the third set comprises a distribution of Dirac delta functions.

The apparatus may be configured such that the first tuple is an N-tuple in which N>1 is an integer. The apparatus may be configured such that the second tuple is an N-tuple in which N>1 is an integer. The apparatus may be configured such that the third tuple is an M-tuple for which N²/2<M<2N² in which N>1 is an integer.

In another aspect, the invention may provide a computer programmed with a computer program which, when executed on the computer, implements the method according described above, in the first aspect of the invention.

The invention includes the combination of the aspects and preferred features described except where such a combination is clearly impermissible or expressly avoided. This means that, for example, the invention in its first aspect (method) may be implemented according to the invention in its third aspect (below) by providing a microarchitecture to implement the method. Similarly, the invention in its second aspect (apparatus) may be implemented according to the invention in its fourth aspect (below) as a microarchitecture.

Computers carry out arithmetic with point-valued numbers. The data that dominate contemporary computing systems are however from measurement processes such as sensors. All measurements are inherently uncertain and this uncertainty is often characterized statistically and forms aleatoric uncertainty. In addition, many other contemporary applications of probability distributions, such as machine learning, comprise models which also have inherent epistemic uncertainty (e.g., on the weights of a neural network). Hardware and software can exploit this uncertainty in measurements for improved performance as well as for trading performance for power dissipation or quality of results. All of these potential applications however stand to benefit from more effective methods for representing arbitrary real-world probability distributions and for propagating those distributions through arithmetic.

The inventors have realised that each real number in the domain of a distribution may be described by a Dirac delta with some probability mass located at the value of the real number. This representation of a distribution in terms of Dirac deltas within its domain is different from that of a probability mass function (PMF), where the domain of the distribution is by definition discrete-valued and integrals can be replaced with sums. Because the Dirac delta distribution is not a function but rather is a distribution, the representation of distributions as a collection of Dirac deltas is also different from the concept of a probability density function (PDF). The inventors therefore refer, herein, to the representation comprising a sum of Dirac deltas as a probability density distribution (PDD).

### Probability Density Distributions (PDDs) and Finite-Dimensional Representations

In general, a real-valued random variable is characterized by its PDD defined on the real numbers. Because we are concerned with computer representations, the information on such a probability distribution is represented by finitely many real number representations. As real number representations of finite size (e.g., 32-bit floating-point representation) provide a discrete and finite representation of the real line, it is conventional to work with probability mass functions (PMFs) instead of PDDs. However, in the present disclosure we ignore the error in representation of real numbers and assume that each real number can be represented exactly. This removes the discrete nature of all permissible values taken by a random variable and as a consequence we employ a formalism that uses PDDs instead of PMFs. Thus, one may then encapsulate the finite capabilities of a computer in representing a given abstract PDD by representing it using finitely-many, say N, (exactly-represented) real numbers, to which we will refer as a finite-dimensional representation of size N.

Computation on PDDs requires, first, an algorithm for calculating the finite-dimensional representation from a given description of the PDD of a random variable and, second, an algorithm for propagating such representations under given arithmetic operations. In the present disclosure, we refer to these two types of algorithms as finite-dimensional representation methods and arithmetic propagation methods, respectively. The present disclosure presents examples of such methods for computation with random variables.

The description of the PDD can be an analytical expression or it can be in the form of samples drawn from a distribution which itself gives rise to a discrete PDD. The present disclosure presents methods that are generic to calculation of representations from any PDD, whether continuous or discrete. The present disclosure is relevant in its application to computations in aleatoric uncertainty in physical measurements (e.g., noisy sensors in autonomous vehicles) and epistemic uncertainty (e.g., weights in a neural network). The present disclosure is relevant in its application to representations calculated from samples drawn from a discrete distribution. The present disclosure considers arithmetic propagations in the case of mutually independent random variables.

### Real-Valued Random Variables as Generalizations of Real Numbers.

In the generalized context of real-valued random variables, a given real number x₀∈ [symbol] R can be thought of as a random variable whose PDD is concentrated at a single point, namely at x=x₀. The PDD of such a point-valued variable is given by the Dirac delta distribution. Let [symbol] ( [symbol] ) denote the space of continuous functions on [symbol] . We will refer to the bounded linear functional δ: [symbol] ( [symbol] )→ [symbol] defined by:

$$δ ( f ) = {\int }_{ℝ} f ( x ) δ ( x ) dx := f ( 0 ) , ∀ f ∈ C ( ℝ )$$

as the Dirac delta distribution. Note that δ is not a function as the conventional integral notation may misleadingly infer. Yet, we will still employ the notation x₀:=: δ(x−x₀) interchangeably to stand for a Dirac delta distribution with evaluation at x=x₀, as this notation is in line with application of change of variables in the integral notation. Henceforth, we will regard all real numbers x₀∈ [symbol] as point-valued random variables with the associated PDD given by δₓ₀.

Herein we refer to a PDD ƒ_{X} is a ‘sum of Dirac deltas’ (SoDD) representation when it is of the form:

$${f}_{X} ( x ) = {\sum }_{n = 1}^{N} {p}_{n} δ ( x - {x}_{n} )$$

Where pₙ∈[0,1] with:

$${\sum }_{n = 1}^{N} {p}_{n} = 1$$

### Finite-Dimensional Representations

To provide some examples, for a better understanding of the invention, the present disclosure introduces five finite-dimensional representation methods. Algorithms are presented to calculate the representation for a given method from a given PDD, as well as algorithms to derive an approximating PDD from a given finite-dimensional representation together with rules governing their propagation under arithmetic operations of addition and multiplication.

### Finite-Dimensional Representation Methods

For a given finite-dimensional representation method, [symbol] , a representation [symbol] is a mapping of random variables (or their PDDs) into [symbol] ^{N}, where we call N the dimension of the representation. This disclosure describes for each method [symbol] considered here the corresponding representation [symbol] . The information on ƒ_{X} may be provided by data samples.

For a given SoDD-based representation we denote by N_{dd} the number of Dirac deltas in the corresponding SoDD distribution. N_{dd} is not same as the dimension N, which is equal to the minimum number of real numbers required to specify the approximating SoDD distribution within the context of given representation method. In general, we have N_{dd}<N. Table 1 summarizes the relations of N_{dd} to N for each examples of SoDD-based representation methods disclosed herein and discussed in more detail below.

TABLE 1

| Representation | N_{dd} | Nₖ | N_{dd} for N = 16 |
|---|---|---|---|
| RQHR | N − 2 | N_{dd}^{k} + 2k | 14 |
| PQHR | N | N_{dd}^{k} | 16 |
| MQHR | N/2 | 2N_{dd}^{k} | 8 |
| TTR | N/2 | 2N_{dd}^{k} | 8 |

### Example 1: Regularly-Quantized Histogram Representation (RQHR)

This representation method assumes that the value range R(X) of a given variable X is known and finite, i.e., |R(X)|<1. Note that this is always the case if the PDD of X is constructed from finitely many samples. The underlying idea is to create an approximating SoDD distribution by dividing R(X) into N_{dd} equal-sized (regular) intervals and to represent the given PDD by a weighted Dirac delta located at the center of each interval with the weight equal to the probability mass of the PDD over the corresponding interval. If we define x₀:=inf R(X) and l_{X}:=|R(X)|/N, then the aforementioned regular intervals have the form:

Iₙ=(x₀+(n−1)l_{X},x₀+nl_{X}),1≤n≤N_{dd}

The probabilities pₙ over these intervals are given by:

$$\\ {p}_{n} = {\int }_{{I}_{n}} {f}_{X} dx , 1 \leq n \leq {N}_{dd}$$

Then, the N-dimensional regularly-quantized histogram representation (RQHR) of X is defined as the ordered N-tuple:

[symbol]

_{RQHR}^{N}(X):=(x₀,l_{X},p₁, . . . ,p_{N}_{_{dd}})

Here N_{dd}=N−2. The corresponding approximating SoDD distribution for the RQHR in has the form:

$$\\ \tilde{f} {}_{X}^{{}_{} RQHR} ( x ) := {\sum }_{n = 1}^{{N}_{dd}} {p}_{n} δ ( x - ( {x}_{0} + ( n - \frac{1}{2} ) {l}_{X} ) )$$

### Example 2: Probability-Quantized Histogram Representation (PQHR)

As in the RQHR method, where the value range of X was regularly quantized, this method also quantizes the range into intervals, but with intervals having the same probability mass.

First, define the interval:

$$\\ {I}_{n} = {F}_{X}^{{}_{} - 1} ( [ \frac{n - 1}{{N}_{dd}} , \frac{n}{{N}_{dd}} ) ) , 1 \leq n \leq {N}_{dd}$$

The function F_{X}⁻¹ is the inverse of F_{X}, where F_{X} is the cumulative distribution function of the random variable X.

The expected value μ_{Xn} of Xₙ within a given interval, of probability mass common to all intervals, is:

$$\\ {μ}_{{X}_{n}} = {( {\int }_{{I}_{n}} {f}_{X} ( x ) dx )}^{- 1} {\int }_{{I}_{n}} {xf}_{X} ( x ) dx = {N}_{dd} {\int }_{{I}_{n}} {xf}_{X} ( x ) dx$$

Then, the N-dimensional probability-quantized histogram representation (PQHR) of X is defined as the ordered N-tuple:

$${PQHR}_{N}^{} ( X ) := ( {μ}_{{X}_{1}} , … , {μ}_{{X}_{{N}_{dd}}} )$$

Here N_{dd}=N. The corresponding approximating SoDD distribution for the PQHR in has the form:

$$\\ \tilde{f} {}_{X}^{{}_{} PQHR} ( x ) := \frac{1}{{N}_{dd}} {\sum }_{n = 1}^{{N}_{dd}} {δ}_{{μ}_{{X}_{n}}}$$

### Example 3: Moment-Quantized Histogram Representation (MQHR)

Given a random variable X with PDD ƒ_{X} and expected values μ_{X}, let CMF_{X} be the cumulative moment function of X, defined by:

$$\\ C M {F}_{X} ( x ) = {{\int }^{x}}_{- ∞} \vert ξ - {μ}_{X} \vert {f}_{X} ( ξ ) d ξ$$

Note that CMF_{X} is monotone increasing and thus we have:

$$\\ {lim}_{x \to + ∞} C M {F}_{X} ( x ) = {TM}_{X}$$

where TM_{X} is the total moment of X around μ_{X} (i.e. setting x₀=μ_{X}) and given by:

$$\\ {TM}_{X} ( {x}_{0} ) := {\int }_{ℝ} \vert x - {x}_{0} \vert {f}_{X} ( x ) dx .$$

Here we assume that TM_{X} is finite, which is true for the practical cases of finitely-many sample generated PDDs. We partition the value range of X, e.g., the real line, by quantizing the cumulative moment TM_{X}. Thus, we define the intervals:

$$\\ {I}_{n} := C M {F}_{X}^{{}_{} - 1} ( ( \frac{( n - 1 ) {TM}_{X}}{{N}_{dd}} , \frac{{nTM}_{X}}{{N}_{dd}} ) ) , 1 \leq n \leq {N}_{dd}$$

As before, consider the expected value of X given X∈Iₙ:

$$\\ {x}_{n} := E [ X \vert X ∈ {I}_{n} ] = {( {\int }_{{I}_{n}} {f}_{X} ( x ) dx )}^{- 1} {\int }_{{I}_{n}} {xf}_{X} ( x ) dx = \frac{1}{{p}_{n}} {\int }_{{I}_{n}} {xf}_{X} ( x ) dx .$$

$$\\ Here , {p}_{n} := {\int }_{{I}_{n}} {f}_{X} ( x ) dx , 1 \leq n \leq {N}_{dd}$$

Then, the N-dimensional moment-quantized histogram representation (MQHR) of X is defined as the ordered N-tuple:

[symbol]

_{MQHR}^{N}(X):=(x₁, . . . ,x_{N}_{_{dd}},p₁, . . . ,p_{N}_{_{dd}})

Here, N_{dd}=N/2. The corresponding approximating SoDD distribution for the MQHR has the form:

$$\\ \tilde{f} {}_{X}^{{}_{} MQHR} ( x ) := {\sum }_{n = 1}^{{N}_{dd}} {p}_{n} δ ( x - {x}_{n} )$$

### Example 4: Telescoping Torques Representation (TTR)

For a random variable X with PDD ƒ_{X} and expected value μ_{X} we define:

Ω₋:={x∈ [symbol] :x<μ_{X}},Ω₊:={x∈ [symbol] :x≥μ_{X}}

and

X₋:=X|X∈Ω₋,X₊:=X|X∈Ω₊.

The following algorithm underlies the TTR method.

Let X be a random variable with PDD ƒ_{X} and expected value μ_{X}. There is a unique approximating PDD ƒ̅_{X} in the form of a SoDD distribution of size 2, that is:

\tilde{ƒ}_{X}(x)=p₋δ(x−x₋)+p₊δ(x−x₊), with p₋+p₊=1

such that:

$$\\ \begin{matrix}{\int }_{ℝ} x {\tilde{f}}_{X} ( x ) dx = {μ}_{X} , & ( 1 )\end{matrix}$$

$$\\ \begin{matrix}{\int }_{ℝ} \vert x - {μ}_{X} \vert {\tilde{f}}_{X} ( x ) dx = {\int }_{ℝ} \vert x - {μ}_{X} \vert {f}_{X} ( x ) dx , & ( 2 )\end{matrix}$$

$$\\ \begin{matrix}{\int }_{{Ω}_{+}} {\tilde{f}}_{X} ( x ) dx = {Pr}_{X} ( {Ω}_{+} ) . & ( 3 )\end{matrix}$$

Moreover, the above parameters p_{±} and x_{±} of this unique SoDD distribution of size 2 satisfy:

p₋=Pr_{X}(Ω₋),p₊=Pr_{X}(Ω₊),x₋=E[X₋],x₊=[E₊]

This circulates around the intuition that the expected value is the centre of mass of the PDD ƒ_{X}, as in a rod with mass density described by ƒ_{X} would stay in balance if supported from x=μ_{X}, and one has the full knowledge of counterbalancing torques (the 2 Dirac deltas in SoDD distribution), i.e., forces (weights or probability masses) and distances (positions), provided that one knows the magnitude of total moment applied from both sides (property (2), above) and the ratio of weights on both sides (property (3), above). One can iterate the idea of this unique 2-SoDD distribution that holds the torque information around the expected value in a telescoping manner, which gives rise to the name of TTR method, to arrive at a unique 2ⁿ-SoDD distribution that contains all the torque information around expected values of X restricted to special inductively-defined intervals of the form Ω₋ and Ω₊ given above.

The TTR of X is formulated inductively as follows. We define the 0th-order TTR of X to be its expected value, recorded as the N=2×2⁰=2-tuple:

[symbol]

_{TT}²(X)=(x₁,p₁)=(μ_{X},1)

This tuple represents a real number as taking the value μ_{X} with probability 1, with the corresponding approximating SoDD distribution of size 1:

\tilde{ƒ}_{X}^{TTR}(x)=δ(x−μ_{X})

The 1^{st}-order TTR of X is given by the N=2×2¹=4-tuple:

[symbol]

_{TT}⁴(X)=(x₁,x₂,p₁,p₂)=(x₋,x₊,p₋,p₊)

This corresponds to the unique SoDD distribution of size 2 given by the equations above. In general, n^{th}-order TTR of X will be a N=2×2ⁿ-tuple:

[symbol]

_{TT}ⁿ⁺¹(X)=(x₁, . . . ,x₂_{ⁿ}, . . . ,p₁, . . . ,p₂_{ⁿ})

This has a corresponding SoDD distribution of size N_{dd}=2ⁿ. For higher order TTRs we will introduce inductive extensions of definitions given above. For this we introduce the following indexing notation. Let a stand for a concatenated sequence of “−” and “+” signs, e.g., α=−+− or α=+, let |α| be the length of the sequence a and let α=+ and α=− mean the sequences of length |α|+1 that one obtains by concatenating a “−” sign or a “+” sign to the right end of a, respectively. We then inductively define:

Ω_{α-}:={x∈Ω_{α}:x<E[X_{α}]},Ω_{α+}:={x∈Ω_{α}:x≥E[X_{α}]}

and

X_{α-}:=X|X∈Ω_{α-},X_{α+}:=X|X∈Ω_{α+}

Note that for a given n≥1 there are 2ⁿ distinct sequences of length n and corresponding 2ⁿ domains Ω_{α} which are indeed intervals. These 2ⁿ intervals partition [symbol] and they are ordered in accordance with the enumeration φₙ where, for 1≤i≤2ⁿ, φₙ(i) is the sequence obtained by replacing 0's and 1's in the length-n binary representation of i−1 by “−” and “+” signs, respectively. For instance, φ₃(1)=−−− and φ₄(5)=−+−−. Then, the n^{th}-order TTR of X is defined as the ordered N-tuple (N=2ⁿ⁺¹):

$$\\ {ℛ}_{TTR}^{{}_{} N} ( X ) := ( {μ}_{{X}_{{φ}_{n} ( 1 )}} , … , {μ}_{{X}_{{φ}_{n} ( {N}_{dd} )}} , {p}_{{φ}_{n} ( 1 )} , … , {p}_{{φ}_{m} ( {N}_{dd} )} )$$

$$\\ Here : {p}_{{φ}_{n} ( i )} := {Pr}_{X} ( {Ω}_{{φ}_{n} ( 1 )} ) and {N}_{dd} = \frac{N}{2} = {2}^{{}_{} n}$$

The corresponding approximating SoDD distribution for the TTR has the form:

$$\\ \tilde{f} {}_{X}^{{}_{} TTR} ( x ) := {\sum }_{i = 1}^{{N}_{dd}} {p}_{{φ}_{n} ( i )} δ ( x - {μ}_{{X}_{{φ}_{n} ( n )}} )$$

### Example 5: Centralized Moments Representation (CMR)

The nth centralized moment of X, μₙ(X), where n≥0, is defined as:

$$\\ {μ}_{0} ( X ) := 1 , {μ}_{X} := {μ}_{1} ( X ) := {\int }_{ℝ} {xf}_{X} ( x ) dx ,$$

$$\\ {μ}_{n} ( X ) := {\int }_{ℝ} {( x - {μ}_{X} )}^{n} {f}_{X} ( x ) dx , n \geq 2.$$

Then, the N-dimensional centralized moment representation (CMR) of X is defined as the ordered N-tuple

[symbol]

_{CMR}^{N}(X):=(μ₁(X), . . . ,μ_{N}(X)

This definition of centralized moments differs from the typical definition in the literature: The first centralized moment, μ₁(X), is conventionally calculated centred at the expected value and is thus 0. By contrast, in the present disclosure we define μ₁(X) to equal the expected value of X. This formulation allows us to define all the centralized moments recursively in terms of lower-order centralized moments, with the zeroth-order centralized moment μ₀(X):=1 as the base case of the recursion.

Because the PDD is a collection of Dirac delta distributions, there are several methods of approximating PDD from the knowledge of centralized moments. Possible methods include Gram-Charlier series [ref 1] and Edgeworth-type expansions [ref 2]. In addition, one may use the formal Edgeworth series as described by Bhattacharya et al. [ref 3] to construct approximating PDDs from CMRs.

### Arithmetic Operations

In this part we outline the rules of arithmetic operations (propagations) of finite-dimensional representations we have just introduced. For a given two random variables X and Y the following disclosure describes how one propagates representations of X and Y of given type to find the same type of representation for the random variable Z:=(X; Y). The propagation rules for all SoDD-based representation methods, i.e., all except CMR, are the same, as they apply to the underlying SoDD distribution rather than the method of representation. Consequently, the following disclosure describes two sets of arithmetic propagation rules, one for CMR and one for SoDD-based representations. For sake of simplicity, in the case of arithmetic propagation of CMR we will restrict our attention to the arithmetic operations of addition and multiplication only. However, it is to be understood that an addition or multiplication of a value to a variable in a SoDD-based representation results in an offset or scaling of the position of the Dirac deltas of the representation and, therefore, the subtraction of two uncertain variables may be achieved by negating the SoDD-based representation of the subtrahend (i.e. the SoDD-based representation of the quantity or number to be subtracted from another) using multiplication with −1. For the case of division of variables in a SoDD-based representation, we define it as a multiplication using the reciprocal of the divisor variable. The reciprocal of a variable in a SoDD-based representation can be constructed by calculating the reciprocals of the input Dirac deltas positions. For example, division of two random variables of a SoDD Dirac mixture representation may be implemented as a multiplication of the dividend with the reciprocal of the divisor. The latter may be constructed by calculating the reciprocals of the positions of its Dirac mixture representation.

### Example 5: Propagation of SoDD-Based Representations

Suppose we are given an N-dimensional SoDD-based representation of fixed type, i.e., RQHR, PQHR, MQHR or TTR, and let us call it FDR. For two mutually independent random variables X and Y with approximating SoDD distributions of size N_{dd} given as:

$${\tilde{f}}_{X}^{F D R} ( x ) = {\sum }_{n = 1}^{{N}_{d d}} {p}_{n} δ ( x - {x}_{n} ) and {\tilde{f}}_{Y}^{F D R} ( y ) = {\sum }_{n = 1}^{{N}_{d d}} {q}_{n} δ ( y - {y}_{n} ) .$$

Propagation of these two PDDs in the form of SoDD distributions of size N_{dd} is done to obtain ƒ̅_{Φ(X:Y)}, a PDD in the form of a SoDD distribution of size N_{dd}², given by:

$${\tilde{f}}_{Φ ( X , Y )} ( z ) = {\sum }_{n = 1}^{{N}_{dd}} {\sum }_{m = 1}^{{N}_{d d}} {p}_{n} {q}_{m} δ ( z - Φ ( {x}_{n} , {y}_{m} ) ) .$$

Then, a “compacted” third tuple R_{FDR}^{N}(z̅) may be generated from this PDD ƒ̅_{Φ(X:Y)}, such that;

[symbol]

_{FDR}^{N}(Φ(X,Y)

This is the arithmetically-propagated N-dimensional representation for the random variable;

Z=Φ(X,Y)

which is found as the N-dimensional representation of the random variable Z described by the PDD ƒ̅_{Φ(X:Y)}, that is:

[symbol]

_{FDR}^{N}(Φ(X,Y)_:= [symbol] _{FDR}^{N}(\tilde{Z}).

This equation is where the larger M-tuple representation is reduced back to an N-tuple. This may preferably be done to enable a fixed size for the tuples that one calculates with. Thus, to enable further calculations with the derived tuples (the M-tuples above) one may reduce these M-tuples back to N-tuples. This may be achieved by considering the data represented by ƒ̅_{Φ(X:Y)} as being a new “obtained” data set (i.e. an obtained third set of data items, obtained as the result of the arithmetic operation) and therefrom generating a “compacted” third tuple, R_{FDR}^{N}(\tilde{z}), containing parameters encoding a probability distribution characterising the distribution of the data items of the third set defined by ƒ̅_{Φ(X:Y)}.

### Arithmetic Operations

For example, in the case of arithmetic on two RQHR representations, each defined as a respective ordered N-tuple:

[symbol]

_{RQHR}^{N}(X):=(x₀,l_{X},p₁, . . . ,p_{N}_{_{dd}})

the corresponding approximating SoDD distribution for the RQHR in has the form:

$${\tilde{f}}_{X}^{R Q H R} ( x ) := {\sum }_{n = 1}^{{N}_{dd}} {p}_{n} δ ( x - ( {x}_{0} + ( n - \frac{1}{2} ) {l}_{X} ) )$$

Of course, for the distribution in the variable Y we simply rewrite the above equation with the substitutions: X→Y and x→y and x₀→y₀ and l_{X}→l_{Y}. Thus, the xₙ, yₘ within Φ(xₙ>yₘ) of the propagation result, ƒ̅_{Φ(X:Y)}(z), are given by:

$${x}_{n} = {x}_{0} + ( n - \frac{1}{2} ) {l}_{X}$$

$${y}_{m} = {y}_{0} + ( m - \frac{1}{2} ) {l}_{Y}$$

In the case of the addition of distributions, the propagation result is:

$${\tilde{f}}_{Φ ( X , Y )} ( z ) = {\sum }_{n = 1}^{{N}_{dd}} {\sum }_{m = 1}^{{N}_{dd}} {p}_{n} {q}_{m} δ ( z - Φ ( {x}_{n} , {y}_{m} ) ) .$$

$$where$$

$$Φ ( {x}_{n} , {y}_{m} ) = {Φ}^{+} ( {x}_{n} , {y}_{m} ) = {x}_{n} + {y}_{m}$$

In the case of the multiplication of distributions, the propagation result is:

$${\tilde{f}}_{Φ ( X , Y )} ( z ) = {\sum }_{n = 1}^{{N}_{d d}} {\sum }_{m = 1}^{{N}_{d d}} {p}_{n} {q}_{m} δ ( z - Φ ( {x}_{n} , {y}_{m} ) ) .$$

$$where$$

$$Φ ( {x}_{n} , {y}_{m} ) = {Φ}^{\times } ( {x}_{n} , {y}_{m} ) = {x}_{n} \times {y}_{m}$$

For example, in the case of arithmetic on two PQHR representations, each defined as a respective ordered N-tuple:

$${ℛ}_{PQHR}^{N} ( X ) := ( {μ}_{{X}_{1}} , … , {μ}_{{X}_{{N}_{dd}}} )$$

the corresponding approximating SoDD distribution for the PQHR in has the form:

$${\tilde{f}}_{X}^{P Q H R} ( x ) := \frac{1}{{N}_{dd}} {\sum }_{n = 1}^{{N}_{d d}} {δ}_{{μ}_{{X}_{n}}}$$

Of course, for the distribution in the variable Y we simply rewrite the above equation with the substitutions: X→Y and x→y and μ_{Xn}→μ_{Ym}. Thus, the xₙ, yₘ within Φ(xₙ, yₘ) of the propagation result, ƒ̅_{Φ(X:Y)}(z), are given by:

$${x}_{n} = {μ}_{Xn} \\ {y}_{m} = {μ}_{Ym}$$

In the case of the addition of distributions, the propagation result is:

$${\tilde{f}}_{Φ ( X , Y )} ( z ) = {\sum }_{n = 1}^{{N}_{dd}} {\sum }_{m = 1}^{{N}_{dd}} {p}_{n} {q}_{m} δ ( z - Φ ( {x}_{n} , {y}_{m} ) ) .$$

$$where$$

$$Φ ( {x}_{n} , {y}_{m} ) = {Φ}^{+} ( {x}_{n} , {y}_{m} ) = {x}_{n} + {y}_{m}$$

In the case of the multiplication of distributions, the propagation result is:

$${f}_{Φ ( X , Y )} ( z ) = {\sum }_{n = 1}^{{N}_{dd}} {\sum }_{m = 1}^{{N}_{dd}} {p}_{n} {q}_{m} δ ( z - Φ ( {x}_{n} , {y}_{m} ) ) .$$

$$where$$

$$Φ ( {x}_{n} , {y}_{m} ) = {Φ}^{\times } ( {x}_{n} , {y}_{m} ) = {x}_{n} \times {y}_{m}$$

For example, in the case of arithmetic on two MQHR representations, each defined as a respective ordered N-tuple:

[symbol]

_{MQHR}^{N}(X):=(x₁, . . . ,x_{N}_{_{dd}},p₁, . . . ,p_{N}_{_{dd}})

the corresponding approximating SoDD distribution for the MQHR has the form:

$${\tilde{f}}_{X}^{MQHR} ( x ) := {\sum }_{n = 1}^{{N}_{d d}} {p}_{n} δ ( x - {x}_{n} )$$

Of course, for the distribution in the variable Y we simply rewrite the above equation with the substitutions: X→Y and x→y and xₙ→yₘ. Thus, the xₙ,yₘ within Φ(xₙ,yₘ) of the propagation result, ƒ̅_{Φ(X:Y)}(z), are given by xₙ and yₙ of the respective SoDD distributions directly. In the case of the addition of distributions, the propagation result is:

$${\tilde{f}}_{Φ ( X , Y )} ( z ) = {\sum }_{n = 1}^{{N}_{d d}} {\sum }_{m = 1}^{{N}_{d d}} {p}_{n} {q}_{m} δ ( z - Φ ( {x}_{n} , {y}_{m} ) ) .$$

$$where$$

$$Φ ( {x}_{n} , {y}_{m} ) = {Φ}^{+} ( {x}_{n} , {y}_{m} ) = {x}_{n} + {y}_{m}$$

In the case of the multiplication of distributions, the propagation result is:

$${\tilde{f}}_{Φ ( X , Y )} ( z ) = {\sum }_{n = 1}^{{N}_{d d}} {\sum }_{m = 1}^{{N}_{dd}} {p}_{n} {q}_{m} δ ( z - Φ ( {x}_{n} , {y}_{m} ) ) .$$

$$where$$

$$Φ ( {x}_{n} , {y}_{m} ) = {Φ}^{\times } ( {x}_{n} , {y}_{m} ) = {x}_{n} \times {y}_{m}$$

For example, in the case of arithmetic on two TTR representations, each defined as a respective ordered N-tuple:

$${TTR}_{N}^{} ( X ) := ( {μ}_{{X}_{{φ}_{n} ( 1 )}} , … , {μ}_{{X}_{{φ}_{n} ( {N}_{dd} )}} , {p}_{{φ}_{n} ( 1 )} , … , {p}_{{φ}_{n} ( {N}_{dd} )} )$$

the corresponding approximating SoDD distribution for the TTR has the form:

$${\tilde{f}}_{X}^{T T R} ( x ) := {\sum }_{i = 1}^{{N}_{dd}} {p}_{{φ}_{n} ( i )} ( x - {μ}_{{X}_{{φ}_{n} ( n )}} )$$

Of course, for the distribution in the variable Y we simply rewrite the above equation with the substitutions: X→Y and x→y and

$${μ}_{X {φ}_{n} ( n )} \to {μ}_{Y {φ}_{m} ( m )} .$$

Thus, the xₙ, yₘ within Φ(xₙ, yₘ) of the propagation result, ƒ̅_{Φ(X:Y)}(z), are given by:

$${x}_{n} = {μ}_{X {φ}_{n} ( n )}$$

$${y}_{m} = {μ}_{Y {φ}_{m} ( m )}$$

In the case of the addition of distributions, the propagation result is:

$${\tilde{f}}_{Φ ( X , Y )} ( z ) = {\sum }_{n = 1}^{{N}_{d d}} {\sum }_{m = 1}^{{N}_{d d}} {p}_{n} {q}_{m} δ ( z - Φ ( {x}_{n} , {y}_{m} ) ) .$$

$$where$$

$$Φ ( {x}_{n} , {y}_{m} ) = {Φ}^{+} ( {x}_{n} , {y}_{m} ) = {x}_{n} + {y}_{m}$$

In the case of the multiplication of distributions, the propagation result is:

$${\tilde{f}}_{Φ ( X , Y )} ( z ) = {\sum }_{n = 1}^{{N}_{d d}} {\sum }_{m = 1}^{{N}_{d d}} {p}_{n} {q}_{m} δ ( z - Φ ( {x}_{n} , {y}_{m} ) ) .$$

$$where$$

$$Φ ( {x}_{n} , {y}_{m} ) = {Φ}^{\times } ( {x}_{n} , {y}_{m} ) = {x}_{n} \times {y}_{m}$$

### Propagation of CMRs

For a given two random variables X and Y the following disclosure describes how one propagates representations of X and Y of given type to find the same type of representation for the random variable Z:=(X; Y). The use of multivariate Taylor expansion of Φ(X; Y) around the expected values of X and Y, i.e., around (μ_{X};μ_{Y}) yields:

$$Φ ( x , y ) = {\sum }_{i = 0}^{∞} {\sum }_{j = 0}^{∞} \frac{{\partial }^{i + j}}{{\partial }^{i} x {\partial }^{j} y} Φ ( {μ}_{X} , {μ}_{Y} ) \frac{{( x - {μ}_{X} )}^{i} {( y - {μ}_{Y} )}^{j}}{i ! j !} .$$

For the case of:

Z⁺=Φ⁺(X,Y)=X+Y

and

Z^{x}=Φ⁺(X,Y)=X×Y

The above Taylor expansion reduces to:

Φ⁺(x,y)=μ_{X}+μ_{Y}+(x−μ_{X})+(y−μ_{X})

and

Φ^{x}(x,y)=μ_{X}μ_{Y}+μ_{Y}(x−μ_{X})+μ_{X}(y−μ_{Y})+(x−μ_{X})(y−μ_{Y})

in the case of mutually independent random variables, i.e., ƒ_{X:Y}=ƒ_{X}ƒ_{Y}. This result is used to generate the value of Φ(xₙ, yₘ) (e.g., Φ(X;Y)=Φ⁺(x, y) or Φ(X;Y)=Φ^{x}(x, y) as appropriate) appearing within the function ƒ̅_{Φ(X:Y)}(z) defined above.

For the nth centralized moment of the random variable Z=(X; Y) we have:

$${μ}_{Z} := {μ}_{1} ( Z ) := {\int }_{{ℝ}^{2}} Φ ( x , y ) {f}_{X , Y} ( x , y ) dxdy ,$$

$${μ}_{n} ( Z ) := {\int }_{{ℝ}^{2}} {( Φ ( x , y ) - {μ}_{Z} )}^{n} {f}_{X , Y} ( x , y ) dxdy , n \geq 2.$$

Approximation of this integral in terms of the centralized moments of X and Y uses of multivariate Taylor expansion, defined above, around the expected values of X and Y, i.e., around (μ_{X}; μ_{Y}). This gives approximations for the first N centralized moments of Z⁺ and Z^{x} in terms of the first N centralized moments of X and Y as:

$$\begin{matrix}{μ}_{{Z}^{+}} = {μ}_{1} ( {Z}^{+} ) = {\int }_{{ℝ}^{2}} {Φ}^{+} ( x , y ) {f}_{X , Y} ( x , y ) dxdy \\ = {\int }_{{ℝ}^{2}} [ {μ}_{X} + {μ}_{Y} + ( x - {μ}_{X} ) + ( y - {μ}_{Y} ) ] {f}_{X} ( x ) {f}_{Y} ( y ) dxdy \\ = {μ}_{X} + {μ}_{Y}\end{matrix} ,$$

$$\begin{matrix}{μ}_{n} ( {Z}^{+} ) = {\int }_{{ℝ}^{2}} {( {Φ}^{+} ( x , y ) - {μ}_{{Z}^{+}} )}^{n} {f}_{X , Y} ( x , y ) dxdy \\ = {\int }_{{ℝ}^{2}} {[ ( x - {μ}_{X} ) + ( y - {μ}_{Y} ) ]}^{n} {f}_{X} ( x ) {f}_{Y} ( y ) dxdy \\ = {\sum }_{i + j = n} \frac{n !}{i ! j !} ( {\int }_{ℝ} {( x - {μ}_{X} )}^{i} {f}_{X} ( x ) dx ) ( {\int }_{ℝ} {( y - {μ}_{Y} )}^{j} {f}_{Y} ( y ) dy ) \\ = {\sum }_{\begin{matrix}i + j = n \\ i , j \neq 1\end{matrix}} \frac{n !}{i ! j !} {μ}_{i} ( X ) {μ}_{j} ( Y ) , 2 \leq n \leq N\end{matrix} ,$$

$$and$$

$$\begin{matrix}{μ}_{{Z}^{\times }} = {μ}_{1} ( {Z}^{\times } ) = {\int }_{{ℝ}^{2}} {Φ}^{\times } ( x , y ) {f}_{X , Y} ( x , y ) dxdy \\ = {\int }_{{ℝ}^{2}} [ {μ}_{X} {μ}_{Y} + {μ}_{Y} ( x - {μ}_{X} ) + {μ}_{X} ( y - {μ}_{Y} ) + \\ ( x - {μ}_{X} ) ( y - {μ}_{Y} ) ] {f}_{X} ( x ) {f}_{Y} ( y ) dxdy \\ = {μ}_{X} {μ}_{Y}\end{matrix} ,$$

$$\begin{matrix}{μ}_{n} ( {Z}^{\times } ) = {\int }_{{ℝ}^{2}} {( {Φ}^{\times } ( x , y ) - {μ}_{{Z}^{\times }} )}^{n} {f}_{X , Y} ( x , y ) dxdy \\ = {\int }_{{ℝ}^{2}} [ {μ}_{Y} ( x - {μ}_{X} ) + {μ}_{X} ( y - {μ}_{Y} ) + \\ {( x - {μ}_{X} ) ( y - {μ}_{Y} ) ]}^{n} {f}_{X} ( x ) {f}_{Y} ( y ) dxdy \\ = {\sum }_{i + j + k = n} \frac{n !}{i ! j ! k !} {μ}_{Y}^{i} {μ}_{X}^{j} ( {\int }_{ℝ} ( x - \\ {{μ}_{X} )}^{i + k} {f}_{X} ( x ) dx ) ( {\int }_{ℝ} {( y - {μ}_{Y} )}^{j + k} {f}_{Y} ( y ) dy ) \\ = {\sum }_{\begin{matrix}i + j + k = n \\ i + k , j + k \neq 1\end{matrix}} \frac{n !}{i ! j ! k !} {μ}_{Y}^{i} {μ}_{X}^{j} {μ}_{i + k} ( X ) {μ}_{j + k} ( Y ) , 2 \leq n \leq N\end{matrix} .$$

For example, let X and Y be two mutually independent random variables with N-dimensional CMRs:

[symbol]

_{CMR}^{N}(X)=(μ₁(X), . . . ,α_{N}(X)) and [symbol] _{CMR}^{N}(Y)=(μ₁(Y), . . . ,α_{N}(Y)).

respectively. Then, one can calculate the N-dimensional CMRs:

[symbol]

_{CMA}^{N}(Z⁺)=(μ₁(Z⁺), . . . ,μ_{N}(Z⁺)) and [symbol] _{CMR}^{N}(Z^{x})=(μ₁(Z^{x}), . . . ,μ_{N}(Z^{x})

of the random variables Z⁺=X+Y and Z^{x}=X×Y exactly via the relations given above, respectively.

The present invention may encode, represent and propagate distributional information/data (e.g., probability distributions, frequency distributions etc.) representing uncertainty in measurement data made by a measurement apparatus (e.g., sensor) and/or may propagate distributional information/data defining distributional weights of an artificial neural network.

In general, an arithmetic operation may be performed by using the parameters (e.g., Dirac delta position, height/probability) of the first tuple (i.e., representing a first distribution), and using the parameters (e.g., e.g., Dirac delta position, height/probability) of the second tuple (i.e., representing a second distribution) to generate a third tuple comprising parameters (e.g., e.g., Dirac delta position, height/probability) having values defining the distribution resulting from the arithmetic operation applied to the first distribution and the second distribution. This third tuple may then preferably be used to generate a “compacted” third tuple, as described herein, which has the same size (e.g., an N-tuple) as that of the first and second tuples. The first and second tuples preferably have the same size (e.g., both being an N-tuple).

The positions of Dirac delta functions representing data of the third distribution may be defined by the position values calculated (e.g., as disclosed herein) using the positions of Dirac delta functions representing data of the first and second data distributions. These position values of the first and second data distributions may be contained within the first and second tuples. The heights/probabilities of Dirac delta functions representing data of the third distribution may be generated by calculating the product of the heights/probabilities of the Dirac delta functions representing data of the first and second data distributions. These height/probability values of the first and second data distributions may be contained within the first and second tuples.

The third tuple may contain probability values (e.g., Dirac delta height/probability) each generated according to a respective probability value in the first tuple and a respective probability value in the second tuple (e.g., a product of a respective probability value in the first tuple and a respective probability value in the second tuple when the arithmetic operation is a multiplication operation or an addition operation etc.). The probability values may represent an amplitude, height or weighting of a Dirac delta function within a distribution represented by the third tuple.

The third tuple may contain position values each generated according to a respective position value in the first tuple and a respective position value in the second tuple (e.g., a product (or an addition) of a respective position value in the first tuple and a respective position value in the second tuple when the arithmetic operation is a multiplication operation (or an addition operation) etc.). The position values may represent a position of a Dirac delta function within a distribution represented by the third tuple.

The invention is not limited to Dirac delta function-based representations (such as MQHR), and the first, second and third tuples may generally contain parameters, according to other representations, e.g., encoding the position and/or width of data intervals within the probability distribution characterising the distribution of the data items of the first, second and third distributions. For example, the first, second and third tuples may contain parameters encoding the value of one or more statistical moments of a probability distribution characterising the distribution of data items.

The arithmetic process allows each parameter of the third tuple to be generated using the parameters of the first tuple and the second tuple. Once the parameters of the third tuple are calculated, then this fully encodes the distributional information of the third distribution, permitting that third distribution to be reproduced as and when required, and permitting the third tuple to be stored in a memory medium and/or transmitted as a signal, in a very efficient form.

In other aspects, either separately or in conjunction with any other aspect herein, the invention may concern the following aspects. In other words, any one or more of the aspects described below may be considered as applying separately from, or in combination with, any of the aspects described above. For example, the apparatus described above may comprise the microarchitecture described below, and similarly so for the methods described above and the methods described below.

In a third aspect, the invention may provide a method for computation on distributions of data, the method comprising providing a microarchitecture comprising:
a first register containing data items;
a second register containing distribution data representing distributions that are uncertainty representations associated with respective said data items;
a first arithmetic logic unit for executing arithmetic on data items selected from the first register;
a second arithmetic logic unit for executing arithmetic on distribution data selected from the second register;
the method comprising the following steps implemented by the microarchitecture:
   executing, by the first arithmetic logic unit, an arithmetic operation on data items selected from the first register, and outputting the result;
   executing, by the second arithmetic logic unit, an arithmetic operation on distribution data representing distributions selected from the second register that are associated with the data items selected from the first register, and outputting the result;
   wherein the arithmetic operation executed on the distribution data selected from the second register is the same as the arithmetic operation executed on the data items selected from the first register thereby to generate further distribution data representing uncertainty associated with the result of the arithmetic operation executed on the data items selected from the first register.

In this way, a first register (e.g. item ‘f0’ of FIG. 6A) may contain data that may be a single item. The second register (e.g. item ‘df0’ of FIG. 6A) may contain distribution data of uncertainty representations of the single item contained in the first register. References herein to a first register containing data items may be considered to include a reference to a first set of registers containing data items. Similarly, references herein to a second register containing distribution data representing distributions may be considered to include a reference to a second set of registers containing distribution data representing distributions. A set of registers may be considered to be a register file.

Preferably, the first register may comprise a first set of registers, and/or may comprise a register file. Preferably, the second register may comprise a first set of registers, and/or may comprise a register file.

In the method, the microarchitecture may comprise, for example, a floating-point register file configured to contain floating-point data. The floating-point register file may contain a first register file configured for containing particle data items, and a second register file configured for containing distribution data. The microarchitecture may comprise, for example, an integer register file configured to contain integer data. The integer register file may contain a first register file configured for containing particle data items, and a second register file configured for containing distribution data. The distributional data may represent distributions (e.g. SoDD-based representations) that are uncertainty representations associated with respective “particle” data items in the first register file. In the method, the floating-point register file may associate a given “particle” data item in the first register file with its associated distributional data within the second register file by assigning one common register file entry identifier to both a given “particle” data value within the first register file and the distributional data entry in the second register file that is to be associated with the “particle” data in question. In this way, the floating-point and/or integer register files in the microarchitecture may associate all floating-point and/or integer registers with distributional information.

The microarchitecture, and the invention in general, may calculate more complex arithmetic operations e.g., fused multiplication and addition or square root, by expressing them in terms of the aforementioned basic arithmetic operations, as would be readily apparent the skilled person.

Desirably, the execution of the arithmetic operation by the second arithmetic logic unit is triggered by a command that triggers the execution of the arithmetic operation by the first arithmetic logic unit. The arithmetic operation preferably comprises one or more of: addition; subtraction; multiplication; division. The invention in general may calculate more complex arithmetic operations e.g., fused multiplication and addition or square root, by expressing them in terms of the aforementioned basic arithmetic operations, as would be readily apparent to the skilled person.

The method may include providing said microarchitecture comprising a memory unit configured to store said data items at addressed memory locations therein, the method comprising the following steps implemented by the microarchitecture: obtaining the originating memory location addresses of data items that contribute to the arithmetic operation executed by the first arithmetic logic unit as the first arithmetic logic unit executes the arithmetic operation; and, storing the obtained originating memory location addresses at a storage location within the memory unit and associating the storage location with said further distribution data. The obtained originating memory locations may be stored in a combined form, such that multiple originating memory location addresses may be stored together, e.g., in a table, with multiple originating memory location addresses stored in the same table entry/location.

The results of arithmetic operations may be output to a random-access memory. These output results may comprise both “particle” data values and distributional data. Each “particle” data value may be stored in a memory unit, providing a physical address space, and may be associated with a distribution representation stored in a distributional memory unit. A memory access unit and a register writeback unit may be provided to define an interface between the register files and the arithmetic logic units of the microarchitecture. The Instruction Fetch unit may be provided in communication with the “particle” memory unit for accessing the memory unit for fetching instructions therefrom. A Load/Store unit may be provided to be in direct communication with the distributional memory unit, and an Instruction Fetch unit may be provided but not so connected. This means that the execution of arithmetic operations on distributional data may take place automatically without requiring, or interfering with, the operation of the Instruction Fetch unit. In this way, the calculation of distributional data, resulting from arithmetic operations on “particle” data and their associated distributional data, may take place at the microarchitectural level. Accordingly, the microarchitecture may be configured to allow only load/store instructions to access the random-access memory. Consequently, an extended memory may be provided in this way to which the microarchitecture can load and store both the “particle” and distributional information of the microarchitecture registers.

In the method, the microarchitecture may be configured to track which memory addresses of a memory unit have contributed to the calculation of the value of any given floating-point or integer register at any point in time. When a “particle” value resulting from an arithmetic operation, is output from a register of the microarchitecture, the output data of a particle value resulting from an arithmetic operation may be stored in memory. The information about the original addresses, or originating addresses, of the particle data items that contributed to the output result (referred to herein as “origin addresses” or “ancestor addresses”; these two terms refer to the same thing) may also be stored within a memory unit. The processor may be configured to subsequently recall the origin addresses when the contents of the register (e.g., the stored “particle” value) are loaded from memory for further use. This is discussed in more detail below and we refer to this correlation tracking as the “origin addresses tracking” mechanism. In the present invention, in preferred embodiments, the value of each floating-point/integer register originates from one or more address of the memory unit. By maintaining and propagating these addresses the invention is able to dynamically identify correlations between any two floating-point/integer registers. This information may be maintained, for example, using a dynamically linked list of “origin addresses”.

In the method, the first register preferably contains a first data item and a second data item. For example, the first register may comprise a first set of registers containing data items, which include the first data item and the second data item. Preferably, the first data item comprises a value of a first random variable, and the second data item comprises a value of a second random variable. Similarly, the second register may comprise a second set of registers containing distribution data representing distributions. For example, the first and second registers may each be a register file. Desirably, the second register contains first distribution data comprising a first tuple containing parameters encoding a probability distribution characterising the uncertainty representation associated with the first data item. Preferably, the second register contains second distribution data comprising a second tuple containing parameters encoding a probability distribution characterising the uncertainty representation associated with the second data item in which the parameters used to encode the second distribution data are the same as the parameters used to encode the first distribution data.

Desirably, said executing, by the second arithmetic logic unit, an arithmetic operation on distribution data comprises selecting the first tuple and the second tuple and therewith generating a third tuple using parameters contained within the first tuple and using parameters contained within the second tuple, the third tuple containing parameters encoding said further distribution data. The method may comprise outputting the third tuple. The outputting of the tuple may comprise outputting it to a memory for storage, or outputting to a transmitter for transmission.

Preferably, the third tuple contains parameters encoding said further distribution data that are the same as the parameters used to encode the probability distribution characterising the uncertainty representation associated with the first data item. Of course, if the second tuple contains parameters encoding a probability distribution that are the same as the parameters used in the first tuple to encode the first distribution data, as discussed above, then these parameters will also be the same parameters (i.e. “same” in nature, but generally not “same” in value) as used in the third tuple.

Desirably, the distribution data comprises probability distributions of respective data Items.

Preferably, the first tuple contains parameters encoding the position of data items within the probability distribution characterising the uncertainty representation associated with the first data item. Desirably, the second tuple contains parameters encoding the position of data items within the probability distribution characterising the uncertainty representation associated with the second data item. Preferably, the third tuple contains parameters encoding the position of data items within a probability distribution characterising the further distribution data.

Desirably, the first tuple contains parameters encoding the position and/or width of data intervals within the probability distribution characterising the uncertainty representation associated with the first data item. Preferably, the second tuple contains parameters encoding the position and/or width of data intervals within the probability distribution characterising the uncertainty representation associated with the second data item. Desirably, the third tuple contains parameters encoding the position and/or width of data intervals within a probability distribution characterising the further distribution data.

Preferably the first tuple contains parameters encoding the probability of data items within the probability distribution characterising the uncertainty representation associated with the first data item. Desirably, the second tuple contains parameters encoding the probability of data items within the probability distribution characterising the uncertainty representation associated with the second data item. Preferably, the third tuple contains parameters encoding the probability of data items within a probability distribution characterising the further distribution data.

Preferably, the first tuple contains parameters encoding the value of one or more statistical moments of the probability distribution characterising the uncertainty representation associated with the first data item. Desirably, the second tuple contains parameters encoding the value of one or more statistical moments of the probability distribution characterising the uncertainty representation associated with the second data item. Preferably, the third tuple contains parameters encoding the value of one or more statistical moments of a probability distribution characterising the further distribution data.

Preferably, the probability distribution characterising the uncertainty representation associated with the first data item comprises a distribution of Dirac delta functions. Desirably, the probability distribution characterising the uncertainty representation associated with the second data item comprises a distribution of Dirac delta functions. Preferably, the probability distribution characterising the further distribution data comprises a distribution of Dirac delta functions.

Preferably, the first tuple is an N-tuple in which N>1 is an integer. Preferably, the second tuple is an N-tuple in which N>1 is an integer. Desirably, the third tuple is an M-tuple for which N²/2<M<2N² in which N>1 is an integer. The outputting of the results from the first and/or second arithmetic logic unit may comprise one or more of: storing the output in a memory; transmitting a signal conveying the output.

In another aspect, the invention may provide a computer program product comprising a computer program which, when executed on a computer, implements the method described above in the third aspect of the invention. In yet another aspect, the invention may provide a computer programmed with a computer program which, when executed on the computer, implements the method described above in the third aspect of the invention.

In a fourth aspect, the invention may provide a microarchitecture for computation on distributions of data comprising:
a first register configured for containing data items;
a second register configured for containing distribution data representing distributions that are uncertainty representations associated with respective said data items;
a first arithmetic logic unit configured for executing arithmetic on data items selected from the first register;
a second arithmetic logic unit configured for executing arithmetic on distribution data selected from the second register;
   the microarchitecture configured to implement the following steps:
executing, by the first arithmetic logic unit, an arithmetic operation on data items selected from the first register, and outputting the result;
executing, by the second arithmetic logic unit, an arithmetic operation on distribution data representing distributions selected from the second register that are associated with the data items selected from the first register, and outputting the result;
wherein the arithmetic operation executed on the distribution data selected from the second register is the same as the arithmetic operation executed on the data items selected from the first register thereby to generate further distribution data representing uncertainty associated with the result of the arithmetic operation executed on the data items selected from the first register.

Preferably, the first register may comprise a first set of registers, and/or may comprise a register file. Preferably, the second register may comprise a first set of registers, and/or may comprise a register file.

References herein to a first register containing data items may be considered to include a reference to a first set of registers containing data items. Similarly, references herein to a second register containing distribution data representing distributions may be considered to include a reference to a second set of registers containing distribution data representing distributions. A set of registers may be considered to be a register file.

The microarchitecture may comprise, for example, a floating-point register file configured to contain floating-point data. The floating-point register file may contain a first register file configured for containing particle data items, and a second register file configured for containing distribution data. The microarchitecture may comprise, for example, an integer register file configured to contain integer data. The integer register file may contain a first register file configured for containing particle data items, and a second register file configured for containing distribution data. The distributional data may represent distributions (e.g. SoDD-based representations) that are uncertainty representations associated with respective “particle” data items in the first register file.

The floating-point register file may associate a given “particle” data item in the first register file with its associated distributional data within the second register file by assigning one common register file entry identifier to both a given “particle” data value within the first register file and the distributional data entry in the second register file that is to be associated with the “particle” data in question. In this way, the floating-point and/or integer register files in the microarchitecture may associate all floating-point and/or integer registers with distributional information.

The microarchitecture maybe configured to execute an arithmetic operation comprising one or more of: addition; subtraction; multiplication; division, or more complex arithmetic operations e.g., fused multiplication and addition or square root, or any bivariate operation, e.g., exponentiation, by expressing them in terms of the aforementioned basic arithmetic operations, as would be readily apparent to the skilled person.

The microarchitecture may be configured to output the results of arithmetic operations to a random-access memory. These output results may comprise both “particle” data values and distributional data. The microarchitecture may be configured to store each “particle” data value in a memory unit, providing a physical address space, and may be associated with a distribution representation stored in a distributional memory unit. The microarchitecture may comprise a memory access unit and a register writeback unit to define an interface between the register files and the arithmetic logic units of the microarchitecture. The microarchitecture may comprise a Instruction Fetch unit configured in communication with the “particle” memory unit for accessing the memory unit for fetching instructions therefrom. The microarchitecture may comprise a Load/Store unit configured to be in direct communication with the distributional memory unit, and the microarchitecture may comprise an Instruction Fetch unit not so connected. This means that the execution of arithmetic operations on distributional data may take place automatically without requiring, or interfering with, the operation of the Instruction Fetch unit. Accordingly, the microarchitecture may be configured to allow only load/store instructions to access the random-access memory. Consequently, the microarchitecture may be configured to load and store both the “particle” and distributional information of the microarchitecture registers.

The microarchitecture may be configured to track which memory addresses of a memory unit have contributed to the calculation of the value of any given floating-point or integer register at any point in time. When a “particle” value resulting from an arithmetic operation, is output from a register of the microarchitecture, the output data of a particle value resulting from an arithmetic operation may be stored in memory. The information about the original addresses, or originating addresses, of the particle data items that contributed to the output result (referred to herein as “origin addresses” or “ancestor addresses”: these two terms refer to the same thing) may also be stored within a memory unit. The processor may be configured to subsequently recall the origin addresses when the contents of the register (e.g., the stored “particle” value) are loaded from memory for further use. This is discussed in more detail below and we refer to this correlation tracking as the “origin addresses tracking” mechanism. In the present invention, in preferred embodiments, the value of each floating-point/integer register originates from one or more address of the memory unit. By maintaining and propagating these addresses the invention is able to dynamically identify correlations between any two floating-point/integer registers. This information may be maintained, for example, using a dynamically linked list of “origin addresses”.

The microarchitecture may be configured to execute the arithmetic operation by the second arithmetic logic unit when triggered by a command that triggers the execution of the arithmetic operation by the first arithmetic logic unit. The outputting by the microarchitecture may comprise one or more of: storing the output in a memory; transmitting a signal conveying the output.

The microarchitecture may comprise a memory unit configured to store said data items at addressed memory locations therein. The microarchitecture is preferably configured to obtain the originating memory location addresses of data items that contribute to the arithmetic operation executed by the first arithmetic logic unit as the first arithmetic logic unit executes the arithmetic operation. The microarchitecture is preferably configured to store the obtained originating memory location addresses at a storage location within the memory unit and associating the storage location with said further distribution data. The obtained originating memory locations may be stored in a combined form, such that multiple originating memory location addresses may be stored together, e.g. in a table, with multiple originating memory location addresses stored in the same table entry/location.

The first register is preferably configured to contain a first data item and a second data item. For example, the first register may comprise a first set of registers containing data items, which include the first data item and the second data item. Preferably, the first data item comprises a value of a first random variable, and the second data item comprises a value of a second random variable. Similarly, the second register may comprise a second set of registers containing distribution data representing distributions. For example, the first and second registers may each be a register file. Preferably, the second register is configured to contain first distribution data comprising a first tuple containing parameters encoding a probability distribution characterising the uncertainty representation associated with the first data item. Desirably, the second register is configured to contain second distribution data comprising a second tuple containing parameters encoding a probability distribution characterising the uncertainty representation associated with the second data item in which the parameters used to encode the second distribution data are the same as the parameters used to encode the first distribution data.

The microarchitecture may be configured to execute, by the second arithmetic logic unit, an arithmetic operation on distribution data comprising selecting the first tuple and the second tuple and therewith generating a third tuple using parameters contained within the first tuple and using parameters contained within the second tuple, the third tuple containing parameters encoding said further distribution data. The microarchitecture may be configured to output the third tuple.

Desirably, the third tuple contains parameters encoding said further distribution data that are the same as the parameters used to encode the probability distribution characterising the uncertainty representation associated with the first data item.

Preferably, the distribution data comprises probability distributions of respective data items.

The first tuple may contain parameters encoding the position of data items within the probability distribution characterising the uncertainty representation associated with the first data item. The second tuple may contain parameters encoding the position of data items within the probability distribution characterising the uncertainty representation associated with the second data item. The third tuple may contain parameters encoding the position of data items within a probability distribution characterising the further distribution data.

The first tuple may contain parameters encoding the position and/or width of data intervals within the probability distribution characterising the uncertainty representation associated with the first data item. The second tuple may contain parameters encoding the position and/or width of data intervals within the probability distribution characterising the uncertainty representation associated with the second data item. The third tuple may contain parameters encoding the position and/or width of data intervals within a probability distribution characterising the further distribution data.

The first tuple may contain parameters encoding the probability of data items within the probability distribution characterising the uncertainty representation associated with the first data item. The second tuple may contain parameters encoding the probability of data items within the probability distribution characterising the uncertainty representation associated with the second data item. The third tuple may contain parameters encoding the probability of data items within a probability distribution characterising the further distribution data.

The first tuple may contain parameters encoding the value of one or more statistical moments of the probability distribution characterising the uncertainty representation associated with the first data item. The second tuple may contain parameters encoding the value of one or more statistical moments of the probability distribution characterising the uncertainty representation associated with the second data item. The third tuple may contain parameters encoding the value of one or more statistical moments of a probability distribution characterising the further distribution data.

The probability distribution characterising the uncertainty representation associated with the first data item may comprise a distribution of Dirac delta functions. The probability distribution characterising the uncertainty representation associated with the second data item comprises a distribution of Dirac delta functions. The probability distribution characterising the further distribution data comprises a distribution of Dirac delta functions.

The first tuple may be an N-tuple, in which N>1 is an integer. The second tuple may be an N-tuple, in which N>1 is an integer. The third tuple may be an M-tuple for which N²/2<M<2N² in which N>1 is an integer.

In other aspects, either separately or in conjunction with any other aspect herein, the invention may concern the following aspects. In other words, any one or more of the aspects described below may be considered as applying separately from, or in combination with, any of the aspects described above. For example, the apparatus described above may comprise the apparatus described below, and similarly so for the methods described above and the methods described below.

In another aspect, either separately or in conjunction with any other aspect herein, the invention may concern a method that can be implemented in software of within the hardware of a microprocessor, FPGA, or other digital computation device, for representing probability distributions of items including both numeric values (e.g., integers and floating-point approximate real numbers) as well as categorical values (e.g., sets of items that have no numeric interpretation). The invention may represent both distributions in the traditional statistical sense as well as set-theoretic collections where the elements of the set have different probabilities of membership. In the special case where the values in the sets are integers or floating-point numbers, the invention can be used as the data representation for a computing system that performs computation natively on probability distributions of numbers in the same way that a traditional microprocessor performs operations on integers and floating-point values, and methods and apparatus for executing arithmetic on distributions disclosed herein may be used.

In other aspects, either separately or in conjunction with any other aspect herein, the invention may concern the following aspects. In other words, any one or more of the aspects described below may be considered as applying separately from, or in combination with, any of the aspects described above. For example, the apparatus described above may comprise the apparatus described below, and similarly so for the methods described above and the methods described below.

In a fifth aspect, the invention may provide a computer-implemented method for the encoding of distributions of data, the method comprising:
obtaining a set of data items;
determining a probability (or frequency) distribution for the obtained data items;
selecting a sub-set of the data items within the obtained data set having a probability e.g. an aggregate probability of occurrence within the obtained data set which exceeds the value of a pre-set threshold probability or which comprise a pre-set number of data items having the highest probability of occurrence within the obtained data set;
generating a tuple for each of the data items within the sub-set whereby a respective tuple comprises a first value and a second value wherein the first value is a value of the respective data item and the second value is a value of the probability of occurrence of the respective data item within the obtained data set;
normalising the probability of occurrence of each respective selected data item such that the sum of said probabilities of occurrence of all selected data items is equal to 1.0;
providing a memory and for each tuple storing therein the first value thereof at a respective memory location;
providing a table (in software or hardware) and for each tuple storing therein the second value thereof in association with a pointer configured to identify the respective memory location of the first value thereof.

It is to be understood that the step of generating a tuple for each of the data items of the sub-set may be implemented either after or before the step of selecting a sub-set of data items. If is implemented after then the subsequent step of generating the tuples comprises generating tuples for only those data items within the sub-set. If is implemented before then the preceding/prior step of generating the tuples comprises generating tuples for all data items of the obtained data set and then the subsequent step of selecting the sub-set of data items proceeds by simply selecting those tuples possessing a value of probability which exceeds the value of a pre-set threshold probability or which define a pre-set number of tuples having the highest probability values amongst all of the tuples generated for the data set. In this way, the sub-set of data items may be selected via the tuples representing them, by proxy.

The set of data items may comprise a set of numeric values or may comprise a set of categorical values, or may represent value ranges (e.g. value ‘bins’ in a distribution or histogram). The set of data items may be obtained from a measurement apparatus (e.g. a sensor), or may be obtained from the output of a machine learning model (e.g., weights of an artificial neural network etc.), or may be obtained from the output of a quantum computer for use in a classical computer when the measurement of the state of qubits of the quantum computer collapses from their superposed states to measured values of “1” or “0” with associated probabilities (e.g. a vector of a Bemoulli random variables). The set of data items may be obtained from a database or memory store of data items (numeric or categorical).

The step of determining a probability distribution may comprise determining a statistical data set (or a population) comprising a listing or function showing all the possible values (or intervals, ranges/bins etc.) of the data and how often they occur. The distribution may be a function (empirical or analytical) that shows values for data items within the data set and how often they occur. A probability distribution may be the function (empirical or analytical) that gives the probabilities of occurrence of different possible/observed values of data items of the data set.

The method may include determining a probability of occurrence of the data items within the obtained data set which do not exceed the value of the pre-set threshold probability (or threshold frequency), or which are not amongst the pre-set number. In other words, the method may include determining the further probability of occurrence of data items within the obtained data set that do not belong to the sub-set. The step of normalising the probability of occurrence of each respective selected data item within the sub-set may be such that the sum of the further probability and said probabilities of occurrence of all selected data items is equal to 1.0. In this way, the further probability may take account of the probability of a data item of the obtained data set being outside of the sub-set and thereby provide an ‘overflow’ probability.

The method may include generating a collective tuple for data items of the obtained data set not within the sub-set comprising a first value and a second value wherein the first is a value collectively representative of the data items of the obtained data set not within the sub-set and the second value is a value of the normalised further probability of occurrence of the data items within the obtained data set, but not within the sub-set.

The method may include storing the first value of the collective tuple in said memory at a respective memory location, and storing in said table the second value of the collective tuple in association with a pointer configured to identify the respective memory location of the first value of the collective tuple.

The method may include generating a representation of the distribution probability distribution for the sub-set of data items using the first value and the second value of a plurality of the aforesaid tuples of the sub-set (e.g., using all of them). The method may include generating a representation of the distribution probability distribution for the obtained data items using the first value and the second value of a plurality of the aforesaid tuples of the sub-set and using the first value and the second value of the collective tuple.

A representation of the distribution probability distribution may be according to any representation disclosed herein (e.g., a SoDD—based representation). The method may include performing an arithmetic operation on two distributions wherein one or both of the distributions are generated as described above.

The aforesaid table may be a structured memory in a circuit structure rather than an array in a computer memory. The method may include providing a logic unit configured for receiving said tuples (e.g. of the sub-set, and optionally also the collective tuple) and for storing the second values thereof, in association with respective pointers, at locations within a sub-table of the table if the first values of the tuples comply with criteria defined by the logic unit. In this way, the method may structure the table to comprise sub-tables each of which contains data from tuples satisfying a particular set of criteria. The criteria defining any one of the sub-tables may, of course, be different to the criteria defining any of the other sub-tables.

The method may comprise providing a copula structure for combining the individual distributions represented using the tuples of separate tables (each formed as described above), or of separate sub-tables, to achieve joint distributions. The copula structure may be configured to generate a multivariate cumulative distribution function for which the marginal probability distribution of each variable is uniform on the interval [0, 1]. Copulas are used to describe the dependence between random variables. Copulas allow one to model and estimate the distribution of random variables by estimating marginals and copulae separately. There are many parametric copula families available to the skilled person for this purpose.

The logic unit may be configured to implement a probabilistic (e.g. non-Boolean) predicate for the table which is configured to return a probability (p) (i.e. rather than a Boolean ‘true/′false’ value), for each element of the table corresponding to a said first value (i.e. a value of a respective data item). The criteria defining different sub-tables may be implemented in this way. Since the predicate may be considered in terms of a predicate tree, this permits the predicate to be flattened into a string using pre-order traversal or post-order traversal of all of the nodes of the tree and this flattened tree can be used as the distribution representation, if desired. This may significantly reduce the size of the representation to being one that scales linearly with the size of the representation rather than exponentially. Techniques for pre-order traversal or post-order traversal of all of the nodes of the tree may be according to techniques readily available to the skilled person.

A tuple may take the form of a data structure consisting of multiple parts; an ordered set of data, e.g. constituting a record. References herein to a “tuple” may be considered to include a reference to a finite ordered list of elements. References herein to an “n-tuple” may be considered to include a reference to a sequence of n elements, where n is a non-negative integer.

In a sixth aspect, the invention may provide an apparatus for the encoding of distributions of data, the apparatus being configured to implement the following steps, comprising:
obtaining a set of data items;
determining a probability distribution for the obtained data items;
selecting a sub-set the data items within the obtained data set having a probability (e.g. aggregate probability) of occurrence within the obtained data set which exceeds the value of a pre-set threshold probability or which comprise a pre-set number of data items having the highest probability of occurrence within the obtained data set;
generating a tuple for each of the data items within the sub-set whereby a respective tuple comprises a first value and a second value wherein the first value is a value of the respective data item and the second value is a value of the probability of occurrence of the respective data item within the obtained data set;
normalising the probability of occurrence of each respective selected data item such that the sum of said probabilities of occurrence of all selected data items is equal to 1.0;
providing a memory and for each tuple storing therein the first value thereof at a respective memory location;
providing a table (in software or hardware) and for each tuple storing therein the second value thereof in association with a pointer configured to identify the respective memory location of the first value thereof.

The apparatus may be configured to implement the step of determining a probability distribution by determining a statistical data set (or a population) comprising a listing or function showing all the possible values (or intervals, ranges/bins etc.) of the data and how often they occur. Preferably, the apparatus may be implemented as a microprocessor, or a dedicated digital logic circuit, or an analogue circuit configured to perform the processing steps.

The apparatus may be configured to determine a probability of occurrence of the data items within the obtained data set which do not exceed the value of the pre-set threshold probability or are not amongst the pre-set number. The apparatus may be configured to implement the step of normalising the probability of occurrence of each respective selected data item within the sub-set may be such that the sum of the further probability and said probabilities of occurrence of all selected data items is equal to 1.0.

The apparatus may be configured to generate a collective tuple for data items of the obtained data set not within the sub-set comprising a first value and a second value wherein the first is a value collectively representative of the data items of the obtained data set not within the sub-set and the second value is a value of the normalised further probability of occurrence of the data items within the obtained data set, but not within the sub-set.

The apparatus may be configured to store the first value of the collective tuple in said memory at a respective memory location, and store in said table the second value of the collective tuple in association with a pointer configured to identify the respective memory location of the first value of the collective tuple.

The apparatus may be configured to generate a representation of the distribution probability distribution for the sub-set of data items using the first value and the second value of a plurality of the aforesaid tuples of the sub-set (e.g., using all of them). The apparatus may be configured to generate a representation of the distribution probability distribution for the obtained data items using the first value and the second value of a plurality of the aforesaid tuples of the sub-set and using the first value and the second value of the collective tuple.

The apparatus may be configured with a structured memory in a circuit structure rather than an array in a computer memory. The apparatus may provide a logic unit configured for receiving said tuples (e.g. of the sub-set, and optionally also the collective tuple) and for storing the second values thereof, in association with respective pointers, at locations within a sub-table of the table if the first values of the tuples comply with criteria defined by the logic unit.

The apparatus may provide a copula structure for combining the individual distributions represented using the tuples of separate tables (each formed as described above), or of separate sub-tables, to achieve joint distributions. The logic unit may be configured to implement a probabilistic (e.g., non-Boolean) predicate for the table which is configured to return a probability (p) (i.e. rather than a Boolean ‘true/′false’ value), for each element of the take corresponding to a said first value (i.e. a value of a respective data item). The criteria defining different sub-tables may be implemented in this way.

In another aspect, the invention may provide a computer program product comprising a computer program which, when executed on a computer, implements the method according to the invention described above. In another aspect, the invention may provide a computer programmed with a computer program which, when executed on the computer, implements the method according described above.

References herein to “threshold” may be considered to include a reference to a value, magnitude or quantity that must be equalled or exceeded for a certain reaction, phenomenon, result, or condition to occur or be manifested.

References herein to “distribution” in the context of a statistical data set (or a population) may be considered to include a reference to a listing or function showing all the possible values (or intervals) of the data and how often they occur. A distribution in statistics may be thought of as a function (empirical or analytical) that shows the possible values for a variable and how often they occur. In probability theory and statistics, a probability distribution may be thought of as the function (empirical or analytical) that gives the probabilities of occurrence of different possible outcomes for measurement of a variable.

The invention includes the combination of the aspects and preferred features described except where such a combination is clearly impermissible or expressly avoided.

In other aspects, either separately or in conjunction with any other aspect herein, the invention may concern the following aspects. In other words, any one or more of the aspects described below may be considered as applying separately from, or in combination with, any of the aspects described above. For example, the apparatus described above may comprise the apparatus described below, and similarly so for the methods described above and the methods described below.

In other aspects, either separately or in conjunction with any other aspect herein, the invention may concern the following aspects. In other words, any one or more of the aspects described below may be considered as applying separately from, or in combination with, any of the aspects described above. For example, the apparatus described above may comprise the apparatus described below, and similarly so for the methods described above and the methods described below.

In another aspect, either separately or in conjunction with any other aspect herein, the invention may concern rearranging instruction sequences to reduce numeric error in propagating uncertainty across the computation state (e.g., registers) on which the instruction sequences operate.

In a seventh aspect, the invention may provide a computer-implemented method for computing a numerical value for uncertainty in the result of a multi-step numerical calculation comprising a sequence of separate calculation instructions defined within a common “basic block”, the method comprising:
(a) identifying a “live-out” variable of the “basic block”;
(b) identifying calculation instructions on who's output the value of the “live-out” variable depends;
(c) providing a mathematical expression combining the calculation instructions identified at step (b);
(d) using the mathematical expression of provided at step (c) to compute a numerical value for uncertainty in the “live-out” variable;

wherein the uncertainty value computed at step (d) is the uncertainty in the result of the multi-step numerical calculation. It has been found that this process not only makes the final result of the calculation more accurate, but also makes the calculation process more efficient.

Preferably, in the method, for the live-out variables of a basic block, rather than computing the updated uncertainty for each instruction on whose results they depend, the sequence of instructions whose result determines the value of the live-out variable can be combined into a single expression for the purposes of computing the updated uncertainty of the live-out variable.

A reference to a variable as “live-out” may be considered to include a reference to a variable being “live-out” at a node (e.g. of an instruction sequence) if it is live on any of the out-edges from that node. A reference to a variable as “live-out” may be considered to include a reference to a variable being a live register entry (e.g. a register whose value will be read again before it is overwritten).

A reference to a “basic block” may be considered to include a reference to a sequence of instructions with no intervening control-flow instruction. The “live-in” variables for a basic block may be considered to be the program variables or machine registers whose values will be read before they are overwritten within the basic block. The “live-out” variables for a basic block may be considered to be the program variables or machine registers whose values will be used after the basic block exits. For the live-out variables of a basic block, rather than computing the updated uncertainty for each instruction on whose results they depend, the sequence of instructions whose result determines the value of the live-out variable can be combined into a single expression for the purposes of computing the updated uncertainty of the live-out variable.

In another aspect, the invention may provide a computer program product comprising a computer program which, when executed on a computer, implements the method according to the invention described above, in its first aspect.

In another aspect, the invention may provide a computer programmed with a computer program which, when executed on the computer, implements the method according described above, in the first aspect of the invention.

In an eighth aspect, the invention may provide an apparatus for computing a numerical value for uncertainty in the result of a multi-step numerical calculation comprising a sequence of separate calculation instructions defined within a common “basic block”, the apparatus configured to implement the following steps comprising:
(a) identifying a “live-out” variable of the “basic block”;
(b) identifying calculation instructions on who's output the value of the “live-out” variable depends;
(c) providing a mathematical expression combining the calculation instructions identified at step (b);
(d) using the mathematical expression of provided at step (c) to compute a numerical value for uncertainty in the “live-out” variable;

wherein the uncertainty value computed at step (d) is the uncertainty in the result of the multi-step numerical calculation.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1 schematically shows an apparatus according to embodiments of the invention;

FIG. 2 shows a schematic representation of approximating distributions for two data sets of measurement data;

FIG. 3 shows a schematic representation of calculating an arithmetic operation upon the two approximating distributions for two data sets of measurement data of FIG. 2;

FIG. 4 shows a schematic representation of calculating an arithmetic operation upon the two approximating distributions for two data sets of measurement data of FIG. 2;

FIG. 5 shows a schematic representation of a processor according to an embodiment of the invention;

FIG. 6A shows a schematic representation of a processor according to an embodiment of the invention;

FIG. 6B shows a schematic representation of a bit-level representation of distributional data according to an embodiment of the invention employing TTR (or RQHR) representation;

FIG. 6C shows a schematic representation of a module for conversion of an in-memory array of particle samples (e.g., data/measurement samples) including distributional information/data according to an embodiment of the invention employing TTR (or RQHR) representation;

FIG. 6D shows output plots of a distribution (a) of input data, and the result (b) of uncertainty tracking of the input data with autocorrelation tracking on or off, and the ground truth results obtained by exhaustively evaluating x*x for all the samples of x;

FIG. 6E shows a schematic representation of a distributional co-ALU which takes as input two distributional source registers and their origin addresses, according to an embodiment of the invention employing TTR (or RQHR) representation;

FIG. 7 shows steps on a process of generating a SoDD representation of uncertainty illustrating distributional information/data according to an example of the invention;

FIG. 8 shows a table of origin addresses of data elements used in a register according to an example of the invention;

FIG. 9 shows a series of RISC-V ISA instructions associated with the table of FIG. 8;

FIG. 10 shows two distributions each of which is a representation of uncertainty, and a further distribution which is the result of executing the arithmetic operation of addition on them according to an example of the invention;

FIG. 11(a)-(e) show distributions each of which is a representation of uncertainty, and further distributions which are the result of executing the arithmetic operation of: (b) addition, (c) subtraction, (d) multiplication, (e) division, on them according to an example of the invention;

FIG. 12(a)-(e) show distributions each of which is a representation of uncertainty, and further distributions which are the result of executing the arithmetic operation of: (c) addition, (d) subtraction, (e) multiplication, (f) division, on them according to an example of the invention;

FIG. 13A shows distributions representing uncertainty in a calculation of a thermal expansion coefficient calculated by applying arithmetic operations on distributions representing uncertainty in sensor measurement data, according to an example of the invention;

FIGS. 13B and 13C show distributions in measurements made by a temperature sensor (FIG. 13A), and the resulting measurement uncertainty distributions (FIG. 13B) representing uncertainty in the sensor measurement data, according to an example of the invention;

FIGS. 13D, 13E and 13F show distributions of uncertainty in measurements made by a quantum phase estimation (QPE) circuit of a variational quantum eigensolver device implementing a variational quantum eigensolver algorithm, the uncertainty distributions representing uncertainty in the measurement data according to an example of the invention;

FIG. 14 shows examples [graphs: (a), (b), (c) and (d)] of the probabilities of sets {n} of n values within each one of four different obtained data sets, and shows a sub-set of values from an obtained data set together with probability values for the occurrence of each value within the sub-set. Tuples formed from data values and associated probability values are shown. An approximating probability distribution is shown comprising a series of Dirac delta functions (SoDD) generated using the tuples;

FIG. 15 shows a hardware block diagram of one embodiment of the invention;

FIG. 16 shows an example probabilistic predicate tree;

FIG. 17 shows a flow chart of a process according to the invention;

FIGS. 18(a) and 18(b) show a program code (FIG. 18(a)) and an assembly language instruction sequence (FIG. 18(b)) generated by a compiler, from that program code;

FIG. 19 shows the program code (FIG. 18(a) and a TAD basic block therefor, together with calculation steps for calculation of uncertainty at stages of the basic block;

FIG. 20 shows the TAD basic block of FIG. 19 together with calculation steps for calculation of uncertainty at stages of the basic block;

FIG. 21 shows the TAD basic block of FIG. 19 together with calculation steps for calculation of uncertainty at stages of the basic block;

FIG. 22 shows the TAD code separated into multiple basic blocks.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

### Example

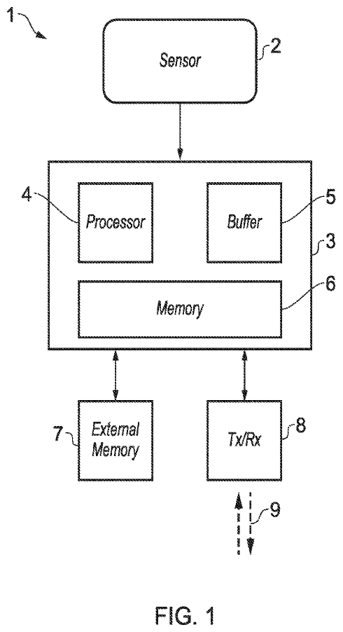

FIG. 1 shows an apparatus 1 according to an embodiment of the invention. The apparatus comprises a computing apparatus 3 which is connected in communication with a measurement device 2 in the form of a sensor unit (e.g. an accelerometer, a magnetometer etc.) which is configured to generate measurements of a pre-determined measurable quantity: a measurand (e.g. acceleration, magnetic flux density etc.). The computing apparatus 3 includes a processor unit 4 in communication with a local buffer memory unit 5 and a local main memory unit 6. The computing apparatus is configured to receive, as input, data from the sensor unit representing measurements of the measurand (e.g. acceleration, magnetic flux density etc.), and to store the received measurements in the local main memory unit 6. The processor unit 4, in conjunction with the buffer memory unit 5, is configured to apply to the stored measurements a data processing algorithm configured for sampling the sensor measurements stored in main memory, so as to generate a sample set of measurements which represents the uncertainty in measurements made by the sensor unit 2 while also representing the measurand as accurately as the sensor unit may allow.

This representation of uncertainty is achieved by generating the sample set such that the distribution of measurement values within the sample set represent the probability distribution of measurements by the sensor unit 2. The computing apparatus is configured to store the sample set, once generated, in its main memory 6 and/or to transmit (e.g. via a serial I/O interface) the sample set to an external memory 7 arranged in communication with the computing apparatus, and/or to transmit via a transmitter unit 8 one or more signals 9 conveying the sample set to a remote receiver (not shown). The signal may be transmitted (e.g. via a serial I/O interface) wirelessly, fibre-optically or via other transmission means as would be readily apparent to the skilled person.

In this way, the computing apparatus is configured to generate and store any number (plurality) of sample sets, over a period of time, in which the distribution of measurement values within each sample set represents the probability distribution of measurements by the sensor unit 2. Similarly, the computing apparatus is configured to generate and store any number (plurality) of sample sets, as generated by different modes of operation of the sensor unit 2 or as generated by different sensor unit 2. In other words, a first sample set stored by the computing apparatus may be associated with a first sensor unit and a second sample set stored by the computing apparatus may be associated with a second sensor unit which is not the same as the first sensor unit. For example, the first sensor unit may be a voltage sensor (electrical voltage) and the second sensor unit may be a current sensor (electrical current). In both cases, the computing apparatus may store distributions of measurement values made by each sensor, respectively, which each represent the probability distribution of measurements by that sensor unit 2.

The computing apparatus 3 is configured to implement a method for the encoding and computation on the distributions of data stored in the main memory unit, as follows.

As a first step, the computing apparatus 3 obtains a first set of measurement data items from the sensor unit 2 and obtains a second set of measurement data items from the sensor unit 2 (which may be the same sensor or a different sensor). These data sets are obtained from storage in the main memory unit and are stored in the buffer memory unit 5 for the duration of processing upon them. The processor unit 4 then applies to the first and second sets of measurement data items a process by which to generate an approximate distribution of the respective set of measurement data items. This process may be any one of the processes described above for generating an N-dimensional SoDD-based representation of fixed type, referred to above as FDR i.e., ROHR, PQHR, MQHR or TTR, or N-dimensional CMR representation. The processor unit applies the same process to each of the first and second measurement data sets, separately, so as to produce a first N-tuple containing parameters encoding a probability distribution characterising the distribution of the measurement data items of the first set, and a second N-tuple containing parameters encoding a probability distribution characterising the distribution of the measurement data items of the second set.

Note that the same process is applied, by the processor unit, the parameters used to encode the distribution of the data items of the second set (i.e. the positions, xₗ, of Dirac-δ functions representing data of the second set, and their heights/probabilities, pₗ) are the same as the parameters used to encode the distribution of the data items of the first set (i.e. the positions, xₗ, of Dirac-δ functions representing data of the first set, and their heights/probabilities, pₗ). Of course, the parameters (position, probability) are the same, but not their values.

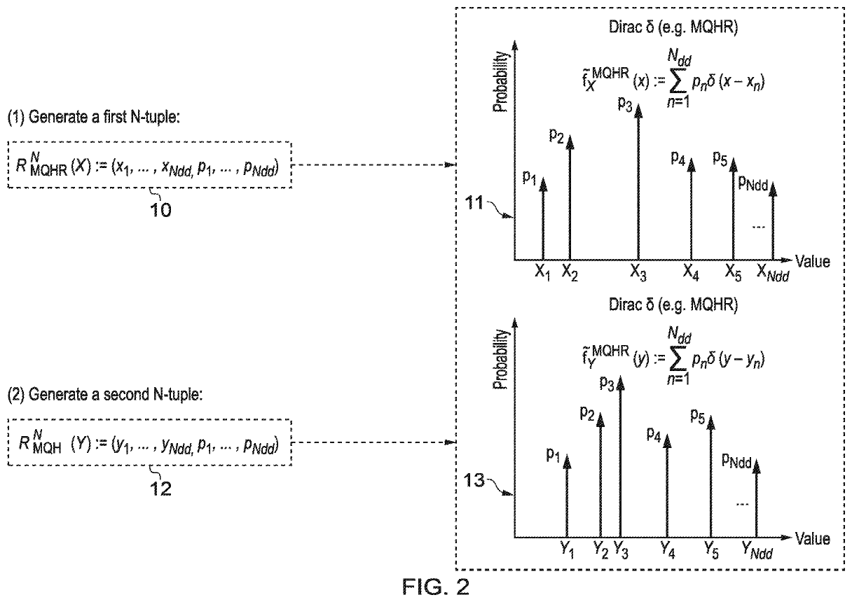

FIG. 2 shows a schematic example of this process for the case when the N-dimensional SoDD-based representation is the MQHR representation. The result of applying the MQHR processing to the first measurement data set is generate a first N-dimensional SoDD-based representation 11 of the first measurement data set, which is entirely defined by the parameters of a first N-tuple 10:

[symbol]

_{MQHR}^{N}(X):=(x₁, . . . ,x_{N}_{_{dd}},p₁, . . . ,p_{N}_{_{dd}})

Similarly, the result of applying the MQHR processing to the second measurement data set is generate a second N-dimensional SoDD-based representation 13 of the second measurement data set, which is entirely defined by the parameters of a second N-tuple 12:

R_{MQHR}^{N}(Y):=(y₁, . . . ,y_{Ndd},p, . . . ,p_{Ndd})

Note that the values of the parameters in the first N-tuple 10 will generally not be the same values as the values of the parameters of the second N-tuple 11. This is, of course, simply because the distributions of the measurement values in the first and second measurement data sets will generally not be the same as each other.

The processor unit 4 may be configured to store the first and second N-tuples (10, 11) in the main memory unit 6 for later use in applying an arithmetic operation (propagation) to them. The processor unit may then simply obtain the first and second N-tuples (10, 11) from the main memory unit 6 and place them, for example, in the buffer memory unit 5 for applying an arithmetic operation (propagation) to them as, and when required. In alternative embodiments, the processor may be configured to obtain the first tuple and the second tuple as output from a remote memory unit 7 or by receiving them as output from a receiver 8 in receipt of a signal 9 conveying the first and second tuples from a remote transmitter/source (not shown).

Next, the processor unit 4 generates a third tuple by applying an arithmetic operation on the first and second N-dimensional SoDD-based representations (11, 13) of the first and second measurement data sets, each of which is entirely defined by the parameters of its respective N-tuple (10, 12):

[symbol]

_{MQHR}^{N}(X):=(x₁, . . . ,x_{N}_{_{dd}},p₁, . . . ,p_{N}_{_{dd}})

To perform this arithmetic operation, the processor uses parameters (i.e. the positions, xᵢ, of Dirac-δ functions representing data, and their heights/probabilities, pₗ) contained within the first tuple and the parameters (i.e. the positions, xᵢ, of Dirac-δ functions representing data, and their heights/probabilities, pᵢ) contained within the second tuple. The result is a third tuple containing parameters encoding a probability distribution representing the result of applying the arithmetic operation on the first probability distribution and the second probability distribution. The processor then outputs the third tuple either to the local memory unit 6, for storage, and/or to the transmitter unit 8 for transmission 9.

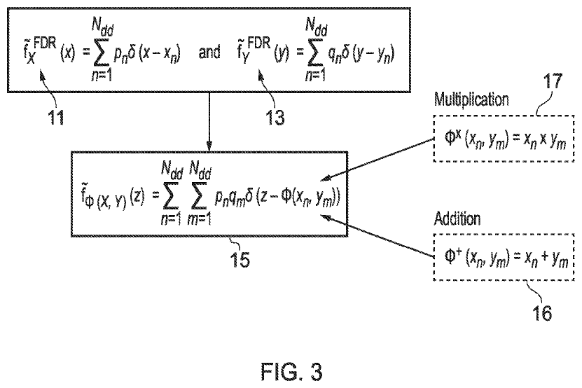

The processor unit is configured to implement an arithmetic operation comprising one or more of: addition; subtraction; multiplication; division, or any bivariate operation, e.g., exponentiation and many others. As an example of an arithmetic operation, FIG. 3 schematically represents the addition and multiplication operations on distributions approximated by the first and second N-dimensional SoDD-based representations (11, 13) of the first and second measurement data sets:

$${\tilde{f}}_{X}^{FDR} ( x ) = {\sum }_{n = 1}^{{N}_{dd}} {p}_{n} δ ( x - {x}_{n} ) and {\tilde{f}}_{Y}^{FDR} ( y ) = {\sum }_{n = 1}^{{N}_{dd}} {q}_{n} δ ( y - {y}_{n} ) .$$

These two distributions (where ‘FDR’=MQHR in this example) are added together or multiplied together to produce a third N-dimensional SoDD-based representation 15:

$${\tilde{f}}_{Φ ( X , Y )} ( z ) = {\sum }_{n = 1}^{{N}_{dd}} {\sum }_{m = 1}^{{N}_{dd}} {p}_{n} {q}_{m} δ ( z - Φ ( {x}_{n} , {y}_{m} ) ) .$$

The third SoDD-based representation 15 represents the result of addition when the quantity Φ(xₙ, yₘ) within this representation is calculated as Φ(xₙ, yₘ)=Φ⁺(xₙ, yₘ)=xₙ+yₘ, as described above.

The third N-dimensional SoDD-based representation 15 represents the result of multiplication when the quantity Φ(xₙ, yₘ) within this representation is calculated as Φ(xₙ, yₘ)=Φ^{x}(xₙ,yₘ)=xₙ×yₘ, as described above.

However, the processor unit is not required to reproduce any of the first, second or third SoDD-based representation (11, 13, 15) in order to generate the third tuple 15. This is because, the arithmetic process allows each parameter of the third tuple to be generated using the parameters of the first tuple and the second tuple. Once the parameters of the third tuple are calculated, then this fully encodes the third SoDD-based representation 15, permitting that third distribution to be reproduced as and when required, and permitting the third tuple to be stored (in local memory unit 5, or remote memory 7) and/or transmitted as a signal 9 from the transmitter unit 8, in a very efficient form.

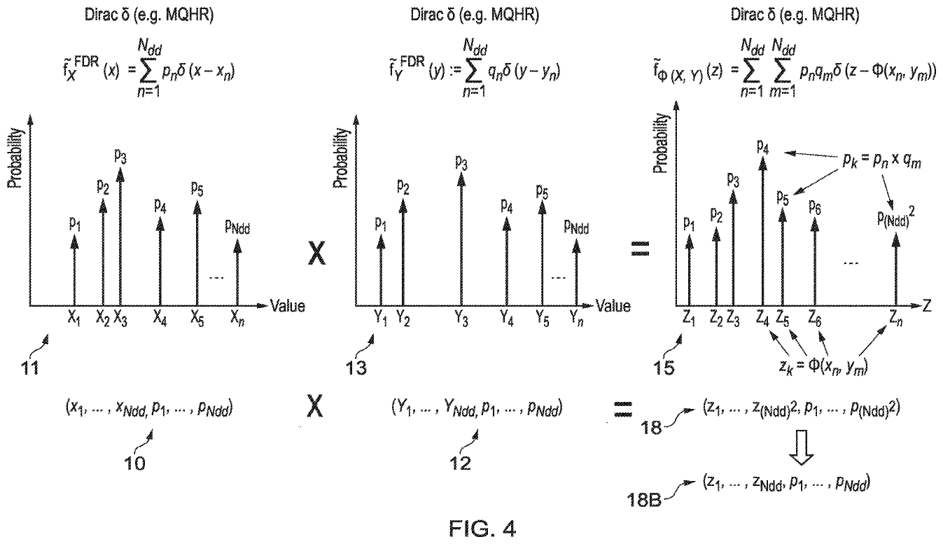

This storage/transmission simply requires the parameters (i.e. the positions, zᵢ, of Dirac-δ functions representing data of the third set, and their heights/probabilities, pᵢ) encoding a probability distribution characterising the distribution of the data items of the third set 15 of data items that are the result of the arithmetic operation. The parameters used to encode the distribution of the data items of the third set are the same as the parameters used to encode the distribution of the data items of the first set and second set, since the third set is encoded using the same SoDD-based representation (i.e. MQHR in this example) as the first set and second set. To achieve the same format of representation (or same parameters) for the propagated variable Z, the third tuple (18 of FIG. 4) is preferably reduced in size to a “compacted” third tuple (18B of FIG. 4) which is an N-tuple. This permits further computation that may involve Z without the representation sizes growing indefinitely. This reduction to a standard size (i.e., N-tuple) also assists in the microarchitectural implementation discussed herein. FIG. 4 schematically shows the process of multiplication applied to two distributions (11, 13) in the MQHR representation, resulting in a third distribution 15 also in the MQHR representation. FIG. 4 also shows the implementation this operation in terms of using the parameters (position, probability) of the N-tuple for the first distribution 11 of the two distributions, and using the parameters (position, probability) of the N-tuple for the second distribution 12 of the two distributions, to generate a third tuple 18 parameters comprising parameters (position, probability) having values defining the distribution resulting from the multiplication. This third tuple is then preferably used to generate a “compacted” third tuple 18B, as described above, which has the same size (an N-tuple) as that of the first and second tuples (10, 12).

In particular, the positions, zₖ, of Dirac-δ functions representing data of the third set 15 are given by the values of Φ(xₙ, yₘ). The heights/probabilities, pₖ, of the Dirac-δ functions representing data of the third set are given by the product, pₖ=pₙ×pₘ, of the heights/probabilities of the Dirac-δ functions representing data of the first (pₙ) and second (pₘ) data sets. This may be summarised, schematically, in the case of a multiplication of the first and second distributions, as:

(x₁, . . . ,x_{N}_{_{dd}},p₁, . . . ,p_{N}_{_{dd}})×(y₁, . . . ,y_{N}_{_{dd}},p₁, . . . ,p_{N}_{_{dd}})=(z₁, . . . ,z_{N}_{_{dd}},p₁, . . . ,p_{N}_{_{dd}})

The invention is not limited to SoDD-based representations (such as MQHR), and the first, second and third tuples may generally contain parameters, according to other representations, encoding the position and/or width of data intervals within the probability distribution characterising the distribution of the data items of the first, second and third sets such as described in any of the examples discussed above. The first, second and third tuples may contain parameters, according to other representations, encoding the probability of data items within the probability distribution characterising the distribution of the data items of the first set. For example, as discussed above, the first, second and third tuples may contain parameters encoding the value of one or more statistical moments of the probability distribution characterising the distribution of the data items of the first set.

The first and second tuples are each an N-tuple in which N>1 is an integer, and the third tuple is an M-tuple for which N²/2<M<2N² in which N>1 is an integer. The compacted third tuple, if generated, is preferably an N-tuple. Efficiencies of data storage and transmission are greatly enhanced by the invention by using the first and second tuples to represent data distributions, but also by using the third tuple to represent the third distribution of data. Much less data are required to represent the data distributions, and this greatly lowers the burden on memory space for storing the data distributions according to the invention. Furthermore, an efficient means of performing arithmetic operations on the data sets is provided which greatly reduces the computational burden on a computer system.

As an example, to better illustrate a use of the invention in this context, the first and second sets of data may typically comprise samples of a respective first and second random measurement variable, representing uncertainty in the measurements. As an example, the first data set may comprise measurements from a voltage sensor, e.g. of a voltage (V) across a circuit component, and the second data set may comprise measurements from a current sensor, e.g. of a current (I) through the circuit component. Consequently, the third set of data, generated by applying the arithmetic operation of multiplication to the distributions of the first and second sets of data, may represent the uncertainty in the electrical power (P=I×V) dissipated by the circuit component. In this way, the monitoring of the power dissipation of the circuit component, and a representation of the uncertainty in measured power, becomes not only possible but also much more efficient in terms of memory requirements of the monitoring computer and in terms of the processing/computing burden on that computer.

### EXAMPLE

### Microarchitecture

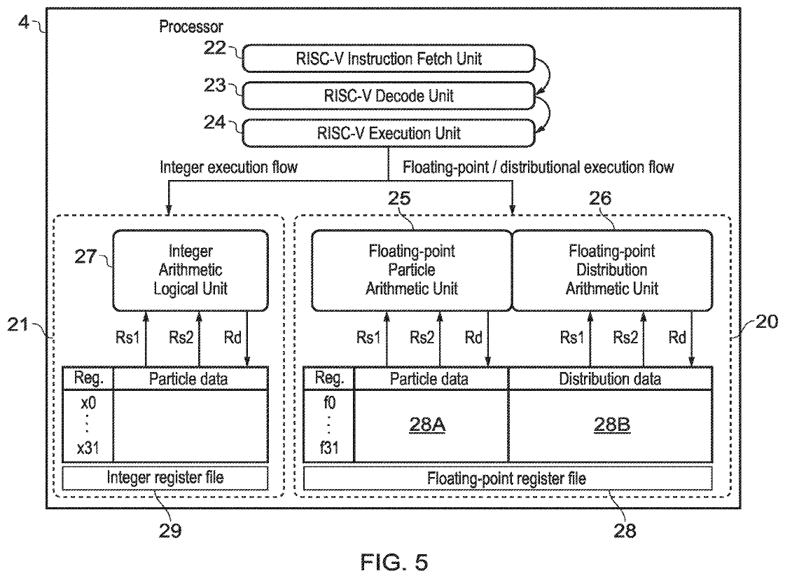

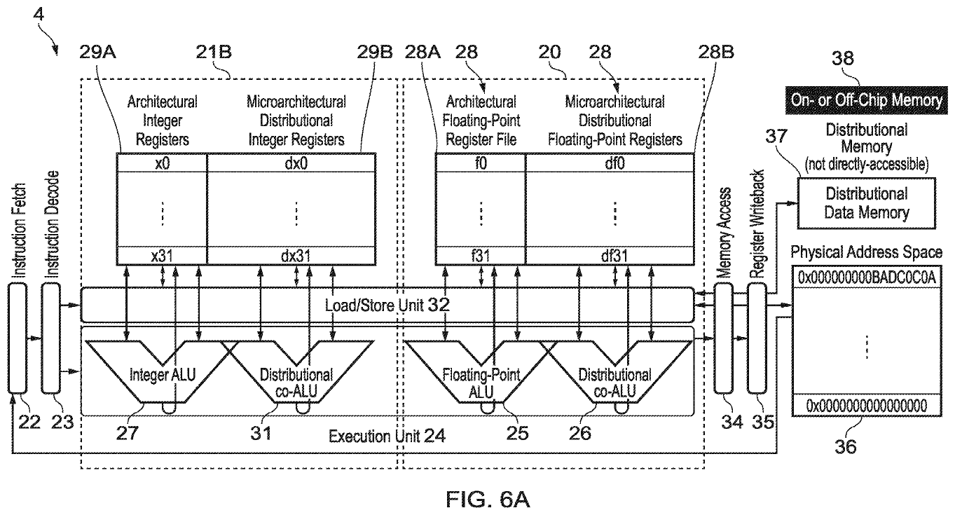

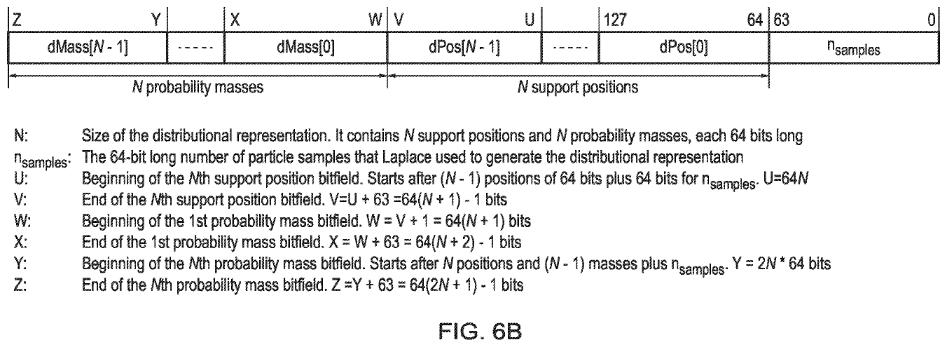

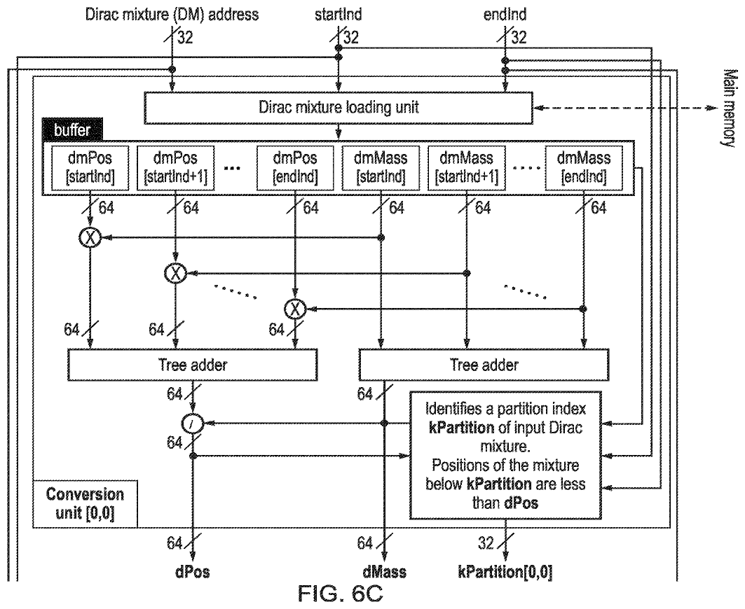

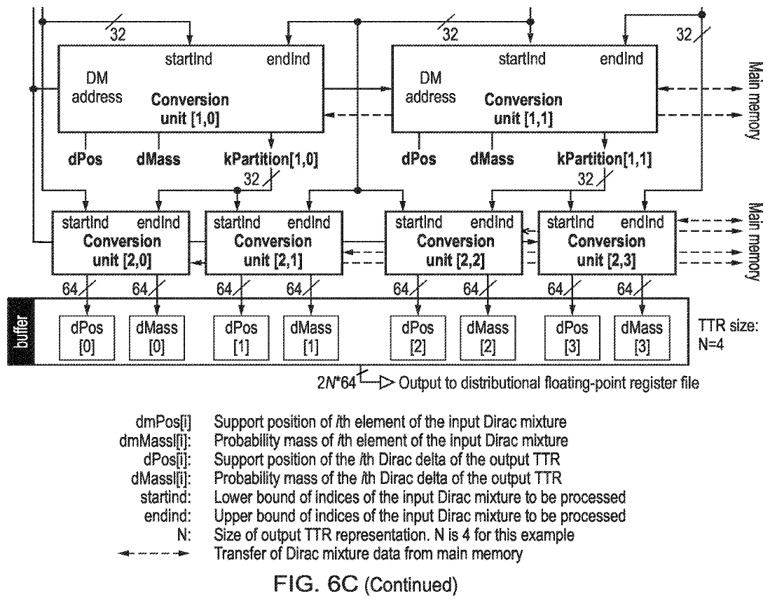

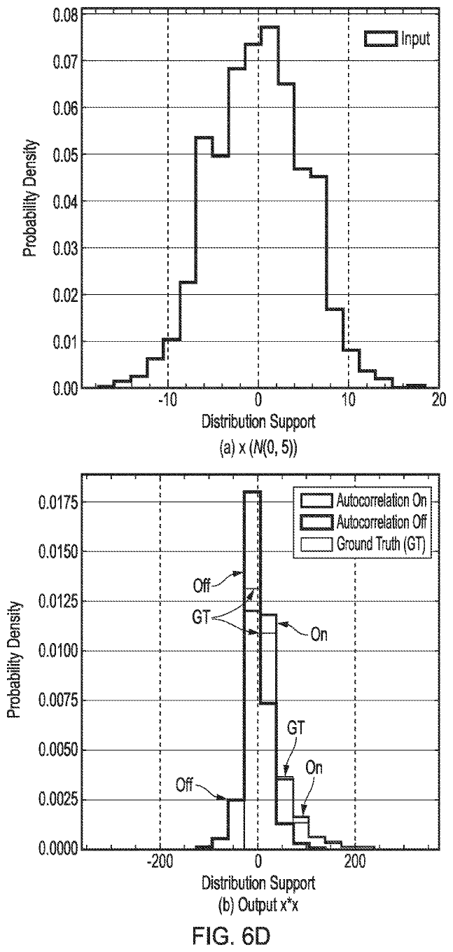

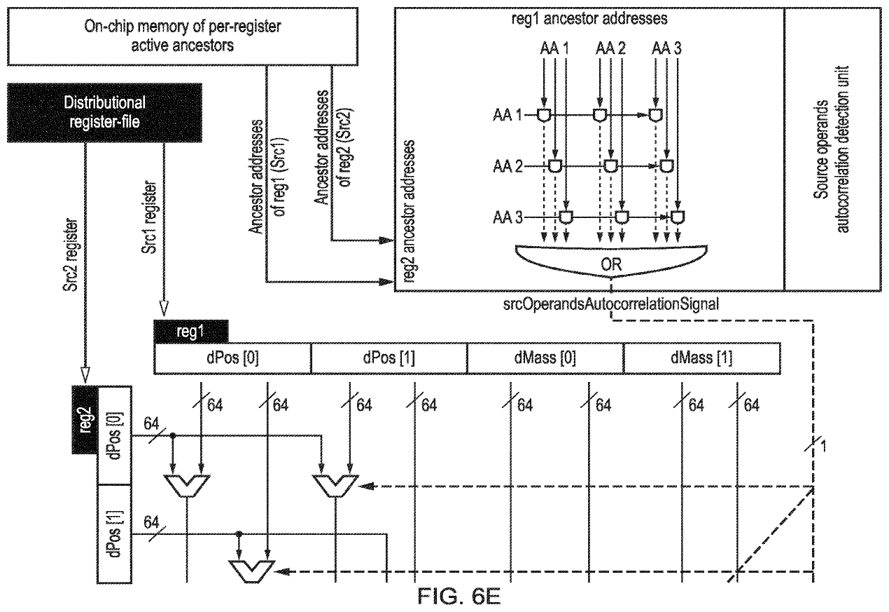

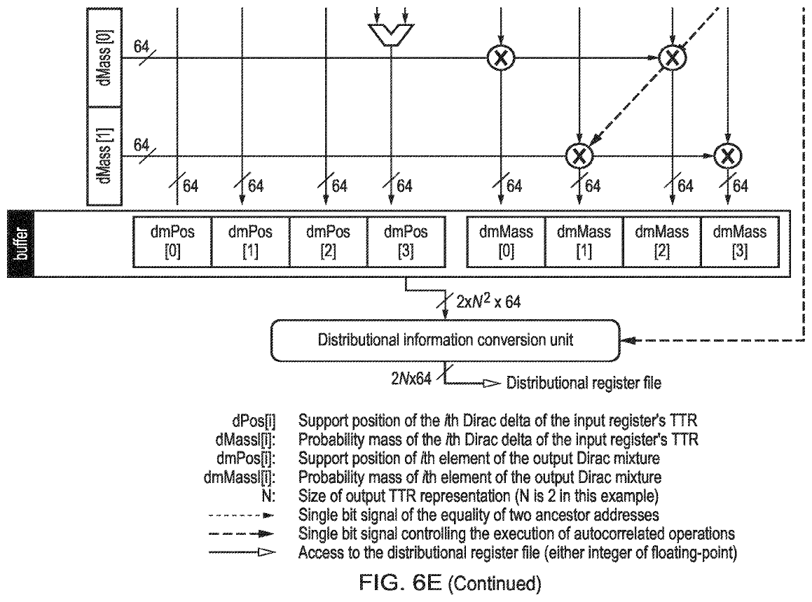

The disclosures above provide efficient binary number representations of uncertainty for data whose values are uncertain. The following describes an example hardware architecture for efficiently performing computation on these representations. For example, the example hardware architecture may be an example of the processor unit 4 described above with reference to FIG. 1. The processor unit 4 may be provided in the form of a microarchitecture described in more detail below, with reference to FIG. 5 and FIGS. 6A, 6B and 6C.

The above binary number representations (tuples) for data effectively implement a trade-off between the number of bits used in representations and the accuracy of a representation of empirical probability distributions: in other words, fewer bits means greater efficiency of uncertainty representation, but at the cost of some acceptable loss of accuracy in that representation. The examples of uncertainty representations presented above allow computing systems in general to efficiently represent uncertain quantities even when those quantities have rarely occurring high-moment outliers.

The uncertainty representations and algorithms for performing arithmetic on them, as presented above, may be implemented in a microarchitecture for computing on data associated with distributions (distributional information/data). An instruction set architecture (ISA) may be used with the microarchitecture which is an extension of the RISC-V 32-bit ISA. The microarchitecture may execute existing RISC-V programs unmodified and whose ISA may be extended to expose new facilities for setting and reading distributional information/data without changing program semantics. The microarchitecture may represent and propagate distributional information/data and provide uncertainty-awareness at the software level.

Uncertain data are ubiquitous in computing systems. One common example is sensor measurements, where the very nature of physical measurements means there is always some degree of uncertainty between the recorded value (the measurement) and the quantity being measured (the measurand). This form of measurement uncertainty is often quantified by performing repeated measurements with the measurand nominally fixed and observing the variation across measurements using statistical analysis or noting the number of significant digits. Such numerically quantified uncertainty is referred to in the literature as aleatoric uncertainty. Uncertainty may also exist when there is insufficient information about a quantity of interest. For example, the training process for neural networks determines values of per-neuron weights, which training updates across training epochs by backpropagation. Because of the large space of possible values for the parameters that control the training process such as the momentum for gradient updates and step size (so-called hyperparameters), weights in a neural network model are initially uncertain but eventually converge on a narrower distribution of weight values as a result of the training process. In the case of a sensing device, the random errors that can occur in the measurement are considered an aleatoric uncertainty. Epistemic uncertainty refers to our imperfect knowledge or ignorance of parameters of the examined phenomenon. The present invention, as implemented by the microarchitecture or otherwise, may encode, represent and propagate distributional information/data (e.g. probability distributions, frequency distributions etc.) representing uncertainty in measurement data made by a measurement apparatus (e.g. sensor) and/or may propagate distributional information/data defining distributional weights of an artificial neural network.

Such uncertainty in values, resulting from incomplete information on the values they should take, is often referred to in the research literature as epistemic uncertainty. Despite the increasing relevance of both of these types of uncertain data in modern computing systems, modern computer architectures neither have support for efficiently representing epistemic uncertainty, nor for representing aleatoric uncertainty, let alone arithmetic and control-flow on such values. Computer architectures today represent both kinds of uncertain values with single point values or “particle” values (i.e., data with no associated distribution), usually by taking the mean value as the representation for use in computation. Hereafter, for conciseness, we refer to single point values (i.e., data with no associated distribution) as “particle” values. The microarchitecture disclosed herein provides a non-intrusive architectural extension to the RISC-V ISA, for computing with both epistemic as well as aleatoric uncertainty.

The microarchitecture may allow programs to associate distributional information with all of the floating-point registers and/or integer registers and by extension all chosen memory words that are used to load and store register values. Arithmetic instructions may propagate the distributional information/data associated with the registers that are the source operands to the destination register and back to memory on a store operation.

Examples of representations are given above (e.g. SoDD-based representations, CMR representations) for efficiently capturing the uncertainty of each memory element inside the microarchitecture by means of discrete probability distributions. In this way, computer representations for variables with distributional information can be seen as analogous to computer representations for real-valued numbers such as fixed-point floating-point representations. In particular, fixed-point representations use a fixed number of bits for whole and fractional parts of a real-valued quantity and represent approximate real values as fixed spacings over their dynamic range while floating-point representations represent real-valued quantities with an exponential expression that permits representing a wider dynamic range but results in non-uniform spacings of values on the real number line. Just as fixed-point and floating-point number representations trade the number of bits in their representations of real-valued quantities for accuracy with respect to the represented real-valued number, the distribution representations/data disclosed herein trade the bits in representations for accuracy of representing empirical probability distributions.

The microarchitecture may both represent and track uncertainty across a computation transparently to the default semantics of the default RISC-V ISA. The microarchitecture may permit a user to make probabilistic and statistical queries on the uncertainty at any point in the computation. Because the examples of representations disclosed herein (e.g. SoDD-based representations, CMR representations) are of finite length, they are an approximation of the probability density function of the original discrete random variable. To recap, let δ(x) be the Dirac distribution centred on x. Given a “particle” value x₀∈ [symbol] , we define the particle value as the distribution δ(x−x₀). Using this definition, we represent an array of M particle values as a sum of weighted Dirac deltas, in the form

$${f}_{X} ( x ) = \frac{1}{M} {\sum }_{n = 1}^{M} {p}_{n} δ ( x - {x}_{n} )$$

where pₙ∈[0,1] with:

$${\sum }_{n = 1}^{M} {p}_{n} = 1$$

In the case of M particle values we set pₙ equal to the probability of appearance of each of the M values, which is 1/M. Thus, the updated Dirac deltas distribution of the M particle values takes the form:

$${f}_{X} ( x ) = \frac{1}{M} {\sum }_{n = 1}^{M} δ ( x - {x}_{n} )$$

This distribution is an accurate representation, which we will refer to as the Dirac mixture representation. The Dirac mixture representation may be used as a reference distributional representation of particle data, in order to define the following three compact distribution representations disclosed in more detail above. We define a distribution function of a random variable X, by the function:

F(x)= [symbol] (X≤x).

For discrete random variables, i.e., variables that take values only in some countable subset of real numbers [symbol] , we define the probability mass function of a discrete random variable X as:

ƒ(x)= [symbol] (X=x).

Here [symbol] (X=x) is the probability that the random variable X has the observed value x. We define the mean value, or expected value, of a random variable X with “probability mass” function ƒ(x) as:

$$𝔼 ( X ) = {\sum }_{x : f ( x ) > 0} xf ( x ) .$$

### Centralized Moments Representation (CMR):

This representation uses the expected value and the first N centralized moments of the Dirac mixture representation of an array of particle data. We exclude the first centralized moment which is always equal to zero. We define the N-th order centralized moment representation (CMR) of a discrete random variable X as the ordered N-tuple defined above. For completeness, we define the k-th moment, mx, (k=positive integer) of the random variable X as the expectation value:

mₖ= [symbol] (X^{k})

We define the k-th centralized moment, σₖ, of random variable X as the expectation value:

σₖ= [symbol] (X−m₁)^{k})

For example, σ₂ is the variance of the random variable. The ordered N-tuple is then:

R_{CMR}^{N}(X):=( [symbol] (X),σ₂(X), . . . ,σ_{N}(X)).

### Regularly-Quantized Histogram Representation (RQHR):

In this representation we may divide the range of the input particle values into N bins of equal range size L. We define the height of each bin 1≤i≥N as pᵢ and set it equal to the relative frequency of the input particle data falling within the interval of i-th bin. This results in a set of regularly positioned histograms, which can be modelled as a Dirac mixture, where each Dirac delta lies in the middle of the interval of each histogram with probability mass equal to pr. Since the range size L is constant, by knowledge of the position x₀ of the first Dirac delta, it is possible to calculate the position of the rest of them. Consequently, we may define the regularly quantized histogram representation (RQHR) of X consisting of N Dirac deltas as the ordered (N+2)-tuple:

R_{RQHR}^{N}(X):=(x₀,L,p₁, . . . ,p_{N}).

Telescoping Torques representation (TTR):

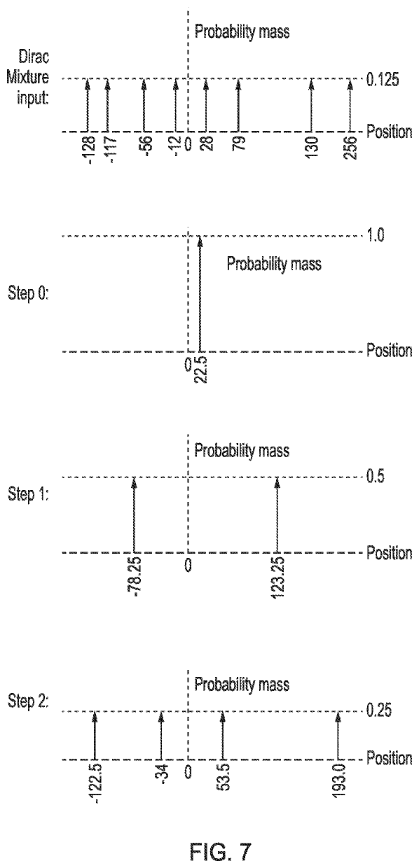

The telescoping torques representation (TTR) recursively constructs a new set of N Dirac deltas from a Dirac mixture with any number of elements in log₂ N steps. At each step the construction divides the given Dirac mixture into two: those that lie below the mean value of the mixture and those that lie above the mean value of the mixture, to obtain twice the number of Dirac mixtures. FIG. 7 shows an example for N=4 and starting from a Dirac mixture of 8 “particles”. The mean value of the initial Dirac mixture is equal to μ₀=22.5. At the step 0 of the TTR construction, we define the 0th-order TTR of the given mixture as a Dirac delta with probability mass equal to the sum of the probability masses of all Dirac deltas in the mixture (which is 1.0) and sitting at the mean value μ₀. At step 1, we consider the two mixtures that lie, respectively, below μ₀ and above μ₀ (each mixture consisting of four Dirac deltas in the case of this example) and repeat the process for each mixture. In this way one defines the 1st-order TTR of the initial mixture as the union of the 0th-order TTRs of each sub-mixture. In the case of the given example, this corresponds to two Dirac deltas sitting at the mean values of the sub-mixtures and both with “probability mass” equal to 0.5. At step 2, the process repeats, further dividing the sub-mixtures of step 1 into two and finding their 0th-order TTRs. This provides a TTR of order n=2 for the initial mixture with N=²ⁿ=4 Dirac deltas. If x₁, . . . , x_{N} are the positions of the Dirac deltas in the nth stage of the construction, where n=log₂ N and if p₁, . . . , p_{N} are their “probability masses”, then the nth-order TTR of X as the ordered 2N-tuple:

R_{TTR}^{N}(X):=(x₁, . . . ,x_{N},p₁, . . . ,p_{N}).

Both TTR and RQHR representations are of fixed size and do not increase in size as computation progresses.

### Arithmetic Operations on Representations

Given two discrete random variables X and Y with probability mass functions represented using any of the representations disclosed herein, the algorithms disclosed herein may be implemented in order to compute the representation of the “probability mass” function of the discrete random variable Z=Φ(X; Y), for Φ(X; Y) as one of addition, multiplication, subtraction and division. The microarchitecture 4 supports these arithmetic operations for all distribution representations disclosed herein. The microarchitecture, and the invention in general, may calculate more complex arithmetic operations e.g., fused multiplication and addition or square root, by expressing them in terms of the aforementioned basic arithmetic operations, as would be readily apparent to the skilled person.

The RQHR and TTR representations (and other SoDD-based representations), for example, are both in the form of a series of Dirac deltas (i.e. “SoDD”), which may be represented as a vector, if desired, of given position and probability mass. Assuming two random variables X and Y, their addition and multiplication results from the circular convolution of Dirac deltas positions and probability mass vectors. For the following parts of this disclosure, we will focus on TTR, but the same principles apply to RQHR (and other SoDD-based representations).

Algorithm 1 shown in Table 2 provides an example of an algorithm implemented by the microarchitecture of the present invention for addition of two input discrete random variables represented using TTR of size N_{TTR}. The results of the operations on the Dirac delta positions and masses of the two input variables are temporarily stored in the variable “destVar”, which is of Dirac mixture representation type of size N_{TTR}×N_{TTR}. After the completion of calculations, the microarchitecture converts the “destVar_{DM}” to “destVar_{TTR}”, using the algorithm illustrated in Table 2.

TABLE 2
Algorithm 1: Addition of uncertainty representations
based on Dirac deltas.

| | |
|---|---|
| 1 | Inputs :srcVar1_{TTR}, srcVar2_{TTR} |
| 2 | Function uncertainAdd_{TTR}(srcVar1_{TTR},srcVar2_{TTR}) |
| 3 | \| destVar_{DM} ← new DMvar(N_{TTR} × N_{TTR}); |
| 4 | \| for i ← 1 to N_{TTR} do |
| 5 | \| \| for j ← 1 to N_{TTR} do |
| 6 | \| \| \| index ← (i−1) * N_{TTR} + j; |
| 7 | \| \| \| destVar_{DM}.position[index] ← |
| | \| \| \| srcVar1_{TTR}.position[i] + srcVar2_{TTR}.position[j]; |
| 8 | \| \| \| destVar_{DM}.pmass[index] ← |
| | \| \| \| srcVar1_{TTR}.pmass [i] * srcVar2_{TTR}.pmass[j]; |
| | \| \| end |
| | \| end |
| 9 | \| destVar_{TTR} ← convertDMTo_{TTR}(destVar_{DM} ); |
| 10 | \| return destVar_{TTR} |

A similar process is required for the multiplication of two variables in TTR, as shown in Table 3.

TABLE 3
Algorithm 2: Multiplication of uncertainty
representations based on Dirac deltas.

| | |
|---|---|
| 1 | Inputs :srcVar1_{TTR}, srcVar2_{TTR} |
| 2 | Function uncertainAdd_{TTR}(srcVar1_{TTR}, srcVar2_{TTR}) |
| 3 | \| destVar_{DM} ← new DMvar(N_{TTR} × N_{TTR}); |
| 4 | \| for i ← 1 to N_{TTR} do |
| 5 | \| \| for j ← 1 to N_{TTR} do |
| 6 | \| \| \| index ← (i−1) * N_{TTR} + j; |
| 7 | \| \| \| destVar_{DM}.position[index] ← |
| | \| \| \| srcVar1_{TTR}.position[i] * srcVar2_{TTR}.position[j]; |
| 8 | \| \| \| destVar_{DM}.pmass[index] ← |
| | \| \| \| srcVar1_{TTR}.pmass[i] * srcVar2_{TTR}.pmass[j]; |
| | \| \| end |
| | \| end |
| 9 | \| destVar_{TTR} ← convert DMToTTR(destVar_{DM} ); |
| 10 | \| return destVar_{TTR} |

The difference between these two algorithms is that the positions of the input Dirac deltas are multiplied in the case of Algorithm 2 instead of being added as in the case of Algorithm 1.

Algorithms 1 and 2, showcase the merits of the Dirac delta representations. The required operations for arithmetic propagation require element-wise operations, which are highly parallel and their calculation can be optimized. Moreover, the result of an arithmetic operation on two variables is also in a Dirac delta mixture form, which can be converted to the intended representations using procedures that apply for particle data and no extra hardware or software logic.

An addition or multiplication of a particle value to a variable in TTR form, results in an offset or scaling of the position of the Dirac deltas of the representation. With that in mind, the subtraction of two uncertain variables in TTR is achieved by negating the TTR of the subtrahend using multiplication with −1. For the case of division of TTR variables, we define it as a multiplication using the reciprocal of the divisor variable. The reciprocal of a TTR variable, can be constructed by calculating the reciprocals of the input Dirac deltas positions.

### Bayes-Laplace Rule

Let Θ be a random variable that takes on instance values θ and which has probability mass function ƒ_{θ}(θ). Let ƒ_{X}(x|θ) be the probability mass function of the distribution of the random variable X, given a parameter Θ, i.e., Pr{X=x|θ}. The parameter Θ is typically a variable in machine state such as a word in memory corresponding to a weight in a neural network model being executed over the microarchitecture. In Bayesian neural networks, there is epistemic uncertainty about such weights and it is the goal of the training procedure to estimate their (posterior) distribution based on a combination of prior knowledge and values seen during training. The Bayes-Laplace rule gives us the expression for the probability mass function of the random variable Θ given one or more “evidence” samples x of the random variable X. Then, given a vector of N samples of the random variable X, i.e., given x={x₁, x₂, . . . x_{N}}, ƒ_{θ}(θ|x) is:

$${f}_{Θ} ( θ \vert x ) = \frac{{f}_{X} ( x \vert θ ) {f}_{Θ} ( θ )}{{\sum }_{θ ∈ 𝒟 ( Θ )} {f}_{X} ( x \vert θ ) {f}_{Θ} ( θ )} .$$

The left-hand side of this equation is often referred to as the “posterior distribution” of the parameter Θ. The probability mass function ƒ_{θ}(θ) is referred to as the “prior distribution” for the parameter Θ and the “likelihood” is computed as:

$${f}_{X} ( x \vert θ ) = {\prod }_{\{ {x}_{1} , {x}_{2} , ... , {x}_{N} \}} {f}_{X} ( x \vert θ ) .$$

The likelihood is often referred to as the sampling distribution. The Bayes-Laplace rule for computing the posterior distribution is an invaluable operation in updating the epistemic uncertainty of program state. In contemporary systems, this update is widely considered to be computationally challenging because of the need to perform the integral or equivalent summation in the denominator of the above equation for ƒ_{θ}(θ|x). The present invention permits computation of the posterior distribution using the representations of uncertainty (e.g. SoDD representations) of the prior distribution, the sampling distribution and the set of “evidence” samples.

Examples of a microarchitecture for the processor unit 4 for computation on distributions of data, are shown in FIG. 5 and FIGS. 6A, 6B and 6C. In each example, the microarchitecture comprises microarchitecture unit 20 comprising a floating-point register file 28 configured to contain floating-point data. The floating-point register file contains a first register file 28A configured for containing particle data items, and a second register file 28B configured for containing distribution data. The distributional data represents distributions (e.g. SoDD-based representations) that are uncertainty representations associated with respective particle data items in the first register file 28A. The floating-point register file 28 associates a given particle data item in the first register file 28A with its associated distributional data within the second register file 28B by assigning one common register file entry identifier (fi) to both a given particle data value within the first register file 28A and the distributional data entry in the second register file 28B that is to be associated with the particle data in question. For example, the first register entry in both the first register file 28A and the second register file 28B are identified by the same one register entry identifier “f0”. Similarly, the last register entry in both the first register file 28A and the second register file 28B are identified by the same one register entry identifier “f31”. Of course, the same applies to intermediate register entry identifiers, such that the l^{th} register entry in both the first register file 28A and the second register file 28B are identified by the same one register entry identifier “fi”.

A first arithmetic logic unit 25 is configured for executing arithmetic on particle data items selected from the first register file 28A, and a second arithmetic logic unit 26 is configured for executing arithmetic on distribution data selected from the second register file 28B. The microarchitecture 20 of the processor 4 is configured to implement the following steps. The first arithmetic logic unit 28A executes an arithmetic operation (e.g. addition, subtraction, multiplication or division) on two floating-point particle data items selected from the first register file 28A, and outputs the result. Simultaneously, the second arithmetic logic unit 28B executes the same arithmetic operation on two items of distribution data representing distributions selected from the second register file 28B that are associated with the data items that were selected from the first register file 28A, and outputs the result. Notably, the arithmetic operation executed on the distribution data selected from the second register file 28B is the same as the arithmetic operation executed on the data items selected from the first register file 28A. As a result, the output of the second arithmetic logic unit 26 is further distributional data representing uncertainty associated with result of the arithmetic operation (e.g. addition, subtraction, multiplication or division) executed on the data items selected from the first register file 28A.

As an example, consider a case in which the first arithmetic logic unit 25 selects particle data items from within the first register file 28A at register file locations/entries: f1 and f2, for adding together, and outputting the result to register file location/entry f0 within the first register file 28A (e.g. for subsequent output from the processor, or for use in further arithmetic operations). The selecting of particle data items from within the first register file 28A at register file locations/entries: f1 and f2, triggers concurrent selection by the second arithmetic logic unit 26 of distributional data items from within the second register file 28B at register file locations/entries: f1 and f2, for adding together, and outputting the result to register file location/entry f0 within the second register file 28A (e.g. for subsequent output from the processor, or for use in further arithmetic operations). This can be summarised as follows, using the naming convention for the floating-point registers of RISC-V architecture, let f0 be a floating-point register of the microarchitecture:
Arithmetic operation: f0:particle=f1:particle+f2:particle
Arithmetic operation: f0:distribution=f1:distribution+f2:distribution

The outputting of the results of this arithmetic operation, by the microarchitecture unit 20 may comprise one or more of: storing the output in a memory; transmitting a signal conveying the output (e.g. electronically to another circuit component, or to a memory, or wirelessly to a remote receiver). The first register file 28A and the second register file 28B are configured to contain at least a first particle data item and associated distributional data (e.g. at f1) and a second particle data item and associated distributional data (e.g. at f2), but may contain many more data items (e.g. up to 32 in this example: f0 to f31).

The second register contains the distribution data (e.g. f1:distribution, f2:distribution) associated with a given particle data item in the form of a tuple, e.g. of any type disclosed herein, containing parameters encoding a probability distribution characterising the uncertainty representation associated with the particle data item in question. The parameters used to encode the distribution data of all of the distributional data items of the second register file 28B are the same as each other, at least during a given arithmetic operation. Consequently the result of the arithmetic operation applied to the two selected tuples of distributional data, is a third tuple (f0:distribution) defined using parameters contained within the first tuple, f1:distribution, and using parameters contained within the second tuple, f1:distribution. The third tuple, f0:distribution, contains parameters encoding new further distribution data which is stored at location f0 in the second register file 28A.

The processor 4 also comprises a microarchitecture unit (21, FIG. 5; 21B, FIG. 6) comprising an integer arithmetic logic unit 27 arranged to implement arithmetic operations on integer particle values contained within an integer register file (29, FIG. 5; 29A & 29B, FIG. 6). In the example of FIG. 5, only integer particle values are contained in the integer register file 29, and the integer arithmetic logic unit 27 is arranged to implement arithmetic operations only on integer particle values contained within an integer register file 29. However, in the example of FIG. 6A, in the microarchitecture 21B integer particle values are contained in a first register file 29A and associated distributional values are contained in a second distributional register file 29B. Furthermore, the microarchitecture 21B comprises an execution unit 24 including not only a first arithmetic logic unit 27 (for integer operations) shown in the example of FIG. 5, but also containing a second arithmetic logic unit 31 configured to perform arithmetic operations on distributional information associated with integer particle data. In this way, the microarchitecture 21B is arranged to implement arithmetic operations only on integer particle values and their associated distributional data contained within the second register file 29B. The operation and functioning of the first and second arithmetic logic units (27, 31) interact with the first and second register files (29A, 29B) such that arithmetic operations performed on integer particle values are also concurrently performed on associated distributional values in the same manner as described above with reference to the floating-point registers and arithmetic units. In summary, the above relation:
Arithmetic operation: f0:particle=f1:particle+f2:particle
Arithmetic operation: f0:distribution=f1:distribution+f2:distribution
   applies equally to integer data arithmetic operations.

In this way, the floating-point and/or integer register files (28A, 28B, 29A, 29B) in the microarchitecture may associate all floating-point and/or integer registers with distributional information. When an instruction reads from a floating-point and/or integer register which has no distributional information, the behaviour is unchanged from a conventional architecture. The semantics in the presence of distributional information is to return the mean. The number of floating-point registers and their conventional particle part remains unchanged.

In summary, FIG. 5 shows a microarchitecture example which does not associate integer registers with uncertainty and thus the integer register file is of conventional design, whereas FIG. 6 shows a microarchitecture example which does associate integer registers with uncertainty and thus the integer register file is according to the invention. Both figures illustrate an example of a processor 4 according to an embodiment of the invention (e.g. the processor unit of FIG. 1). The processor unit, in these examples, is configured to implement an RISC-V ISA. Accordingly, the processor unit comprises a RISC-V Instruction Fetch Unit 22 arranged in communication with an RISC-V Decode Unit 23 of the processor unit. The RISC-V Instruction Fetch Unit 22 is configured to fetch instructions from the computer 3 (FIG. 1) and holds each instruction as it is executed by the processor unit 4. The Fetch Unit issues instructions to the Decode unit 23 which, in turn, is responsive to a received Fetch instruction so as to decode the received instruction and issue a consequent instruction to a RISC-V Execution Unit 24 of the processor unit, to execute the decoded instruction. Upon receipt of an instruction, the RISC-V Execution Unit 24 issues instructions to the arithmetic logic units (ALU) of the processor unit, to execute an arithmetic operation on floating-point particle data 28A and their associated distributional information/data 28B, according to the invention, and optionally also to execute an arithmetic operation on integer particle data 29A.

In this way, the processor preferably comprises extended register files (28A, 28B; 29A, 29B) according to the invention, comprising a first register file (28A, 29A) that can store floating-point data, or integer data, and a second register file (28B, 29B) that can store distributional information/data. This extended floating-point register file associates all floating-point (or integer) registers within the first register file (28A, 29A), with distributional information within the second register file (28B, 29B). The execution unit 24 follows the algorithms disclosed herein to cause an extended functional unit (20, 21B) containing a floating-point (or integer) distribution arithmetic unit (26, 31) to execute arithmetic operations on distributional data (second register file 28B, 29B) associated with floating-point (or integer) particle data (first register file 28A, 29A) within a floating-point (or integer) register files 28A or 29A.

### Details of the Microarchitecture Illustrated in FIGS. 6A, 6B and 6C

FIG. 6B shows the bit-level representation of an RQHR or TTR of size N. Nomenclature and symbology in FIG. 6B is as follows:

| | |
|---|---|
| N: | Size of the distributional representation. It contains N support |
| | positions and N probability masses, each 64 bits long |
| nₛₐₘₚₗₑₛ: | The 64-bit long number of particle samples that Laplace used |
| | to generate the distributional representation |
| U: | Beginning of the Nth support position bitfield. Starts after |
| | (N − 1) positions of 64 bits plus 64 bits for nₛₐₘₚₗₑₛ. U = 64N |
| V: | End of the Nth support position bitfield. |
| | V = U + 63 = 64(N + 1) − 1 bits |
| W: | Beginning of the 1st probability mass bitfield. |
| | W = V + 1 = 64(N + 1) bits |
| X: | End of the 1st probability mass bitfield. |
| | X = W + 63 = 64(N + 2) − 1 bits |
| Y: | Beginning of the Nth probability mass bitfield. Starts after N |
| | positions and (N − 1) masses plus nₛₐₘₚₗₑₛ. Y = 2N * 64 bits |
| Z: | End of the Nth probability mass bitfield. |
| | Z = Y + 63 = 64(2N + 1) − 1 bits |

The lower-order 64 bits store the number of particle samples used to derive the distributional representation. The next N 64-bit values store the support positions of the representation. They are followed by the N 64-bit values of the probability masses. Let f0 be a conventional floating-point register of the microarchitecture (e.g., RISC-V RV32IMFD) and let df0 be the respective microarchitecture-level distributional floating-point register. The microarchitecture according to preferred embodiments performs all arithmetic and logic instructions on both the conventional and distributional registers in parallel. For example, the addition of source registers f1 and f2 into destination register f0 also triggers the addition of the distributional information of registers df1 and df2 into the distributional register df0. The semantics of non-distributional register values and operations on them remain unchanged. Tracking of distributional information happens in parallel to (and not affecting the behaviour of) the non-distributional architectural state. The microarchitecture according to preferred embodiments extends both integer and floating-point arithmetic and logic units (ALUs) with two distributional co-ALUs. The conventional, unchanged ALU operates on the particle values of the source registers. The distributional co-ALU performs the same operation on the distributional representations of the source registers using the algorithms of Table 2 and Table 3 noted above. The distributional co-ALU may be configured to calculate statistics of the distributional representation of a source register. Examples include the statistical measures described herein (e.g., above), such as, though not limited to the following.

### The N^{th} Centralized Moment:

For any integer N≥0, the N^{th} moment of random variable X is given by τ_{N}=E(X−E(X))^{N}) where:

E(X)=Σᵢ₌₀^{K}dₚₒₛ[i]dₘₐₛₛ[i]

Here, dₚₒₛ[i] and dₘₐₛₛ[i] are the Dirac Delta position and probability mass for particle i.

### The N^{th} Mode/Anti-Mode:

The N^{th} mode of X is the particle value x at which the probability mass function ƒ_{X} takes its N^{th} highest value and is calculated as dₚₒₛ[ᵢN] where in is the index at which dₘₐₛₛ takes the N^{th} highest value. The N^{th} anti-mode is calculated similarly but with in being the index at which dₘₐₛₛ takes the N^{th} lowest value. If N is greater than the size of the distributional representation the statistic evaluates to a NaN (“not a number”).

### Distribution's Support Minimum or Maximum Value:

This calculation returns the minimum or maximum value of the Dirac delta positions of the distributional representation of X (i.e., minimum or maximum of dₚₒₛ).

### Tail Probability:

Given a cut-off value x₀∈ [symbol] , the calculation of the tail probability of X is

Pr(X>x₀)=Σ_{∀i∈[0,K]s.t.d}_{ₚₒₛ}_{[i]>x}_{₀}dₘₐₛₛ[i]

The tail probability Pr (X≤x0) is calculated as: Pr (X≥x0)=1.0 −Pr (X>x0).

### Loading/Storing Uncertainty Information

A load instruction in the microarchitecture loads the distributional representation that corresponds to an address of the microarchitecture's main memory to the distributional part of the destination register. A store instruction stores the distributional information of the source register to the main memory of the microarchitecture. FIG. 6A shows how a portion of the physical memory of the processor implementing the microarchitecture stores the distributional representations. The load/store unit of the microarchitecture maps an address accessed by an application to the address that stores its distributional representation.

An additional load instruction is discussed in more detail below that initializes the distributional information of a destination register by creating a distribution representation from an in-memory array of source particle samples.

FIG. 6C shows an implementation of the hardware module that converts source samples (e.g., sensor measurements) to the TTR representation. Nomenclature and symbology in FIG. 6C is as follows:

| | |
|---|---|
| dmPos[i]: | Support position of ith element of the input Dirac mixture |
| dmMass[i]: | Probability mass of ith element of the input Dirac mixture |
| dPos[i]: | Support position of the ith Dirac delta of the output TTR |
| dMass[i] | Probability mass of the ith Dirac delta of the output TTR |
| startInd: | Lower bound of indices of the input Dirac mixture to be |
| | processed |
| endInd: | Upper bound of indices of the input Dirac mixture to be |
| | processed |
| N: | Size of output TTR representation. N is 4 for this example |
| [symbol] | Transfer of Dirac mixture data from main memory |

The module comprises multiple levels of conversion units (i.e., “Conversion unit [0,0]”; “Conversion unit [1,0]”; “Conversion unit [1,1]”; “Conversion unit [2,0]”; “Conversion unit [2,1]”; “Conversion unit [2,2]”; “Conversion unit [2,3]”), one level for each step involved in the conversion of an array of samples in the form of a SoDD (also referred to as a “Dirac mixture” herein) to a TTR representation (discussed above). A pair of integers identifies each conversion unit. The first integer corresponds to the conversion step and the second is an increasing index, e.g., “Conversion unit [1,1]” in FIG. 6C is the second conversion unit of conversion Step 1 (Section 2.2). Because FIG. 6C shows an example for the conversion of input samples to TTR of size four, the output level consists of four conversion units which generate the four support positions (“dmPos”) and probability masses (“dmMass”) of the TTR of size four. Each conversion unit has three inputs and three outputs. The first input is the memory address of the array of samples that the conversion unit will process. The microarchitecture stores the samples in the main memory as a SoDD Dirac mixture, sorted by ascending support position (“dmPos” value). The second and third inputs are two integers that correspond to the starting index (“startInd”) and ending index (“endInd”) of the continuous array of samples that the conversion unit will process. Each conversion unit outputs a support position (“dPos”) value and a probability mass (“dMass”) value. The conversion unit calculates the output probability mass as:

dMass=Σ_{startInd}^{endInd}dmMass[i]

The conversion unit calculates the mean value of the source SoDD Dirac mixture as:

μ=Σ_{startInd}^{endInd}dmPos[i]*dmMass[i]

The conversion unit calculates the output support position as:

$$dPos = \frac{μ}{dMass}$$

The third output of the conversion unit is an integer “kPartition” which corresponds to the index below which all sorted support positions of the input SoDD Dirac mixture are less than the calculated “dPos”. In intermediate conversion levels, the conversion units propagate their output “kPartition” to the next conversion level. Depending on the subset of arrays that they must process, the “kPartition” acts as The “startInd” or “endInd” value of the conversion units of the next level. In the final conversion level, the TTR conversion module writes the output distributional information to the distributional destination register and writes the mean value of the source samples to the conventional destination register.

Given an arithmetic instruction with “Rd” target register, then the extended functional unit (20, 21B) computes both its particle value (according to original RISC-V ISA) and its distribution according to the distributions associated with the source registers. Every arithmetic operation applied on the extended register files (28A, 28B; 29A, 29B), is applied equally on both on the particle (28A, 29A) and distributional (28B, 29B) information of the source registers. This affects the value of both the particle and distributional information of the destination register. For example, consider adding registers f1 and f2 and storing the resulting addition value in register f0:
Arithmetic operation: f0:particle=f1:particle+f2:particle
Arithmetic operation: f0:distribution=f1:distribution+f2:distribution

The results of arithmetic operations may be output to a random access memory 5 of the processor unit 4 (FIG. 6A). These output results comprise both particle data values (f0:particle) and distributional data (f0:distribution). Each particle data value (f0:particle) is stored in a memory unit 36, providing a physical address space, and is associated with a distribution representation (f0:distribution) stored in a distributional memory unit 37. A memory access unit 34 and a register writeback unit 35 provide an interface between the extended register files (28A, 28B; 29A, 29B) and the arithmetic logic units of the processor 4. The Instruction Fetch unit 22 is in communication with the particle memory unit 36 for accessing the memory unit 36 for fetching instructions therefrom. Notably, in this example, the Load/Store unit 32 is in direct communication with the distributional memory unit 37, but the Instruction Fetch unit 22 is not so connected. This means that the execution of arithmetic operations on distributional data may take place automatically without requiring, or interfering with, the operation of the Instruction Fetch unit 22. In this way, the calculation of distributional data, resulting from arithmetic operations on particle data and their associated distributional data, may take place ‘under the hood’ at the microarchitectural level. Accordingly, the microarchitecture may be configured to allow only load/store instructions to access the random access memory 5. In this sense, the memory unit 5 provides an extended memory, to which the microarchitecture can load and store both the particle and distributional information of the microarchitecture registers (28A, 28B; 29A, 29B).

### Tracking of Correlations Between Registers

For the improved propagation of the distributional information of the registers of the microarchitecture, it is useful to be able to track correlations between the registers. These correlations change dynamically as microarchitecture propagates the distributional information of the registers through arithmetic operations. In order to track and identify the correlation between registers, processor 4 is configured to track which memory addresses of memory unit 36 have contributed to the calculation of the value of any given floating-point or integer register at any point in time. When a particle value (f0) resulting from an arithmetic operation, is output from a register of the microarchitecture, the processor unit stores the output data of a particle value (f0) resulting from an arithmetic operation in memory when it executes a store instruction. The processor unit 4 also stores the information about the original addresses, or originating addresses, within the main memory unit 5, of the particle data items that contributed to the output result (referred to herein as “origin addresses” or “ancestor addresses”; these two terms refer to the same thing). The processor may subsequently recall the origin addresses when the contents of the register (e.g. the stored particle value (f0) are loaded from main memory for further use. We refer to this correlation tracking as the “origin addresses tracking” mechanism.

The memory unit 5 of the processor is configured to store data items at addressed memory locations therein. The microarchitecture 4 is configured to obtain the originating memory location addresses (i.e. “origin addresses”) of data items that contribute to the arithmetic operation (e.g. Arithmetic operation: f0:particle=f1:particle+f2:particle) executed by either of the floating-point or integer arithmetic logic units (floating-point ALU, 25; Integer ALU, 27) as the floating-point or integer arithmetic logic unit in question executes an arithmetic operation. The microarchitecture is configured to store the obtained originating memory location addresses at a storage location within the memory unit 5 and to associate that storage location with the further distribution data (e.g. f0:distribution) that is generated by the second arithmetic logic units (distributional ALU, 25; Integer ALU, 27).

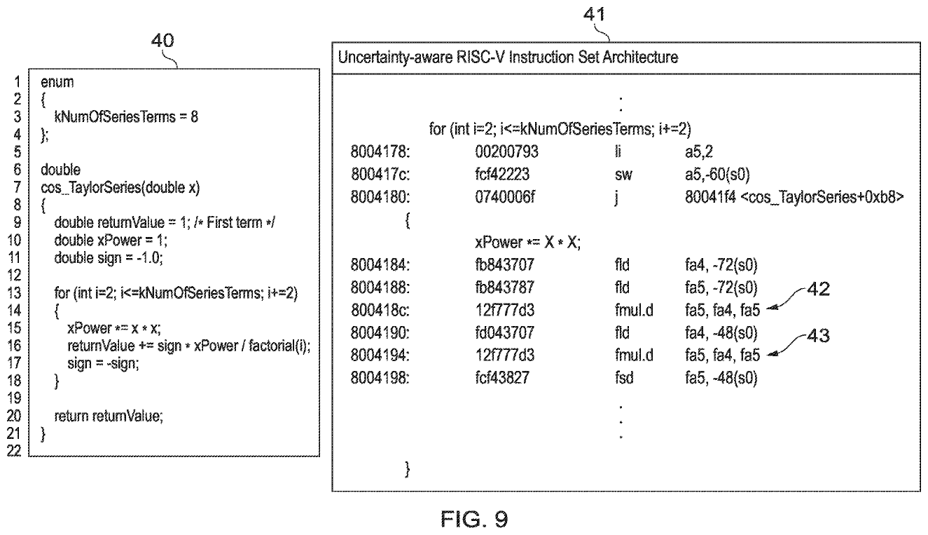

As an illustrative example, FIG. 9 presents an example C-code 40 for calculating the Taylor series expansion of the cosine function. Line 12 of the code shows that an important part of the series expansion is the calculation of the square of C variable x. Assuming that x is a variable with distributional information, the goal of the origin addresses tracking mechanism is to detect at the micro-architectural level that variable x is multiplied with itself.

### Challenges to Tracking Correlations: Ancestor/Origin Addresses Tracking Mechanism

FIG. 9 also shows the RV32IFMD ISA instructions 41 that correspond to lines 10-12 of the C-code snippet in FIG. 9. One may observe that even in the case of the operation “x*x” the compiler requires to use two different registers (fa4 and fa5) to calculate the product “x*x” (see 42 and 43). Consequently, tracking only the IDs of the source registers involved in an instruction is not sufficient to track correlations of variables with distributional information. Despite the assignment of two different registers, the compiler in the example of FIG. 9 instructs the loading of their values from the same address. This is a core insight behind the present correlation tracking mechanism.

In the present invention, in preferred embodiments, the value of each floating-point/integer register originates from one or more address of the memory unit 5 of the processor. By maintaining and propagating these addresses the invention is able to dynamically identify correlations between any two floating-point/integer registers of the processor 4. This information may be maintained, for example, using a dynamically linked list, which we will refer to as the “List of origin addresses” herein. An origin address can only uniquely appear in this list.

As noted above, FIG. 9 shows the C source code and RV32IFMD ISA disassembly of the calculation of the even powers of a variable x, e.g., extracted from a function that uses a Taylor series expansion to calculate the cosine of x. The compiler uses two different registers (fa4 and fa5) to calculate x*x. Tracking only the identities of the source registers of instructions is not sufficient to track correlations between registers and by extension, variables with distributional information. The processor loads the values of both registers from the same memory address, which corresponds to the same variable of the source application. This is the core insight behind our autocorrelation tracking mechanism.

The value of each floating-point register originates from one or more addresses of the main memory. By keeping track of these ancestor addresses we can dynamically identify correlations between any two registers of the microarchitecture. Each time the microarchitecture executes a load instruction, it adds the source address to the set of ancestor addresses of the destination register rd. An on-chip memory of the microarchitecture is configured to store a fixed number (AAMax) of ancestor addresses for each of the architectural registers. The microarchitecture evicts addresses from this memory using a least-recently used (LRU) policy. When the microarchitecture stores a registers to memory, its set of ancestor addresses is spilled to main memory. For each arithmetic operation, if the source registers have at least one common ancestor, the microarchitecture executes the arithmetic operation in an autocorrelation-tracked manner. The microarchitecture also updates the ancestor addresses of the destination register with the union of the ancestor addresses of the source registers.

### Correlation Between Register Values

Let x be a variable with distributional information. Disclosures above have introduced arithmetic operations on uncorrelated random variables. The correct calculation of expressions such as x*x is a subset of the broader problem of handling correlated (i.e., non-independent) distributions. The correct execution of such autocorrelated arithmetic operations requires point-wise operations on the support of the source operands. FIG. 6D shows the calculation of x*x with and without the correct handling of autocorrelation. FIG. 6D (a) shows the distribution of x created in the microarchitecture using samples from a zero-mean Gaussian distribution. FIG. 6D (b) shows the combined outcome of uncertainty tracking with autocorrelation tracking on or off, and the ground truth of exhaustively evaluating x*x for all samples of x. The evaluation of x*x when autocorrelation tracking is on is almost identical to the ground truth. Without such handling of arithmetic on autocorrelated random variables there are negative values in the support of the outcome distribution which is incorrect for the expression x*x.

Distributional co-ALU: Example

FIG. 6E shows the internals of the distributional co-ALU. Nomenclature and symbology in FIG. 6E is as follows:

| | |
|---|---|
| dPos[i]: | Support position of the ith Dirac delta of the input register's |
| | TTR |
| dMass[i]: | Probability mass of the ith Dirac delta of the input register's |
| | TTR |
| dmPos[i]: | Support position of ith element of the output Dirac mixture |
| dmMass[i]: | Probability mass of ith element of the output Dirac mixture |
| N: | Size of output TTR representation (N is 2 in this example) |
| [symbol] | Single bit signal of the equality of two ancestor addresses |
| [symbol] | Single bit signal controlling the execution of autocorrelated |
| | operations |
| [symbol] | Access to the distributional register file (either integer of |
| | floating-point) |

Using the information stored in the on-chip memory of active per-register ancestors (FIG. 6A) the co-ALU determines whether the source registers have common ancestor addresses in the autocorrelation detection unit. The unit sets the output “signalsrcOperandsAutocorrelationSignal” if it detects autocorrelation. If not set, then the co-ALU executes Algorithm 1 or Algorithm 2 (or a variant according to the instruction) shown in Tables 2 and Table 3 respectively. The smaller ALU components perform the intended arithmetic operation on the support positions of the distributional source registers. For all arithmetic operations, the co-ALU multiplies the masses of the distributional source registers. An “assertedsrcOperandsAutocorrelationSignal” signal disables non-pointwise units and the co-ALU performs a point-to-point operation on the source positions and masses. The buffered output of both autocorrelation-tracked and uncorrelated-operand calculations is a SoDD Dirac mixture. A conversion unit like that of FIG. 6C, converts the SoDD Dirac mixture to TTR and forwards it to the distributional register file. For the correct tracking of uncertainty in applications, The microarchitecture preferably propagates distributional information through all floating point operations. However, not all operations have the same distributional execution overhead. If one or both of the distributional source registers do not contain distributional data (i.e., are particle values) then the co-ALU performs a scaling of the support position or no operation, respectively. The quantities “src1” and “src2” may correspond to the quantities “srcVar1” and “srcVar2” noted in Algorithm 1 and Algorithm 2 shown in Tables 2 and Table 3 above, for example.

### Example of Tracking Correlations

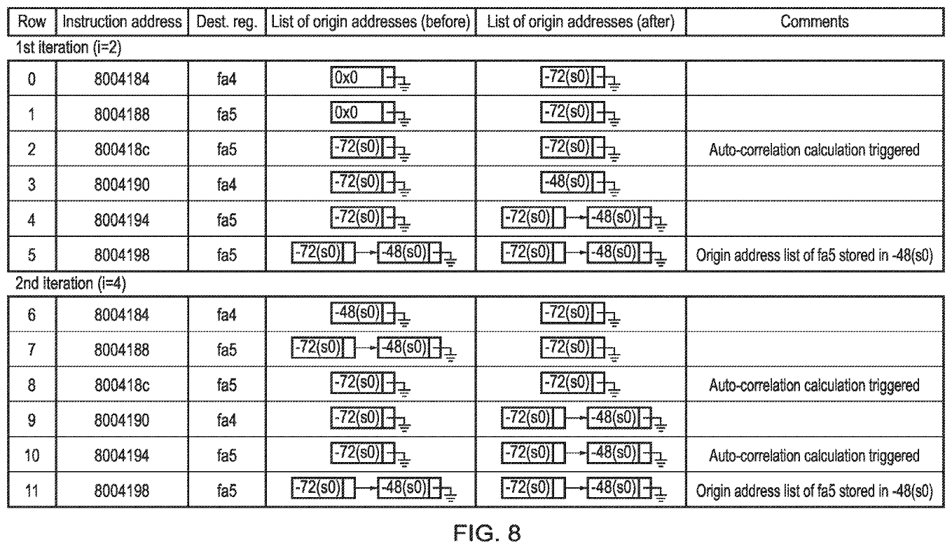

FIG. 8 is an example of the tracking of origin addresses and autocorrelation detection for the RV32IMFD assembly code snippet of FIG. 9. The example focuses on the execution of:

xPower*=x*x(line 12 in FIG. 3)

Each row of the table shown in FIG. 8 corresponds to the execution of an assembly instruction of the C-code snippet of FIG. 9. In each row, we focus on the destination register of each instruction and show its “List of origin addresses” before and after the execution of the instruction. In rows 0 and 1 of the table shown in FIG. 8, we observe that the “List of origin addresses” of registers fa4 and fa5 are created to include “−72(s0)”, where “s0” is a saved integer register which holds an address relative to the stack pointer. Since fa4 and fa5 have identical origin addresses, the processor performs an autocorrelated multiplication in row 2 of the table shown in FIG. 8, which corresponds to the operation “x*x”.

In row 3 of the table shown in FIG. 8, a new address is loaded in fa4, and thus its origin address is overwritten. In row 4 of the table shown in FIG. 8, which corresponds to the second multiplication of the assembly C-code snippet of FIG. 9, the origin addresses list of destination register fa5 is set as the combination of the source registers fa4 and fa5, i.e., including both addresses “−72(s0)” and “−48(s)”. In row 5 of the table shown in FIG. 8, this origin address is stored in address location “−48(s0)” in order to be loaded at the next iteration of the for-loop of line 10 of the C-code of FIG. 9. In this second iteration, the first instructions rows 6-8 of the table shown in FIG. 8 have the same effect as in the first iteration. In the load instruction of row 9 of the table shown in FIG. 8, the origin address of fa4 is updated according to the list stored in “−48(s0)”. In this way, in the multiplication of row 10 of the table shown in FIG. 8, registers fa4 and fa5 share a common origin (“−72(s0)”) in their origin address lists and this allows the processor to identify that it needs to perform an auto-correlated multiplication. This multiplication corresponds to the operation “xPower*(x*x)”. In the case of arithmetic operations with auto-correlation there is no need to store information about the distribution of the correlation of the source operands.

### Example Applications

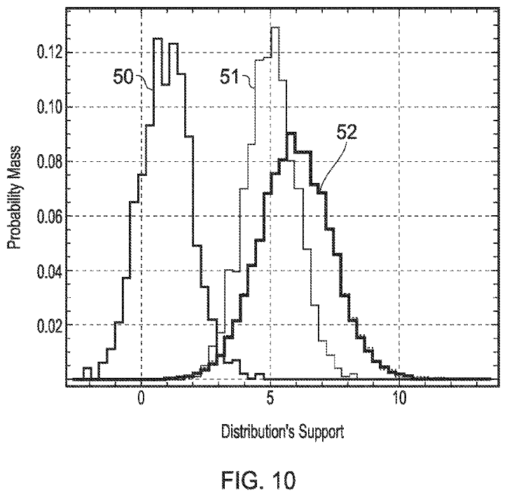

FIG. 10 shows the result of applying the arithmetic operation:

### Arithmetic “Particle” Operation:

particle(6.0)=particle(5.0)+particle(1.0)

### Arithmetic “Distribution” Operation:

distribution(N(6.0,σ₂²))=distribution(N(5.0, σ₁²))+distribution(N(1.0, σ₁²))

In which the particle values being added are 1.0 and 5.0. Each of these particles is associated with distributional information representing uncertainty in the value of the particle. For both particles, the distributional information is a Gaussian distribution (50, 51) with variance σ₁² and with mean values of 1.0 for one particle and 5.0 for the other particle. The result is a third particle (the product) of value 6.0 and distributional information representing uncertainty in the third particle value as a Gaussian distribution 52 with variance σ₂² and with a mean value of 6.0. In general, the value of the variance σ₂² of the resulting distribution 52 will differ from the values of the variances σ₁² of the distributions (50, 51) contributing to the sum, as can be seen by visual inspection of FIG. 10.

In the following we present examples of the ability of the present invention, in any aspect, to correctly represent distributions from particle samples and propagate the distributional information through arithmetic operations. We compare against (i) the Monte Carlo for propagating uncertainty, and (ii) the NIST uncertainty machine [4].

### Example 1: Using Samples from Parametric Distributions

We evaluate the ability of an embodiment of the present invention to represent and operate on samples from known parametric distributions. We randomly sample from Gaussian distributions to create the independent variables with distributional information “A” and “B” and perform all the basic arithmetic operations (addition, subtraction, multiplication and, division) on them. We verify the correctness of the mathematical operation by exhaustively performing each mathematical operation on all combination of samples of the input distributions (Monte Carlo). For these examples we used the TTR representation described above, with 8 Dirac deltas to represent variables with distributional information.

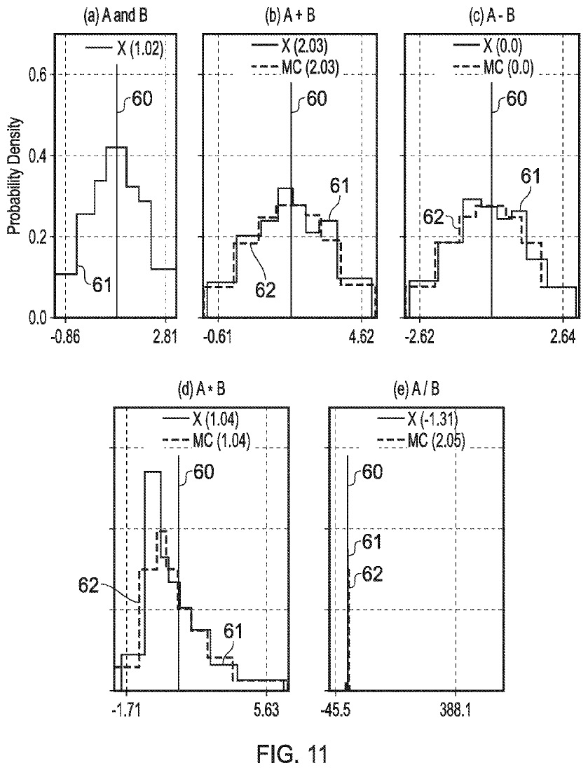

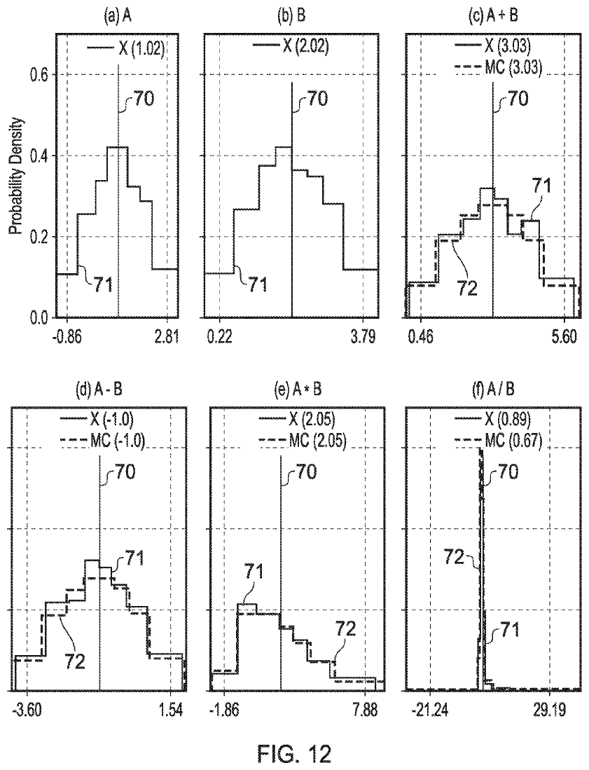

FIG. 11 and FIG. 12 show the histograms 61 (denoted in the figure legends as “X”) of the results. In the cases that the input independent samples come from the same parametric distribution, we illustrate the histograms of “A” and “B” using the same subfigure (e.g., FIG. 11(a)). We annotate the results 62 of the Monte Carlo simulation with a dashed line (MC). We show the mean 60 of each distribution in the legend of each subfigure. We also use a vertical line to annotate the mean of a distribution histogram 61 according to the invention. The x-axis of all subfigures corresponds to the domain of the distributions of each subfigure. FIGS. 11 to 12 correspond to modelling and arithmetic operations on Gaussian distributions, N(μ;σ²).

FIG. 11 shows the representations and arithmetic operations on two independent Gaussian random variables (N(1;1) and N(1;1)). The x-axis of all subfigures is the domain of the distribution. The dashed line shows the distribution of each arithmetic operation calculated using Monte Carlo on the input distribution samples. FIG. 12 shows the representations and arithmetic operations on two independent Gaussian random variables (N(1;1) and N(2;1)).

### Example 2: Thermal Expansion Coefficient

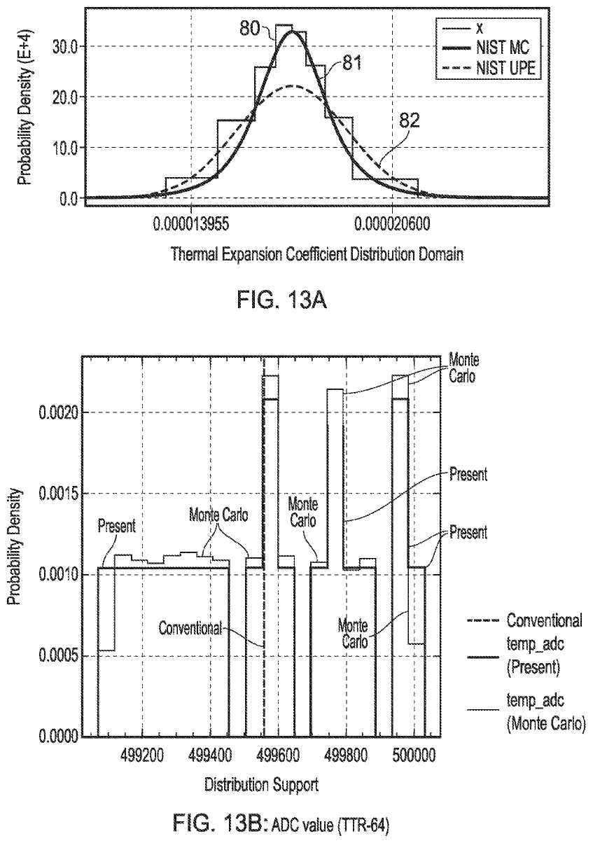

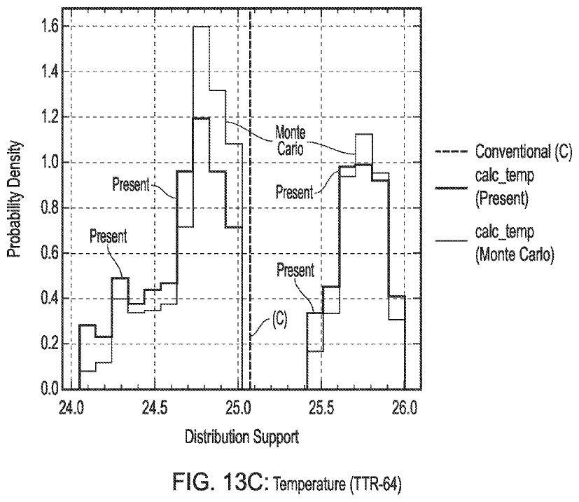

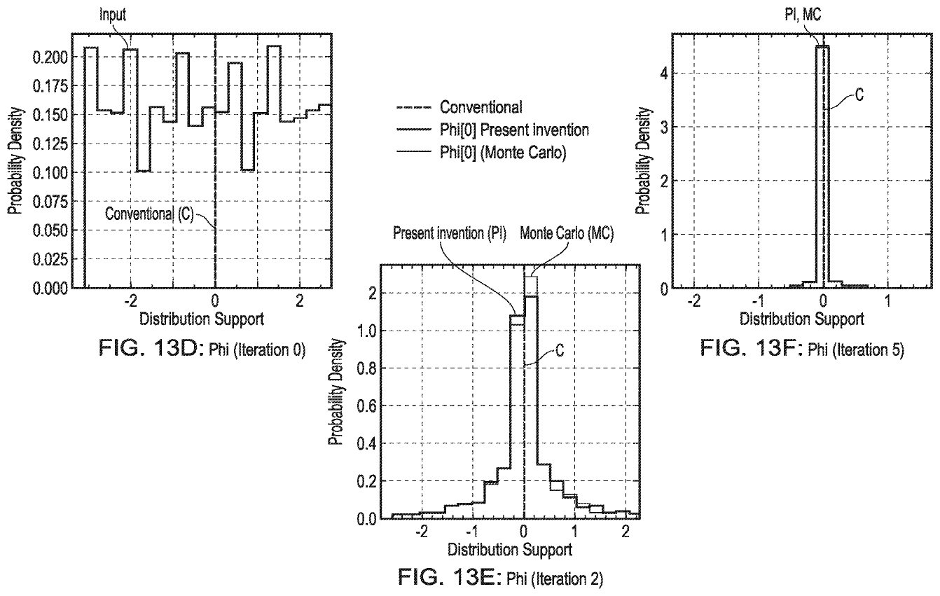

FIG. 13 shows the results for the distribution of the thermal expansion coefficient K of a cylindrical copper bar calculated from artificially-created measurements of its initial length Lₐ, final lengths L_{b} and the temperature difference ΔT. We assume that Lₐ is uniformly distributed on the interval [9,10], L_{b} is uniformly distributed on the interval [11;12] and ΔT has Gaussian distribution with N(2;1). The equation for calculating the thermal expansion coefficient is:

$$K = \frac{{L}_{b} - {L}_{a}}{{L}_{a} Δ T}$$

The results 80 (denoted in the figure legends as “X”) of the calculation of distributional information for the thermal expansion coefficient K, are compared against results (81, 82) from the NIST uncertainty machine [4]. The NIST Uncertainty Machine (NISTUM) is a Web-based software application that allows users to specify random variables and perform mathematical operations on them, including complex functions. Users specify the type and parameters of the parametric distributions that the input random variables to the NISTUM follow. The NISTUM provides two methods for propagating uncertainty during arithmetic operations. One method is based on the propagation of the centralized moments of the distribution, which we will refer to as NIST uncertainty propagation expression (NIST UPE—see curve 82). Another method is based on Monte Carlo simulation of the arithmetic operations on distributions, which we will refer to as NIST Monte Carlo (NIST MC—see curve 81). We examined three applications drawn from the examples of the NISTUM user manual [4]. We used random number generators to derive samples of the parametric distributions that the input variables of the examples follow. We used the Web-based interface of NISTUM to execute the example applications and get the data produced by NISTUM for both its uncertainty propagation methods. For these examples we used the TTR representation described above, with 8 Dirac deltas to represent variables with distributional information.

This example application corresponds to the measurement of the linear thermal expansion coefficient of a cylindrical copper bar of initial length Lₐ=1.4999 m measured with the bar at temperature T₀=288.15 K. The final length of the bar Lₐ was measured at temperature T₁=373.10 K and yielded L_{b}=1.5021 m. The measured variables were modelled as Student's t random variables with 3 degrees of freedom, with means equal to the measured values, and standard deviations equal to 0.0001 m for Lₐ, 0.0002 m for L_{b}, 0.02 K for T₀, and 0.05 K for T₁, respectively. FIG. 13 shows the comparison of the results according to the invention and NISTUM for the thermal expansion coefficient application.

### Example 3: Speed Estimation Using GPS Data

In human activity tracking, it is common to use GPS coordinates to estimate a person's movement speed. For this example we use a public dataset of human activity with timestamped GPS coordinates and GPS accuracy values. We adopt the methodology of Bornholt et al. [ref. 7] to derive a distribution of the GPS coordinates around a pair of GPS longitude and latitude values of the human activity dataset. We use the distributions of GPS coordinates to calculate the distribution of the estimated speed between two GPS points (gps-speed). Compared to the conventional microarchitecture, the average improvement of the TTR in terms of Wasserstein distance from the Monte Carlo evaluation output is 1.9×.

### Example 4: Bosch BME680 Sensor Conversion Routines

The BME680 by Bosch is a temperature, pressure, and humidity sensor. Bosch provides routines for converting raw ADC values to meaningful measurements using 20 sensor-specific calibration constants. This example evaluates the effect of noise in the ADC measurements and uncertainty in the calibration constants on the calibrated temperature, pressure, and humidity outputs of official commercial calibration firmware code provided by Bosch [ref. 8]. FIG. 13B shows the noisy temperature ADC measurements and FIG. 13C shows their effect on the converted temperature. In this application, aleatoric uncertainty leads to a bimodal distribution of the output result. The conventional architecture output falls in a zero probability range, meaning that average-filtering the noisy ADC leads to an incorrect result. Compared to the conventional methods, the present microarchitecture achieves on average 5.7× (up to 10× with TTR-64) smaller Wasserstein distance from the Monte Carlo output.

### Example 5: Brown-Ham Dislocation Model

This example calculates the cutting stress of an alloy precipitate using the Brown-Ham dislocation model [Ref. 10]. Anderson et al. [Ref. 9] provide empirical value ranges for the inputs of the dislocation model. We assume that the inputs of the dislocation model follow a uniform distribution across these ranges. On average, in comparison to the conventional methods, the present microarchitecture achieves 3.83× (up to 9.3×) higher accuracy with respect to the Monte Carlo simulation.

### Example 6: One-Dimensional Finite Element Model

An engineering problem for which uncertainties in the problem parameters have important safety implications relates to measurements of the properties of structural components. Consider a beam (e.g., concrete or steel) of cross-sectional area A and length L made of material with Young's modulus E loaded with an applied axial load q₀ per unit length. The beam's extension u(x) at position x from the cantilever, is:

$$u ( x ) = \frac{{q}_{0}}{2 AE} ( 2 xL - {x}^{2} )$$

Because of material variabilities or variations in atmospheric conditions, the Young's modulus may be uncertain and this uncertainty can be quantified with a probability distribution for the Young's modulus rather than using a single number. In the same way that engineers will often want to evaluate a floating-point implementation of the equation for the extension u(x) rather than one where the parameters are constrained to integer values, it is useful to evaluate the equation for the extension u(x) with parameters such as the Young's modulus as distributions representing uncertainty. The implementations of analytic models such as the equation for the extension u(x) or their finite-element counterparts may be in legacy or third-party libraries, making it attractive to have methods for tracking uncertainty that work on existing program binaries. A one-dimensional finite element model was used to calculate the extension of a beam when the model parameters have epistemic uncertainty. We assumed a uniform distribution of the Young's modulus input parameter of the benchmark and fixed particle values for the rest of the input parameters. The present microarchitecture achieved an average accuracy improvement of 2× compared to the conventional methods.

### Example 7: Accelerated Variational Quantum Eigensolver

This quantum algorithm calculates ground states of a quantum system Hamiltonian, H [refs. 11 and 12]. The present microarchitecture was applied configured to find the quantum state ψ(k) that minimizes the eigenvalue: [symbol] ψ(k [symbol] |H|ψ(k) [symbol] . Typically, this uses rejection sampling to calculate P(ϕ|E) from measurements of P(E|ϕ) from a quantum phase estimation (QPE) circuit [Ref. 13]. With the present microarchitecture we can explicitly calculate the posterior from P(E|ϕ) and calculate P(ϕ). Over multiple iterations on the present microarchitecture, the algorithm can calculate better estimates of P(ϕ|E). FIG. 13D shows the input which we generate using samples from a uniform distribution. FIGS. 13E and 13F show the decrease in the posterior variance P(ϕ) after two and five iterations on the present microarchitecture, respectively. The present microarchitecture achieves an accuracy improvement of 6.23× compared to the conventional techniques (up to 41.3× with TTR-256).

### Example

Referring once more to FIG. 1, in an alternative aspect of the invention, or in addition to aspects disclosed herein, an apparatus 1 is shown according to an embodiment of the invention. The apparatus comprises a computing apparatus 3 which is connected in communication with a measurement device 2 in the form of a sensor unit (e.g. an accelerometer, a magnetometer etc.) which is configured to generate measurements of a pre-determined measurable quantity: a measurand (e.g. acceleration, magnetic flux density etc.). The computing apparatus 3 includes a processor unit 4 in communication with a local buffer memory unit 5 and a local main memory unit 6. The computing apparatus is configured to receive, as input, data from the sensor unit representing measurements of the measurand (e.g. acceleration, magnetic flux density etc.), and to store the received measurements in the local main memory unit 6. The processor unit 4, in conjunction with the buffer memory unit 5, is configured to apply to the stored measurements a data processing algorithm configured for sampling the sensor measurements stored in main memory, so as to generate a sample set of measurements which represents the uncertainty in measurements made by the sensor unit 2 while also representing the measurand as accurately as the sensor unit may allow. The processor unit 4 may be configured to use the sample set to generate a probability distribution, and distributional information encoding the probability distribution, which can be used as the representation of uncertainty in measurements by the sensor unit. This representation may be according to any of the methods disclosed herein (e.g. a SoDD-based representation; a CMR representation) and discussed in detail elsewhere in the present disclosure.

The computing apparatus is configured to store the distributional data representing the uncertainty of measurements, once generated, in its main memory 6 and/or to transmit (e.g. via a serial I/O interface) the sample set to an external memory 7 arranged in communication with the computing apparatus, and/or to transmit via a transmitter unit 8 one or more signals 9 conveying the sample set to a remote receiver (not shown). The signal may be transmitted (e.g. via a serial I/O interface) wirelessly, fibre-optically or via other transmission means as would be readily apparent to the skilled person.

In this way, the computing apparatus is configured to generate and store any number (plurality) of sample sets, over a period of time, in which the distribution of measurement values within each sample set represents the probability distribution of measurements by the sensor unit 2, and associated approximating probability distributions and encoded distributional information. Similarly, the computing apparatus is configured to generate and store any number (plurality) of sample sets, approximating probability distributions and encoded distributional information, as generated by/in different modes of operation of the sensor unit 2 or as generated by a different sensor unit 2. In other words, a first sample set stored by the computing apparatus may be associated with a first sensor unit and a second sample set stored by the computing apparatus may be associated with a second sensor unit which is not the same as the first sensor unit. For example, the first sensor unit may be a voltage sensor (electrical voltage) and the second sensor unit may be a current sensor (electrical current). In both cases, the computing apparatus may store distributions of measurement values made by each sensor, respectively, which each represent the probability distribution of measurements by that sensor unit 2.

The computing apparatus 3 is configured to implement a method for computation on the distributions of data stored in the main memory unit such as: sample sets, approximating probability distributions and encoded distributional information, as follows.

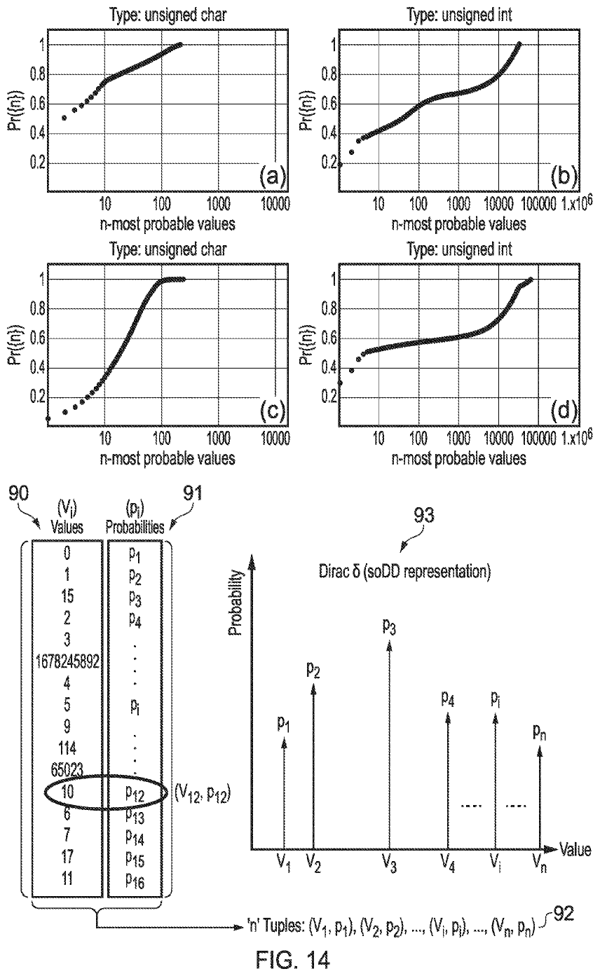

Referring to FIG. 14, there is shown examples [graphs: (a), (b), (c) and (d)] of the cumulative probability distributions of sets {n} of n values within each one of four different obtained data sets. FIG. 14 also shows a sub-set 90 of values (Vᵢ) from an obtained data set together with probability (pᵢ) values 91 each defining a probability for the occurrence of each value within the sub-set in question. Tuples 92 formed from data values 90 and associated probability values 91 are shown. An approximating probability distribution 93 is shown comprising a series of Dirac delta functions (SoDD representation, as disclosed herein) generated using these tuples 92. Each value (Vᵢ) within the sub-set (bounded to n values) is a value that the data can take on that has the highest probability within the obtained set of data.

By having the highest probability, this may mean that the data items in question comprise a pre-set number (n, an integer >1) of data items having the highest probability of occurrence within the obtained data set. In other words, the ‘top’ n data items that have the greatest probability or frequency, whatever that probability (frequency) may be, of occurrence within the obtained data set. This approach fixed the size of the sub-set to the value of n. The value of n may be chosen as desired according to the characteristics of the obtained data set. For example, the value of may be a value in the range: 5<n<100, such as n=50, or n=20 etc. Other values of n may be used, of course, as appropriate. The size of the value n can be chosen in each instance of the implementation of the invention, allowing implementations that trade the hardware or software cost of implementation for representational accuracy. The approximating probability distribution 93, comprising Dirac deltas, are an example representation where the n values represent the positions of n Dirac deltas and the probabilities associated with the values present the probabilities associated with the Dirac deltas.

Alternatively, by having the highest probability, this may mean that the data items in question comprise only those data items having probabilities, pᵢ, (or frequencies) exceeding a pre-set probability threshold value (e.g. p_{threshold}=0.2). This means that all of the probability (pᵢ) values 11 satisfy the condition: pᵢ>p_{threshold}. The value of p_{threshold} may be chosen as desired according to the characteristics of the obtained data set. For example, the value of p_{threshold} may be a value in the range: 0.1<p_{threshold}<0.9, or in the range 0.1<p_{threshold}<0.5, or in the range 0.2<p_{threshold}<0.5, such as e.g. p_{threshold}=0.25. Other values/ranges of p_{threshold} may be used, of course, as appropriate. In this case, the number (n) of values (Vᵢ, i=1, . . . , n) in the sub-set 90 will not be fixed, in general, and will typically vary depending on the value of p_{threshold}. Another alternative, by having the highest probability, this may mean that the selected data items comprise the greatest number of data items have respective probabilities that are individually higher than the probability associated with any non-selected data item (outside the set of selected data items) and the probabilities of the selected data items sum to an aggregate probability that does not exceed the threshold probability.

FIG. 14 shows real-world examples of collections of values of data items representing the distribution of values taken on by all program variables of types unsigned int and unsigned char for the programs from the MiBench suite of representative embedded system applications and from the SPEC CPU 2000 suite of representative desktop computer applications. The probabilities (Pr({n})) shown in the graphs (a), (b), (c) and (d) correspond to the probabilities of sets {n} of n values, and the fraction of the probability mass of the overall distribution that they represent, for two real-world sets of programs (MiBench [see ref. [5], top row of plots (a) and (b); and SPEC CPU 2000 [see ref. [6], bottom row of plots (c) and (d)). The sub-set 90 of values (Vᵢ) shows the set of actual elements, for n=16, for the MiBench unsigned int case.

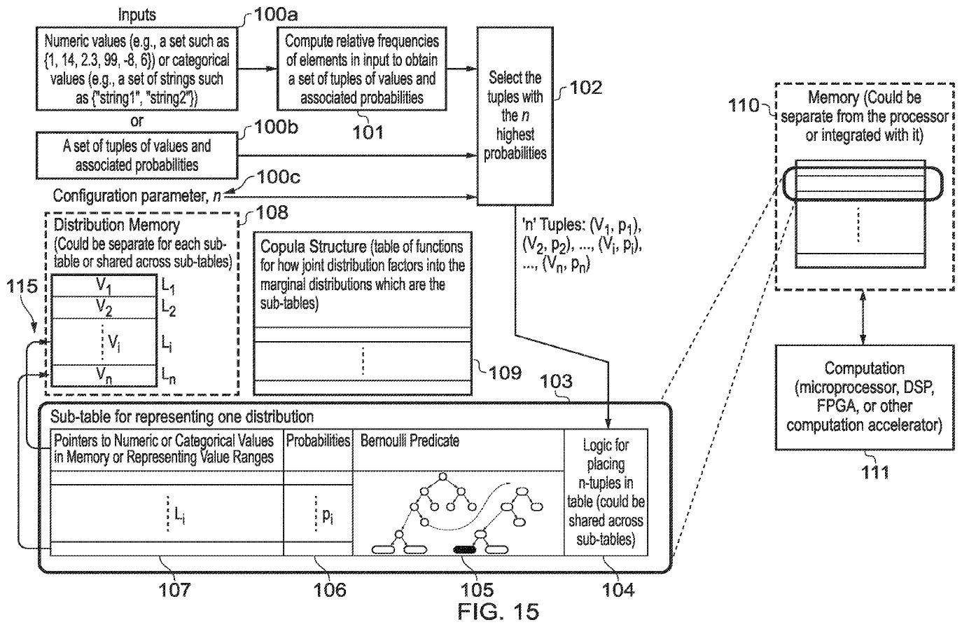

Referring to FIG. 15, there is shown a hardware block diagram of one embodiment of the invention. The computer apparatus 3 may be configured accordingly. The apparatus is configured to obtain input data as follows.

The apparatus receives as input 100a a data set of numeric values (e.g., a set such as {1, 14, 2.3, 99, −8, 6}) or categorical values (e.g., a set of strings such as {“string1”, “string 2” . . . }) and from them computes 101 relative frequencies of occurrence of elements within in input data set therewith to obtain a set of tuples (Vᵢ, pᵢ), of values and associated probabilities of each element within the set. Alternatively, the apparatus may receive as input 100b a set of tuples (Vᵢ, pᵢ) of values and associated probabilities that have been determined by the apparatus previously. In addition, as a further input, the apparatus may optionally receive a value of the number “n” representing the number of data elements to be contained within a sub-set {n} of data elements selected from the input data set 100a, or sub-set {n} of tuples from within the input 100b a set of tuples (Vᵢ, pᵢ), by selecting 102 the tuples with the n highest probability values (pᵢ) within the obtained data set (n, e.g. n=16 as in FIG. 14). In some implementations, the input parameter value 100c of the number “n”, may be omitted in those cases where, as discussed above, the data elements are selected based on the probability threshold of each individual item, or where data elements are selected such that their aggregate probability sums to some threshold. In an alternative implementation, the apparatus may, at this stage, select a sub-set the data items within the obtained data set which have a probability of occurrence within the obtained data set which exceeds the value of a pre-set threshold probability (as discussed above).

Next, the apparatus normalises the probability values (pᵢ) of each respective tuple (Vᵢ, pᵢ) associated with selected data items, such that the sum of those probabilities, of all selected data items, is equal to 1.0. This normalisation re-scales the probability values to be relative probabilities of occurrence amongst the respective tuples (Vᵢ, pᵢ) for members of the sub-set of data items. Each tuple (Vᵢ, pᵢ) for each of the data items within the sub-set comprises a first value (Vᵢ) and a second value (pᵢ) wherein the first value is a value of the respective data item and the second value is a value of the normalised probability of occurrence of the respective data item within the obtained data set.

The contents of each one of the ‘n’ tuples (Vᵢ, pᵢ) are then stored, separately, in a memory table 110 and in a distribution memory 108. In particular, for each tuple (Vᵢ, pᵢ), the first value (Vᵢ) thereof is stored at a respective memory location (Lᵢ) of the distribution memory 108. However, the second value (pᵢ) of the same tuple is stored in a sub-table (103: in software or hardware) of the memory table 110 in association with a pointer 115 configured to identify the respective memory location (Lᵢ) of the first value (Vᵢ) of the tuple (Vᵢ, pᵢ). This means that the sub-table 103 contains only the probability value 106 of each tuple, and a pointer 115 to the location 107 associated data value (numeric or categorical) of the tuple within a separate memory 108. The memory table 110 may be a structured memory in a circuit structure rather than an array in a computer memory. The apparatus includes a logic unit (104, 105) configured for receiving the selected ‘n’ tuples 102 and to store the probability values (pᵢ), in association with respective pointers 107, at locations within a sub-table of the table if the data values (Vᵢ) of the tuples comply with criteria defined by the logic unit. In the way, the apparatus may structure the memory table 110 to comprise sub-tables 103 each of which contains data of tuples satisfying a particular set of criteria. The criteria defining any one of the sub-tables may, of course, be different to the criteria defining any of the other sub-tables.

Computation of arithmetic operations may be executed on these distributions, in any manner described herein, by a microprocessor, digital signal processor (DSP) or Field Programmable Gate Array (FPGA) of the apparatus 31.

The apparatus is configured to implement a copula structure 109 for combining the individual distributions 93 represented using the tuples of separate tables (each formed as described above, e.g. SoDD), or of separate sub-tables, to achieve joint distributions. The copula structure may be configured to generate a multivariate cumulative distribution function for which the marginal probability distribution of each variable is uniform on the interval [0, 1]. This is an example only, and it is to be understood that using the copula to generate a multivariate CDF from uniform marginals is optional. There are many parametric copula families available to the skilled person for this purpose.

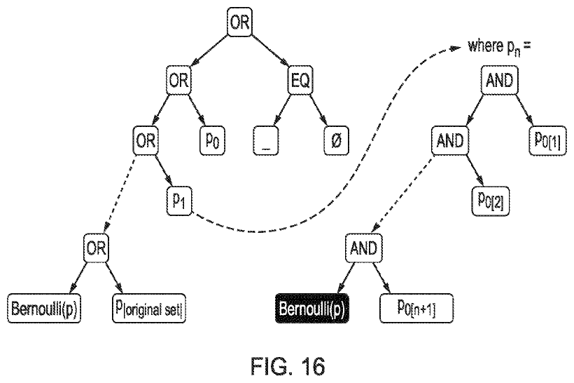

The logic unit may be configured to implement a probabilistic (e.g. non-Boolean) predicate 105 for the table which is configured to return a probability (Bernoulli(p)) (i.e. rather than a Boolean ‘true/′false’ value), for each of the given data values (Vᵢ) to which it is applied. A schematic example is shown in FIG. 16. The criteria defining different sub-tables may be implemented in this way. Since the predicate may be considered in terms of a predicate tree, this permits the predicate to be flattened into a string using pre-order traversal or post-order traversal of all of the nodes of the tree and this flattened tree can be used as the distribution representation, if desired. This may significantly reduce the size of the representation to being one that scales linearly with the size of the representation rather than exponentially. Techniques for pre-order traversal or post-order traversal of all of the nodes of the tree may be according to techniques readily available to the skilled person.

The apparatus may be further configured to determining a probability (or frequency) of occurrence of the data items within the obtained data set which do not exceed the value of the pre-set threshold probability (or threshold frequency) or are not amongst the pre-set number {n}. In other words, the method may include determining the further probability (p_{overflow}) of occurrence of data items within the obtained data set that do not belong to the sub-set {n} of data items or of selected tuples with the n highest probability values. In this case, the apparatus normalises the probability values (pᵢ), of each of the {n} selected data items such that the sum:

p_{overflow}+Σᵢ₌₁ⁿpᵢ=1.0.

In this way, the further probability may take account of the probability of a data item of the obtained data set being outside of the sub-set and thereby provide an ‘overflow’ probability.

The apparatus, in this case, generates a collective tuple (V_{overflow}, p_{overflow}) collectively representing those data items of the obtained data set not within the sub-set. The value V_{overflow}, is collectively representative of the data items of the obtained data set not within the sub-set. The value p_{overflow}, is a value of the normalised further probability of occurrence (e.g. cumulative or aggregate probability) of the data items not within the selected sub-set, {n}. The collective tuple may be stored in the memory table 110, split across the sub-table 103 and the distribution memory 108, in the manner described above. In a preferred embodiments, V_{overflow} may be a “special” value, analogous to NaN (“not a number”) and Inf (infinity) which denotes an unknown value. Such values are sometimes referred to as erasure values.

An insight of the present invention is to represent the elements of a sub-set {n} with a hardware table structure 110 comprising a table entries for each of: (1) pointers to memory locations for the basis values of the distributions, whether numbers, strings, etc., including a possible overflow item to represent all other possible basis values not explicitly listed; (2) table entries for the probabilities for each basis value, including an entry for the probability of the overflow item mentioned above; (3) updating the columns of the table to ensure the probabilities sum to one. Because each distribution in use in the computing system could in principle be associated with a different such table (e.g., distributions corresponding to different points in time of a heteroscedastic process or distributions corresponding to different variables in a program), from the context of the overall computing system, the present disclosure refers to these tables as sub-tables. In a typical implementation, a system may contain a collection of such sub-tables, one sub-table for each distribution that the system requires to represent.

Every distribution instance (i.e., each sub-table) may be given a unique identifier, so that a computing system can reference the different distributions (i.e., the marginals).

Because the structure disclosed herein uses pointers to elements as the value representation, rather than the values themselves, an implementation can represent distributions where the basis values might either represent specific integers, specific real-valued values, or integer or real-valued value ranges. They could also represent strings or other categorical labels. In the special case where the values to be represented can fit directly into the table, the pointers can be replaced with the values to be represented, directly. The ability of the invention to use entries in the table to represent value ranges means that representing histograms of numbers can be used. The invention also provides the flexibility to represent, e.g., individual strings of text or lexicographically-ordered ranges of strings of text in a language orthography and their associated probabilities, and so on.

In addition to operations on the distribution representation in a microprocessor that permits arithmetic on distributions on numbers, the operations on the sub-table could also be set theoretic operations such as intersection, union, complement, and so on. For example, given two distributions representing sets of words and their corresponding probabilities, the union operation will have a new distribution whose basis values are the n items (for a representation table of size n) with the highest probabilities from the constituent sets of the union operation, with the probabilities appropriately normalized so that the new distribution has elements whose probabilities sum to one (1.0).

The components of the hardware structure maybe sub-tables for each distribution, a memory for holding the basis values of distributions, a copula structure for combining the individual distributions to achieve a joint distribution, and logic for taking sets of values and placing them into the sub-tables in the form of distributions.

### Example

In computer science, three-address code (often abbreviated to TAD, TAC or 3AC) is an intermediate code used by optimizing compilers to aid in the implementation of code-improving transformations. Each TAC instruction has at most three operands and is typically a combination of assignment and a binary operator. For example, t1:=t2+t3. The name derives from the use of three operands in these statements even though instructions with fewer operands may occur. In three-address code, a program may be broken down into several separate instructions. These instructions translate more easily to assembly language.

A basic block in a three-address code (TAD) can be considered to be a sequence of contiguous instructions that contains no jumps to other parts of the code. Dividing a code into basic blocks makes analysis of control flow much easier. In compiler construction, a basic block may be considered as a straight-line code sequence with no branches in, except to the entry to the code, and no branches out, except at the exit from the code. This makes a basic blocks highly amenable to analysis. Compilers usually decompose programs into their basic blocks as a first step in the analysis process. Basic blocks can also be considered to form the vertices or nodes in a control flow graph.

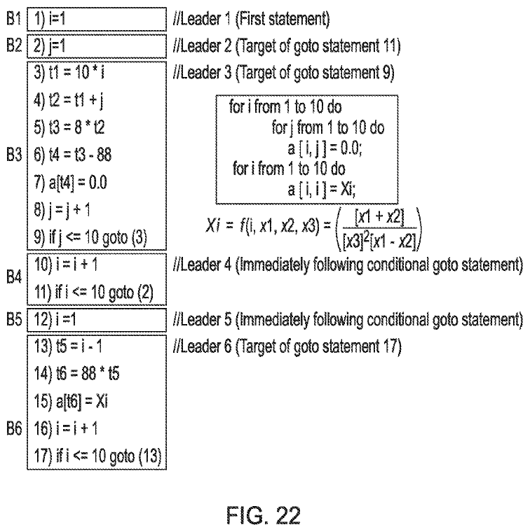

FIG. 22 shows an example of TAD of the following program for generating a 10×10 diagonal matrix with diagonal matrix elements Xi.

### Example: Code to Set a 10×10 Diagonal Matrix with Diagonal Elements Xi

```
for i from 1 to 10 do
  for j from 1 to 10 do
    a[i, j] = 0.0;
  for i from 1 to 10 do
    a[i, i] = Xi;
```

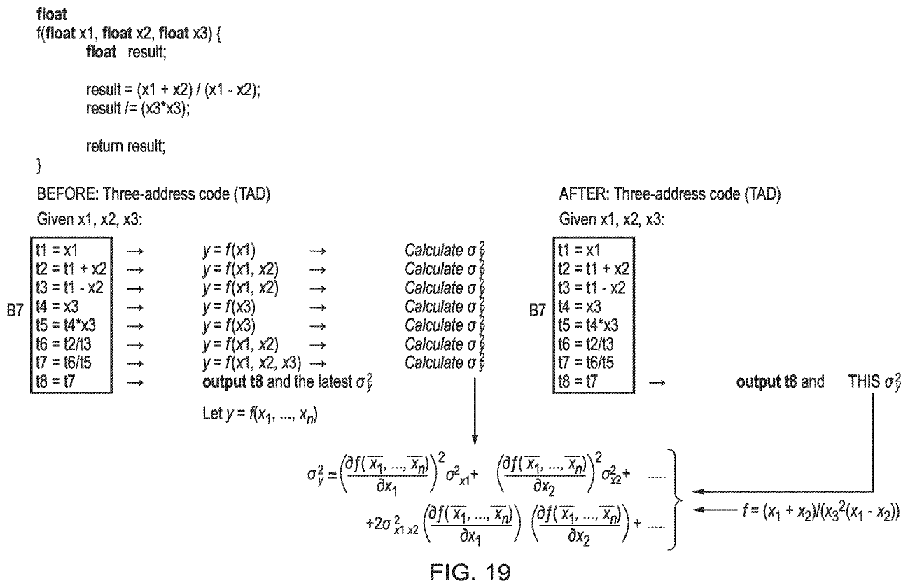

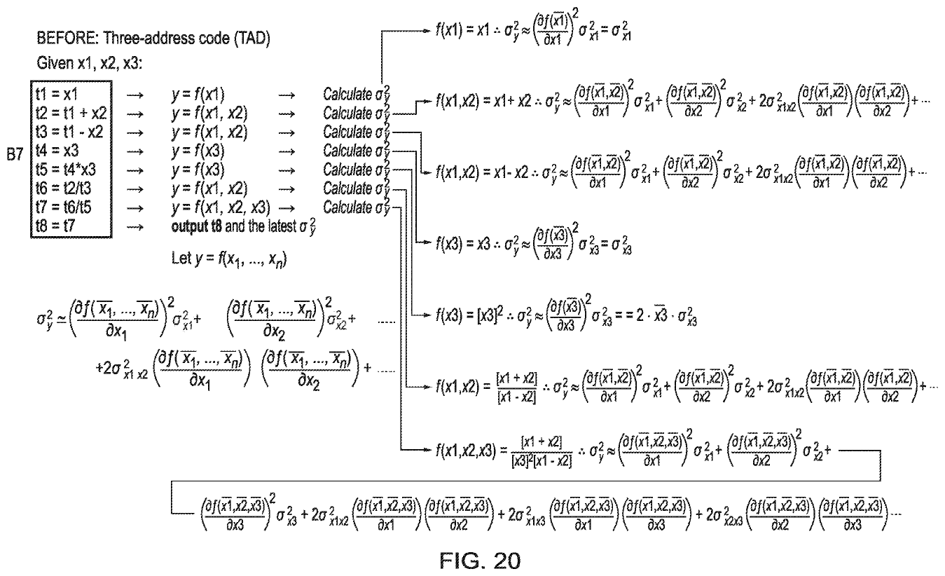

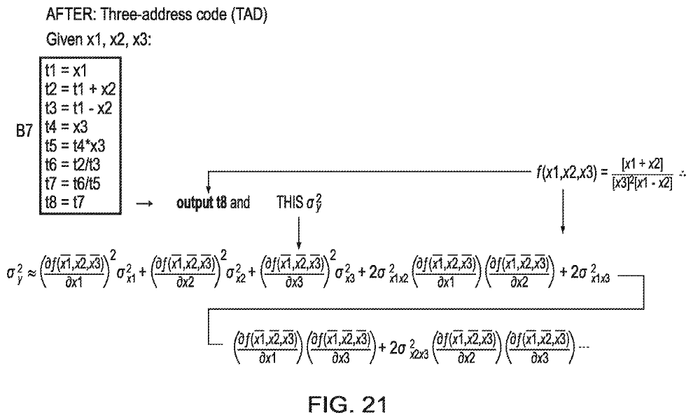

The TAC is partitioned into basic blocks B1 to B6 according to the partitioning rules defined below. Here, Xi appears in basic block B6, and the value of Xi may be generated by another basic block of code (Block B7: see FIG. 19, FIG. 20 and FIG. 21) designed to calculate the following:

$$Xi = f ( i , x 1 , x 2 , x 3 ) = ( \frac{[ x 1 + x 2 ]}{{[ x 3 ]}^{2} [ x 1 - x 2 ]} )$$

Steps (3)-(6) of the TAD are used to make a matrix element ‘0’ and step (15) of the TAD is used to make a matrix element Xi.

Partitioning Three-Address Code into Basic Blocks

The process of partitioning a TAD code comprises an input stage of receiving a TAD code, followed by a processing stage in which the input TAD code is processed to partition it, as follows.

### Input:

A sequence of three address instructions (TAD).

### Process:

“Leader” instructions within a code are determined as follows:
(1) The first “three-address” instruction of the code is a leader.
(2) Instructions which are targets of unconditional or conditional jump/goto statements are leaders.
(3) Instructions which immediately follows unconditional or conditional jump/goto statements are leaders.
For each leader, its basic block contains itself and all instructions up to, but excluding, the next leader. A basic block contains only statements that execute in a sequence one after the other. A variable name in a basic block is ‘live’ at a given point if its value is used after that point in the program.

Application of this process to the TAD code of FIG. 22 results in a first basic block B1 comprising a first leader (“Leader 1”) in the form of the first statement line 1) of the TAD. The second basic block B2 arises at the second statement line 2) of the TAD which defines a second leader (“Leader 2”). This arises because this statement line is the target of a “goto” statement at TAD line 11). The third basic block B3 arises at the third statement line 3) of the TAD which defines a third leader (“Leader 3”). This arises because this statement line is the target of a “goto” statement at TAD line 9). The fourth basic block B4 arises at the tenth statement line 10) of the TAD which defines a fourth leader (“Leader 4”). This arises because this statement line immediately follows a conditional “goto” statement at TAD line 9). The fifth basic block B5 arises at the twelfth statement line 12) of the TAD which defines a fifth leader (“Leader 5”). This arises because this statement line immediately follows a conditional “goto” statement at TAD line 11). The final basic block B6 of the TAD code arises at the thirteenth statement line 13) of the TAD which defines a sixth leader (“Leader 6”). This arises because this statement line is the target of a “goto” statement at TAD line 17). In this way, a TAD code may be partitioned into basic blocks.

The following disclosure describes an example of a computer apparatus configured for generating a TAD code in respect of program codes executed by the computer, and configured for partitioning the TAD codes into basic blocks. The computer apparatus is configured rearrange TAD instruction sequences to reduce numeric error in propagating uncertainty across the computation state (e.g., registers) on which the instruction sequences operate. This is particularly useful when executing arithmetic on distributions representing uncertainty in data handled by the computer, as discussed more fully elsewhere herein. The data handled by the computer may, for example, be measurement data from a measurement apparatus (e.g. a sensor) and the distributions representing uncertainty in data may represent the uncertainty in the value of the measurements made by the measurement apparatus.

Referring once more to FIG. 1, in an alternative aspect of the invention, or in addition to aspects disclosed herein, an apparatus 1 is shown according to an embodiment of the invention. The apparatus comprises a computing apparatus 3 which is connected in communication with a measurement device 2 in the form of a sensor unit (e.g. an accelerometer, a magnetometer etc.) which is configured to generate measurements of a pre-determined measurable quantity: a measurand (e.g. acceleration, magnetic flux density etc.). The computing apparatus 3 includes a processor unit 4 in communication with a local buffer memory unit 5 and a local main memory unit 6. The computing apparatus is configured to receive, as input, data from the sensor unit representing measurements of the measurand (e.g. acceleration, magnetic flux density etc.), and to store the received measurements in the local main memory unit 6. The processor unit 4, in conjunction with the buffer memory unit 5, is configured to apply to the stored measurements a data processing algorithm configured for sampling the sensor measurements stored in main memory, so as to generate a sample set of measurements which represents the uncertainty in measurements made by the sensor unit 2 while also representing the measurand as accurately as the sensor unit may allow. The processor unit 4 is configured to use the sample set to generate an approximating probability distribution and distributional information encoding the approximating probability distribution as the representation of uncertainty in measurements by the sensor unit according to any of the methods disclosed herein (e.g. a SoDD-based representation; a CMR representation as disclosed in other aspects herein) and discussed in detail elsewhere in the present disclosure.

The computing apparatus is configured to store the distributional data representing the uncertainty of measurements, once generated, in its main memory 6 and/or to transmit (e.g. via a serial I/O interface) the sample set to an external memory 7 arranged in communication with the computing apparatus, and/or to transmit via a transmitter unit 8 one or more signals 9 conveying the sample set to a remote receiver (not shown). The signal may be transmitted (e.g. via a serial I/O interface) wirelessly, fibre-optically or via other transmission means as would be readily apparent to the skilled person.

In this way, the computing apparatus is configured to generate and store any number (plurality) of sample sets, over a period of time, in which the distribution of measurement values within each sample set represents the probability distribution of measurements by the sensor unit 2, and associated approximating probability distributions and encoded distributional information. Similarly, the computing apparatus is configured to generate and store any number (plurality) of sample sets, approximating probability distributions and encoded distributional information, as generated by/in different modes of operation of the sensor unit 2 or as generated by a different sensor unit 2. In other words, a first sample set stored by the computing apparatus may be associated with a first sensor unit and a second sample set stored by the computing apparatus may be associated with a second sensor unit which is not the same as the first sensor unit. For example, the first sensor unit may be a voltage sensor (electrical voltage) and the second sensor unit may be a current sensor (electrical current). In both cases, the computing apparatus may store distributions of measurement values made by each sensor, respectively, which each represent the probability distribution of measurements by that sensor unit 2.

The computing apparatus 3 is configured to implement a method for computation on the distributions of data stored in the main memory unit such as: sample sets, approximating probability distributions and encoded distributional information, as follows.

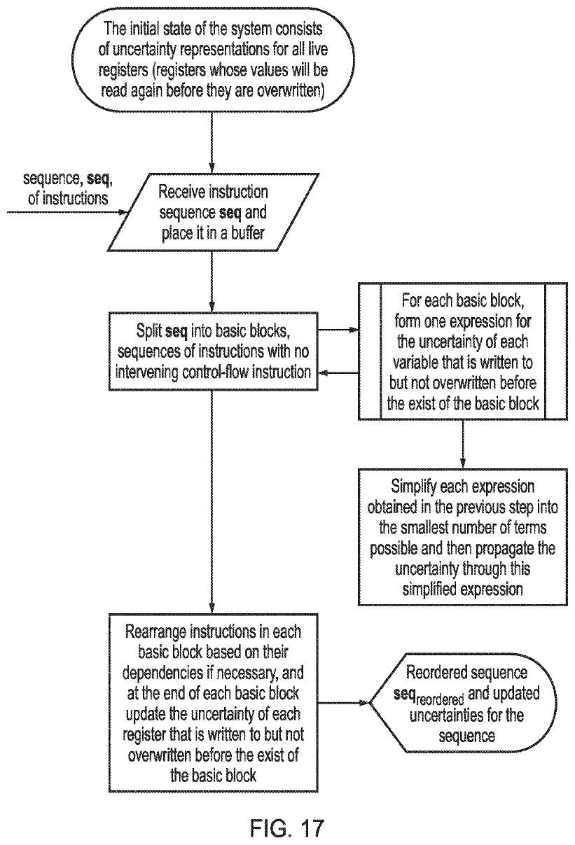

Referring to FIG. 17, there is shown a flow diagram illustrating process steps in the method implemented by the computer apparatus 3. The process steps are configured for computing a numerical value for uncertainty in the result of a multi-step numerical calculation comprising a sequence of separate calculation instructions defined within a common “basic block”.

The method is applied to distributions of data contained within the buffer memory unit 5 of the computer apparatus 3, having been placed in the buffer memory from the main memory unit 6 by the processor unit 4, for this purpose.

Initialisation: The initial state of the system consists of uncertainty representations for all live registers (registers whose values will be read again before they are overwritten).
Step #1: Receive instruction sequence seq and place it in buffer memory unit 5.
Step #2: Split seq into basic blocks, sequences of instructions with no intervening control-flow instruction.
Step #2B: For each basic block, form one expression for the uncertainty of each variable that is written to but not overwritten before the exit of the basic block.
Step #2C: Simplify each expression obtained in the previous step into the smallest number of terms possible and then propagate the uncertainty through this simplified expression.
Step #3: Rearrange instructions in each basic block based on their dependencies if necessary, and at the end of each basic block update the uncertainty of each register that is written to but not overwritten before the exit of the basic block.
Step #4: Output the re-ordered sequence seq_{reordered} and updated uncertainties (distributions of data) for the sequence.

By this method (i.e. Step #1 to Step #4), the computer apparatus 3 identifies “live-out” variable(s) of the “basic block” (Step #1). It then identifies calculation instructions on who's output the value of the “live-out” variable depends (Step #2). Then, at steps #2A and #2B, it provides a mathematical expression combining the calculation instructions identified at step #2. Using the mathematical expression of provided at step #2C, the computer apparatus computes, at step #3, a numerical value for uncertainty in the “live-out” variable. Notably, the uncertainty value computed at step #3 is the uncertainty in the result of the multi-step numerical calculation. This process not only makes the final result of the calculation more accurate, but also makes the calculation process more efficient.

In this way, for the live-out variables of the basic block, rather than computing the updated uncertainty for each TAD instruction, the sequence of instructions whose result determines the value of the live-out variable can be combined into a single expression, at step #2C, for the purposes of computing the updated uncertainty of the live-out variable.

The method may be implemented in a programmable processor. It provides a means for rearranging instructions that perform operations on representations of uncertainty, such that the rearranged instructions still obey true data dependences. The rearranged instruction sequences have better numerical stability when the processor processing the instructions associates uncertainty representations with the values on which the instructions operate.

In one realization, when the uncertainty representation is based on the moments of a probability distribution (e.g. the CMR uncertainty representation disclosed herein) and where the method for computing on uncertainty is based on the Taylor series expansion of the instruction operation around the mean value of the value being operated on, then the rearrangement of instructions improves the numerical stability of the evaluation of the Taylor series expansion of the function corresponding to the aggregate set of instructions.

The rearrangement can be applied to any method for propagating uncertainty through a sequence of arithmetic operations and is not limited to this specific example case of using Taylor series expansions of the functions through which uncertainty is being propagated. The instruction rearrangement method is valuable for any programmable processor architecture that implements arithmetic on probability distributions and where that arithmetic could have different numerical stability properties when instructions are rearranged in dependence-honouring functionally-equivalent orderings.

### Combining Variance Estimate for Live-Out Variables

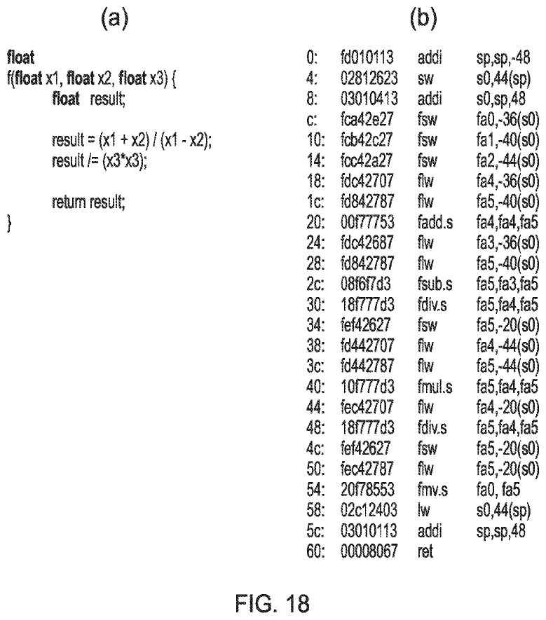

FIG. 18(a) shows a simple program that performs a sequence of arithmetic operations and FIG. 18(b) shows the assembly language instruction sequence generated by a compiler, from that program. While different compilers and different compilation options will lead to slightly different instruction sequences, the sequence of program statements in FIG. 18(a) will always be translated into a sequence of assembly language instructions which, when executed, lead to the arithmetic operations required by the program. In particular, FIG. 18(a) shows a program that performs arithmetic on three floating-point variables. When executed on a processor architecture that associates some representation of uncertainty to each variable, the arithmetic in each program statement will require the hardware implemented in the processor to evaluate new distributions for the uncertainties of intermediate and final results. FIG. 18(b) shows the program in FIG. 18(a) compiles to the sequence of assembly language instructions for a processor. Rather than updating the uncertainty for the destination register of each instruction in FIG. 18(b) separately, it is possible to generate an instance of an equation defining the uncertainty (σ_{y}²) in a calculated quantity, y=ƒ(x₁, . . . , xₙ), that implements the combined expression:

ƒ=(x1+x2)/(×3*x3*(x1−x2)).

In particular, for example, let ƒ be a function implemented by some sequence of statements in a high-level language such as C or implemented by any sequence of instructions executing within a programmable processor. The function ƒ might also represent a collection of logic gates in a fixed-function digital integrated circuit such as an ASIC or in a field-programmable digital circuit such as an FPGA. Let x₁, x₂, . . . , xₙ be the parameters of the function ƒ.

The method for determining the uncertainty of the function ƒ based on the Taylor series expansion of ƒ specifies that the uncertainty in ƒ, represented by its standard deviation as follows. This example is particularly relevant for propagating uncertainty is the CMR method disclosed herein. The present invention, in the presently-described aspect, could be applied to other distribution representations and propagation methods other than the CMR/Taylor series expansion methods. However, for illustrative purposes, and to allow a better understanding of the invention, the following example concerns the CMR/Taylor series expansion methods.

$$Let y = f ( {x}_{1} , ... , {x}_{n} ) , then :$$

$${σ}_{y}^{2} ≃ {( \frac{\partial f ( \overline{{x}_{1}} , … , \overline{{x}_{n}} )}{\partial {x}_{1}} )}^{2} {σ}_{{x}_{1}}^{2} + {( \frac{\partial f ( \overline{{x}_{1}} , … , \overline{{x}_{n}} )}{\partial {x}_{2}} )}^{2} {σ}_{{x}_{2}}^{2} + … + 2 {σ}_{{x}_{1} {x}_{2}}^{2} ( \frac{\partial f ( \overline{{x}_{1}} , … , \overline{{x}_{n}} )}{\partial {x}_{1}} ) ( \frac{\partial f ( \overline{{x}_{1}} , … , \overline{{x}_{n}} )}{\partial {x}_{2}} ) + …$$

The variances in the right hand side of the above expression are typically small and computing the squares and higher powers of those variances leads to numeral errors in practice. The insights of the method in this disclosure are:
(1) to represent the standard deviations within the computation hardware's internal representation for the digital logic circuit implementing the above equation (σ_{y}²), with an unsigned fixed-point representation rather than representing them with floating-point representations, since the variances will always be positive; and,
(2) to combine sequences of arithmetic operations that do not contain a control-flow instruction (i.e., a basic block) where those operations being combined would otherwise be treated separately, for the purposes of computing the variance of variables that will be used again before being overwritten (i.e., the live variables).

The second of the insights above reduces the number of times the approximations of the above equation (σ_{y}²) need to be applied, to reduce error in the computed uncertainty. Both of these insights can be implemented in hardware or could also be implemented as a compile-time transformation on a source program, or using a combination of compile time transformations (e.g., to determine the combined function for each basic block and its partial derivatives, e.g., using automatic differentiation) combined with evaluating the instance of the above equation (σ_{y}²) generated in that process, in hardware when the values of the variances are available. Other methods for representing and propagating uncertainty in a digital computation hardware structure might use methods different from the above equation (σ_{y}²) but the present methods herein make the uncertainty tracking more numerically stable and will still apply.

FIG. 19 schematically shows the effect of the invention on implementation of the program code of FIG. 18(a) for calculating the quantity:

ƒ=(x1+x2)/(x3*x3*(x1−x2))

via a TAD code in a basic block B7 both before (“BEFORE” in FIG. 19) and after (“AFTER” in FIG. 19) application of the invention. In the case of before application of the invention, it can be seen that the quantity σ_{y}² must be calculated eight times, once for each of the eight code lines of the TAD code within basic block B7. The final output line of the TAD code produces the variable “18” which carries the value of ƒ. The final output line of the TAD code produces the latest value of the quantity σ_{y}² quantifying the uncertainty in ƒ. All preceding values of σ_{y}² quantify the uncertainty in the preceding seven TAD variables (t1 to t7) within the basic block B7. FIG. 20 shows this explicitly, in which each expression σ_{y}² for each one of the TAD code lines t1 to t8 (see “BEFORE” in FIG. 19) are explicitly defined and calculated. Contrast this with FIG. 21 in which the invention has been applied and only the expression o? for the final TAD code line t8 (see “AFTER” in FIG. 19) is explicitly defined and this expression is used/calculated by the processor 4 to quantify the uncertainty in the function ƒ. This instruction sequence has better numerical stability for calculating the uncertainty representation σ_{y}².

In other words, FIG. 21 implements Step #2B, above, whereby for basic block B7, one expression is formed for the uncertainty σ_{y}² of the variable “18” that is written to but not overwritten before the exit of that basic block. Step #2C is implemented in that the expression σ_{y}² is a simplified expression obtained in Step #2B having the smallest number of terms possible. This is then used to propagate the uncertainty.

References herein to a “tuple” may be considered to include a reference to a finite ordered list of elements. References herein to an “n-tuple” may be considered to include a reference to a sequence of n elements, where n is a non-negative integer.

References herein to a “parameter” may be considered to include a reference to a numerical or other measurable factor forming one of a set (of one or more) that defines a system or sets its properties, or a quantity (such as a mean or variance) that describes a statistical population, or a characteristic that can help in defining or classifying a particular system, or an element of a system that identifies the system.

References herein to “threshold” may be considered to include a reference to a value, magnitude or quantity that must be equalled or exceeded for a certain reaction, phenomenon, result, or condition to occur or be manifested.

References herein to “distribution” in the context of a statistical data set (or a population) may be considered to include a reference to a listing or function showing all the possible values (or intervals) of the data and how often they occur. A distribution in statistics may be thought of as a function (empirical or analytical) that shows the possible values for a variable and how often they occur. In probability theory and statistics, a probability distribution may be thought of as the function (empirical or analytical) that gives the probabilities of occurrence of different possible outcomes for measurement of a variable.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

### REFERENCES

[1] Anders Hald, The early history of the cumulants and the Gram-Charlier series, International Statistical Review 68 (2000), no. 2, 137-153.
[2] Peter Hall, The bootstrap and Edgeworth expansion, Springer Science & Business Media, 2013.
[3] Rabi N Bhattacharya, Jayanta K Ghosh, et al., On the validity of the formal Edgeworth expansion, Ann. Statist. 6 (1978), no. 2, 434-451.
[4] T. Lafarge and A. Possolo, NIST uncertainty machine-user's manual, National Institute of Standards and Technology, Gaithersburg, 2015. (https://uncertainty.nist.gov/ and https://www.nist.gov/publications/uncertainty-machine-users-manual)
[5] MiBench: “A free, commercially representative embedded benchmark suite” by Matthew R. Guthaus, Jeffrey S. Ringenberg, Dan Ernst, Todd M. Austin, Trevor Mudge, Richard B. Brown, IEEE 4th Annual Workshop on Workload Characterization, Austin, TX, December 2001. (http://vhosts.eecs.umich.edu/mibench//)
[6] The most widely used benchmarks are the Standard Performance Evaluation Corporation (SPEC) CPU benchmarks: “SPEC2000 Retires SPEC92”, by B. Case, The Microprocessor Report, vol. 9, 1995
[7] James Bornholt, Todd Mytkowicz, and Kathryn S Mckinley. 2015. Uncertain<t>: Abstractions for uncertain hardware and software. IEEE Micro 35, 3 (2015), 132-143.
[8] Bosch Sensortec. [n. d.]. BME680 sensor API. [Online]. Available: https: //github.com/BoschSensortec/BME680_driver, Accessed: 07/09/2021.
[9] M. J. Anderson, F. Schulz, Y. Lu, H. S. Kitaguchi, P. Bowen, C. Argyrakis, and H. C. Basoalto. 2020. On the modelling of precipitation kinetics in a turbine disc nickel-based superalloy. Acta Materialia 191 (2020), 81-100. https://doi.org/10.1016/j. actamat.2020.03.058.
[10] L M Brown and R K Ham. 1971. Dislocation-particle interactions. Strengthening methods in crystals (1971), 9-135.
[11] James R Cruise, Neil|Gillespie, and Brendan Reid. 2020. Practical Quantum Computing: The value of local computation. arXiv preprint arXiv:2009.08513 (2020).
[12] Daochen Wang, Oscar Higgott, and Stephen Brierley. 2019. Accelerated Variational Quantum Eigensolver. Phys. Rev. Lett. 122 (April 2019), 140504. Issue 14. https://doi.org/10.1103/PhysRevLett.122.140504.
[13] Nathan Wiebe and Chris Granade. 2016. Efficient Bayesian Phase Estimation. Phys. Rev. Lett. 117 (June 2016), 010503. Issue 1. https://doi.org/10.1103/PhysRevLett.117.010503.

1. A method for processing digitally encoded data computation on distributions of data by a processor that includes a microarchitecture comprising a first register containing at least one data item, a second register containing distribution data representing distributions that are uncertainty representations associated with the at least one data item, a first arithmetic logic unit for executing arithmetic on the at least one data item selected from the first register, and a second arithmetic logic unit for executing arithmetic on the distribution data selected from the second registers, the method comprising the operations of responding to an instruction to be executed by the processor by:
executing, by the first arithmetic logic unit, a first arithmetic operation on the at least one data item selected from the first register, and outputting the result;
executing, by the second arithmetic logic unit, the first arithmetic operation on the distribution data representing distributions selected from the second register, wherein the distribution data is associated with the at least one data item selected from the first register, and outputting the result
comprising further distribution data representing uncertainty associated with the result of the arithmetic operation executed on the at least one data item selected from the first register.

2. (canceled)

3. The method of claim 1 wherein the operation of executing the first arithmetic operation by the second arithmetic logic unit is triggered by a command that triggers the operation of executing the first arithmetic operation by the first arithmetic logic unit.

4. The method of claim 1 wherein the processor includes a memory unit configured to store data items at addressed memory locations therein, the method comprising the following operations implemented by the microarchitecture:
obtaining originating memory location addresses of data items that contribute to the arithmetic operation executed by the first arithmetic logic unit as the first arithmetic logic unit executes the arithmetic operation;
storing the obtained originating memory location addresses at a storage location within the memory unit; and
associating the storage location with the further distribution data.

5. The method of claim 1 wherein:
the first register contains a first data item and a second data item;
the second register contains first distribution data comprising a first tuple containing parameters encoding a probability distribution characterising an uncertainty representation associated with the first data item;
the second register contains second distribution data comprising a second tuple containing parameters encoding a probability distribution characterising an uncertainty representation associated with the second data item in which the parameters used to encode the second distribution data are substantially the same as the parameters used to encode the first distribution data; and,
the operation of executing, by the second arithmetic logic unit, the first arithmetic operation on the distribution data comprises
selecting the first tuple and the second tuple and generating a third tuple using parameters contained within the first tuple and the second tuple, wherein the third tuple contains parameters encoding the further distribution data; and
outputting the third tuple.

6. The method of claim 5 wherein the third tuple contains parameters encoding the further distribution data that are substantially the same as the parameters used to encode the probability distribution characterising the uncertainty representation associated with the first data item.

7. The method of claim 5 wherein:
the distribution data comprises probability distributions of respective data items;
the first tuple contains parameters encoding the position of data items within the probability distribution characterising the uncertainty representation associated with the first data item;
the second tuple contains parameters encoding the position of data items within the probability distribution characterising the uncertainty representation associated with the second data item; and,
the third tuple contains parameters encoding the position of data items within a probability distribution characterising the further distribution data.

8. The method of claim 5 wherein:
the distribution data comprises probability distributions of respective data items;
the first tuple contains parameters encoding the position and/or width of data intervals within the probability distribution characterising the uncertainty representation associated with the first data item;
the second tuple contains parameters encoding the position and/or width of data intervals within the probability distribution characterising the uncertainty representation associated with the second data item; and,
the third tuple contains parameters encoding the position and/or width of data intervals within a probability distribution characterising the further distribution data.

9. The method of claim 5 wherein:
the distribution data comprises probability distributions of respective data items;
the first tuple contains parameters encoding the probability of data items within the probability distribution characterising the uncertainty representation associated with the first data item;
the second tuple contains parameters encoding the probability of data items within the probability distribution characterising the uncertainty representation associated with the second data item; and,
the third tuple contains parameters encoding the probability of data items within a probability distribution characterising the further distribution data.

10. The method of claim 9 wherein:
the distribution data comprises probability distributions of respective data items;
the first tuple contains parameters encoding the value of one or more statistical moments of the probability distribution characterising the uncertainty representation associated with the first data item;
the second tuple contains parameters encoding the value of one or more statistical moments of the probability distribution characterising the uncertainty representation associated with the second data item; and,
the third tuple contains parameters encoding the value of one or more statistical moments of a probability distribution characterising the further distribution data.

11. The method of claim 10 wherein:
the probability distribution characterising the uncertainty representation associated with the first data item comprises a distribution of Dirac delta functions;
the probability distribution characterising the uncertainty representation associated with the second data item comprises a distribution of Dirac delta functions; and,
the probability distribution characterising the further distribution data comprises a distribution of Dirac delta functions.

12. The method of claim 11 wherein the first tuple takes the form of an N-tuple, the second tuple takes the form of an N-tuple, and wherein the third tuple is takes the form of an M-tuple for which N²/2<M<2N² in which N>1 is an integer.

13. The method of claim 1 wherein the at least one data item selected from the first register comprises a value of a first random variable, and the distribution data comprises a value of a second random variable.

14. The method of claim 1 wherein operations of outputting the result comprises one or more of: storing the output in a memory; and transmitting a signal conveying the output.

15. The method of claim 1 wherein the arithmetic operation comprises one or more of: addition; subtraction; multiplication; and division.

16. (canceled)

17. (canceled)

18. A microarchitecture for performing one or more computations on distributions of data comprising:
a first register configured for containing data items;
a second register configured for containing distribution data representing distributions that are uncertainty representations associated with respective ones of said data items;
a first arithmetic logic unit configured for executing one or more arithmetic operations on data items selected from the first register;
a second arithmetic logic unit configured for executing one or more arithmetic operations on distribution data selected from the second register;
the microarchitecture configured to:
cause the first arithmetic logic unit; to execute an arithmetic operation on one or more data items selected from the first register, and output the result;
cause the second arithmetic logic unit; to execute an arithmetic operation on the distribution data, and outputting the result comprising further distribution data representing uncertainty associated with result of the arithmetic operation executed on the data items selected from the first register;
wherein the arithmetic operation executed on the distribution data is substantially the same as the arithmetic operation executed on the data items selected from the first register.

19. (canceled)

20. The microarchitecture of claim 18 configured to execute the arithmetic operation by the second arithmetic logic unit when triggered by a command that triggers the execution of the arithmetic operation by the first arithmetic logic unit.

21. The microarchitecture of claim 18 further comprising a memory unit configured to store said data items at addressed memory locations therein, and wherein the microarchitecture is configured to implement the following steps:
obtaining the originating memory location addresses of data items that contribute to the arithmetic operation executed by the first arithmetic logic unit as the first arithmetic logic unit executes the arithmetic operation;
storing the obtained originating memory location addresses at a storage location within the memory unit; and
associating the storage location with said further distribution data.

22. The microarchitecture of claim 18 wherein:
the first register is configured to contain a first data item and a second data item;
the second register is configured to contain first distribution data comprising a first tuple containing parameters encoding a probability distribution characterising the uncertainty representation associated with the first data item;
the second register is configured to contain second distribution data comprising a second tuple containing parameters encoding a probability distribution characterising the uncertainty representation associated with the second data item in which the parameters used to encode the second distribution data are substantially the same as the parameters used to encode the first distribution data; and
the microarchitecture is configured to execute, by the second arithmetic logic unit, an arithmetic operation on distribution data comprising selecting the first tuple and the second tuple and therewith generating a third tuple using parameters contained within the first tuple and using parameters contained within the second tuple, the third tuple containing parameters encoding said further distribution data; and to output the third tuple.

23. (canceled)

24. (canceled)

25. (canceled)

26. (canceled)

27. (canceled)

28. (canceled)

29. (canceled)

30. (canceled)

31. The microarchitecture of claim 18 wherein said outputting comprises one or more of:
storing the output in a memory; and
transmitting a signal conveying the output.

32. (canceled)

33. A method for processing digitally encoded data on distributions of data, by a processor that includes a microarchitecture comprising: a first register, a second register, a first arithmetic logic unit and a second arithmetic logic unit, the method comprising the operations of:
providing to the processor for storage in the first register at least one data item to cause the first arithmetic logic unit to perform a first arithmetic operation on the at least one data item, and to output a first result;
providing to the processor for storage in the second register distribution data, the distribution data representing distributions that are uncertainty representations associated with the at least one data item to cause the second arithmetic logic unit to perform substantially the first arithmetic operation on the distribution data, and to output a second result comprising further distribution data representing uncertainty associated with the result of the first arithmetic operation executed on the at least one data item selected from the first register; and
receiving the second result.
